(19) United States
(12) Patent Application Publication
(10) Pub. No.: US 2015/0371611 A1
(43) Pub. Date: Dec. 24, 2015

(54) OBSCURELY RENDERING CONTENT USING MASKING TECHNIQUES

(71) Applicant: ContentGuard Holdings, Inc., Plano, TX (US)

(72) Inventors: Michael Charles Raley, Plano, TX (US); Satyadev Rajesh Patel, Palo Alto, CA (US); Scott Richardson, Plano, TX (US); Shaul Teplinsky, San Francisco, CA (US)

(21) Appl. No.: 14/744,997

(22) Filed: Jun. 19, 2015

Related U.S. Application Data
(60) Provisional application No. 62/014,661, filed on Jun. 19, 2014.
(60) Provisional application No. 62/022,179, filed on Jul. 8, 2014.
(60) Provisional application No. 62/042,580, filed on Aug. 27, 2014.
(60) Provisional application No. 62/042,584, filed on Aug. 27, 2014.
(60) Provisional application No. 62/042,590, filed on Aug. 27, 2014.
(60) Provisional application No. 62/042,599, filed on Aug. 27, 2014.
(60) Provisional application No. 62/042,610, filed on Aug. 27, 2014.
(60) Provisional application No. 62/042,629, filed on Aug. 27, 2014.
(60) Provisional application No. 62/042,772, filed on Aug. 27, 2014.
(60) Provisional application No. 62/054,951, filed on Sep. 24, 2014.
(60) Provisional application No. 62/054,952, filed on Sep. 24, 2014.
(60) Provisional application No. 62/054,956, filed on Sep. 24, 2014.
(60) Provisional application No. 62/054,960, filed on Sep. 24, 2014.
(60) Provisional application No. 62/054,963, filed on Sep. 24, 2014.
(60) Provisional application No. 62/054,964, filed on Sep. 24, 2014.
(60) Provisional application No. 62/075,819, filed on Nov. 5, 2014.

(51) Int. Cl. G09G 5/377

(52) U.S. Cl. CPC G09G 5/377; G09G 2340/12

(57) ABSTRACT

Exemplary embodiments relate to methods, apparatus, and computer-readable media storing instructions for displaying content. An exemplary method comprises receiving source content, identifying a mask that segments the source content into at least a first segment and a second segment, the identifying including specifying one or more parameters associated with the mask, identifying one or more masking techniques, associating the source content with obscuration information and one or more usage rules, the obscuration information including information corresponding to the mask, information corresponding to the one or more parameters, and information corresponding to the one or more masking techniques, and transmitting the source content, the one or more usage rules, and the obscuration information to at least one recipient computing device.

### RELATED APPLICATION DATA

This application claims priority to U.S. Provisional Application No. 62/014,661, filed Jun. 19, 2014, U.S. Provisional Application No. 62/022,179, filed Jul. 8, 2014, U.S. Provisional Application No. 62/042,580, filed Aug. 27, 2014, U.S. Provisional Application No. 62/042,584, filed Aug. 27, 2014, U.S. Provisional Application No. 62/042,590, filed Aug. 27, 2014, U.S. Provisional Application No. 62/042,599, filed Aug. 27, 2014, U.S. Provisional Application No. 62/042,610, filed Aug. 27, 2014, U.S. Provisional Application No. 62/042,629, filed Aug. 27, 2014, U.S. Provisional Application No. 62/042,772, filed Aug. 27, 2014, U.S. Provisional Application No. 62/054,951, filed Sep. 24, 2014, U.S. Provisional Application No. 62/054,952, filed Sep. 24, 2014, U.S. Provisional Application No. 62/054,956, filed Sep. 24, 2014, U.S. Provisional Application No. 62/054,960, filed Sep. 24, 2014, U.S. Provisional Application No. 62/054,963, filed Sep. 24, 2014, U.S. Provisional Application No. 62/054,964, filed Sep. 24, 2014 and U.S. Provisional Application No. 62/075,819, filed Nov. 5, 2014, the disclosures of which are hereby incorporated herein by reference in their entirety.

### FIELD OF THE INVENTION

The present invention generally relates to the field of digital rights management, and more particularly to preventing unauthorized uses, for example, screen captures, during rendering of protected content.

### BACKGROUND

Digital rights management (DRM) enables the delivery of content from a source to a recipient, subject to restrictions defined by the source concerning use of the content. Exemplary DRM systems and control techniques are described in U.S. Pat. No. 7,073,199, issued Jul. 4, 2006, to Raley, and U.S. Pat. No. 6,233,684, issued May 15, 2001, to Stefik et al., which are both hereby incorporated by reference in their entireties. Various DRM systems or control techniques (such as those described therein) can serve be used with the obscuration techniques described herein.

One of the biggest challenges with controlling use of content is to prevent users from using the content in a manner other than those permitted by usage rules. As used herein, usage rules indicate how content can be used. Usage rules can be embodied in any data file and defined using program code, and can further be associated with conditions that must be satisfied before use of the content is permitted. Usage rules can be supported by cohesive enforcement units, which are trusted devices that maintain one or more of physical, communications and behavioral integrity within a computing system.

For example, if the recipient is allowed to create a copy of the content and the copy of the content is not DRM-protected, then the recipient's use of the copy would not be subject to any use restrictions that had been placed on the original content. For example, many modern consumer platforms for DRM-protected content support a “screen capture” feature. While these “screen capture” features are not necessarily intended to be used to bypass DRM restrictions (for example, by making a non-DRM copy) of the content, some DRM systems that distribute or render content have attempted to prevent or impede the use of screen capture features on user rendering devices to prevent the user from bypassing DRM restrictions on the content. As such, it is clear that the use of techniques such as screen capture present a threat to DRM control that is difficult to overcome.

When DRM systems impose restrictions on the use of a rendering device, for example, by preventing or impeding the use of the screen capture features, a conflict of interest arises between the rendering device owner's (receiver, or recipient) interest in being able to operate their device with all of its features without restriction (including screen capture capability), and the content provider's (sender, or source) interest in regulating and preventing copying of the content rendered on the recipient's devices. This conflict of interest has historically been overcome by establishing trust between the content supplier and the rendering device. By establishing trust in this manner, the content supplier can be sure that the rendering device will not bypass DRM restrictions on rendered content.

There is a field of technology devoted to trusted computing. A primary focus balances control of the rendering device by the content provider with control by the recipient. In cases where the recipient operates a trusted client and the content provider (source) controls the trusted elements of the client, screen capture by the device (e.g., satellite DVRs, game consoles and the like) can be prevented by disabling those capabilities. However, users typically operate devices that are substantially under their control (e.g., PC's, Mac's, mobile phones and the like). As mentioned above, many of these types of devices offer the recipient a screen capture feature that cannot be controlled by the source of the content. For example, screen capture functionality can be achieved using “shift printscreen” on PC's, “shift cmd 4” on Macs, “pwr vol-” on android devices, “pwr home” on devices running iOS, and the like.

Some providers of DRM rendering clients (recipients) have attempted to eliminate a platform's ability to bypass DRM restrictions using screen capture. However, these efforts have been met with simple workarounds within the rendering device systems, or, in some cases, the platform providers have taken action to prevent DRM clients running on those platforms from preventing screen captures. For example, Snapchat is an existing DRM client that operates within iOS. Snapchat developers noticed that before a screen capture takes place (pwr home) in iOS, the operating system would cancel any finger presses that are currently occurring before harvesting the image that is displayed on the screen. Thus, to disable the screen capture feature, Snapchat used a “press and hold” to view feature when a user wanted to render protected content. Thus, when a user attempted to take a screen capture, iOS would automatically interrupt the “press and hold” signal before capturing the screen. In response to the interruption of the “press and hold” signal, the Snapchat client would remove the DRM protected content from the screen before the screen capture was completed. When Apple Inc., the platform provider, noticed that Snapchat was relying on this feature to eliminate screen capture of DRM-protected content, they issued a patch to the operating system that enabled screen capture without cancelling the press event. Thus, the efforts made by Snapchat to preventing unauthorized screen capture were rendered ineffective. As a concession, Apple Inc. added a feature that allowed applications to be notified that the screen capture had occurred.

### SUMMARY

Exemplary embodiments relate to a computer-implemented method executed by one or more computing devices for displaying content. An exemplary method comprises receiving, by at least one of the one or more computing devices, source content, identifying, by at least one of the one or more computing devices, a mask that segments the source content into at least a first segment and a second segment, the identifying including specifying one or more parameters associated with the mask, identifying, by at least one of the one or more computing devices, one or more masking techniques, associating, by at least one of the one or more computing devices, the source content with obscuration information and one or more usage rules, the obscuration information including information corresponding to the mask, information corresponding to the one or more parameters, and information corresponding to the one or more masking techniques, and transmitting, by at least one of the one or more computing devices, the source content, the one or more usage rules, and the obscuration information to at least one recipient computing device.

Exemplary embodiments also relate to an apparatus for displaying content. An exemplary apparatus comprises one or more processors, and one or more memories operatively coupled to at least one of the one or more processors and having instructions stored thereon that, when executed by at least one of the one or more processors, cause at least one of the one or more processors to enable the receipt of source content, identify a mask that segments the source content into at least a first segment and a second segment, the identifying including specifying one or more parameters associated with the mask, identify one or more masking techniques, associate the source content with obscuration information and one or more usage rules, the obscuration information including information corresponding to the mask, information corresponding to the one or more parameters, and information corresponding to the one or more masking techniques, and transmit the source content, the one or more usage rules, and the obscuration information to at least one recipient computing device.

Exemplary embodiments further relate to at least one non-transitory computer-readable medium storing computer-readable instructions that, when executed by one or more computing devices, cause at least one of the one or more computing devices to receive source content, identify a mask that segments the source content into at least a first segment and a second segment, the identifying including specifying one or more parameters associated with the mask, identify one or more masking techniques, associate the source content with obscuration information and one or more usage rules, the obscuration information including information corresponding to the mask, information corresponding to the one or more parameters, and information corresponding to the one or more masking techniques, and transmit the source content, the one or more usage rules, and the obscuration information to at least one recipient computing device.

Additional exemplary embodiments relate to an apparatus for displaying content. An exemplary apparatus comprises one or more processors, and one or more memories operatively coupled to at least one of the one or more processors and having instructions stored thereon that, when executed by at least one of the one or more processors, cause at least one of the one or more processors to enable the receipt of source content, identify a mask that segments the source content into at least a first segment and a second segment, the identifying including specifying one or more parameters associated with the mask, identify one or more masking techniques, wherein the one or more masking techniques can be applied to segments of the source content identified by the mask to create an obscured rendering of the source content, associate the source content with obscuration information and one or more usage rules, the obscuration information including information corresponding to the mask, information corresponding to the one or more parameters, and information corresponding to the one or more masking techniques, the one or more usage rules indicating how the source content may be obscurely rendered using the obscuration information, and transmit the source content, the one or more usage rules, and the obscuration information to at least one recipient computing device.

In the exemplary embodiments, at least one recipient computing device may be operable to use the source content, the one or more usage rules, and the obscuration information to create an obscured rendering of the source content. The mask may segment the source content into at least three segments including the first segment, the second segment, and one or more additional segments. Identifying the mask may comprise selecting a mask from a library of at least two possible masks. At least one of the one or more masking techniques may be a blur, may replace a segment with a solid color approximating the average color of the segment, and may alter the RGB values of each pixel of a segment. The mask may be based at least in part on an image or a logo, may be based at least in part on a tile pattern of shapes, and may be based at least in part on a field of hexagon shapes. A document may comprise the source content.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a system layout associated with the use of symmetric obscuration techniques according to an exemplary embodiment.

FIG. 2 illustrates a workflow associated with the use of symmetric obscuration techniques according to an exemplary embodiment.

FIG. 3 illustrates a configuration in which an obscured rendering of content can be streamed from a server according to an exemplary embodiment.

FIG. 4 illustrates a configuration in which an obscured rendering of content can be streamed from a server according to an exemplary embodiment.

FIG. 5 illustrates a system layout associated with the use of asymmetric obscuration techniques according to an exemplary embodiment.

FIG. 6 illustrates a workflow associated with the use of asymmetric obscuration techniques according to an exemplary embodiment.

FIG. 7 illustrates a system layout associated with the use of a packaging configuration according to an exemplary embodiment.

FIG. 8 illustrates a workflow associated with the use of a packaging configuration according to an exemplary embodiment.

FIG. 9 illustrates a system layout associated with the use of a server-side library of obscuration techniques according to an exemplary embodiment.

FIG. 10 illustrates a workflows associated with the use of a server-side library of obscuration techniques according to an exemplary embodiment.

FIG. 11 illustrates a system layout associated with the use of a network-based content storage according to an exemplary embodiment.

FIG. 12 illustrates a workflow associated with the use of a network-based content storage according to an exemplary embodiment.

FIG. 13 illustrates a workflow for sender device, receiver device, and server configurations according to an exemplary embodiment.

FIG. 14 illustrates a fence post masking transformation according to an exemplary embodiment.

FIG. 15 illustrates a masking transformation according to an exemplary embodiment.

FIG. 16 illustrates a masking transformation according to an exemplary embodiment.

FIG. 17 illustrates a masking transformation according to an exemplary embodiment.

FIG. 18 illustrates a masking transformation according to an exemplary embodiment.

FIG. 19 illustrates a masking transformation according to an exemplary embodiment.

FIG. 20 illustrates a masking transformation according to an exemplary embodiment.

FIG. 21 illustrates a Red-Green-Blue (RGB) transformation according to an exemplary embodiment.

FIG. 22 illustrates a masking transformation according to an exemplary embodiment.

FIG. 23 illustrates an interface according to an exemplary embodiment.

FIG. 24 illustrates an interface according to an exemplary embodiment.

FIG. 25 illustrates original (raw) content according to an exemplary embodiment.

FIG. 26 illustrates the identification of a region to protect with an obscuration technique according to an exemplary embodiment.

FIG. 27 illustrates an interface according to an exemplary embodiment.

FIG. 28 illustrates an interface according to an exemplary embodiment.

FIG. 29 illustrates an interface according to an exemplary embodiment.

FIG. 30 illustrates an interface according to an exemplary embodiment.

FIG. 31 illustrates a screen capture according to an exemplary embodiment.

FIG. 32 illustrates a fence post obscuration technique according to an exemplary embodiment.

FIG. 33 illustrates an obscuration technique according to an exemplary embodiment.

FIG. 34 illustrates an obscuration technique according to an exemplary embodiment.

FIGS. 35-37 illustrate pixel and display configurations according to an exemplary embodiment.

FIG. 38A illustrates a representation of image content data in a frame according to an exemplary embodiment.

FIG. 38B illustrates pixel data having four input values for four color components according to an exemplary embodiment.

FIG. 38C illustrates pixel data having three input values for three color components according to an exemplary embodiment.

FIG. 39A-D illustrate an obscuration technique according to an exemplary embodiment.

FIGS. 40A-C illustrate an obscuration technique according to an exemplary embodiment.

FIG. 41 illustrates an obscuration technique according to an exemplary embodiment.

FIGS. 42A-B illustrate an obscuration technique according to an exemplary embodiment.

FIGS. 43A-B illustrate an obscuration technique according to an exemplary embodiment.

FIG. 44 illustrates a graphic according to an exemplary embodiment.

FIGS. 45A-B illustrate an obscuration technique according to an exemplary embodiment.

FIGS. 46A-C illustrate an obscuration technique according to an exemplary embodiment.

FIGS. 47A-D illustrate an obscuration technique according to an exemplary embodiment.

FIGS. 48A-F illustrate obscuration techniques according to an exemplary embodiment.

FIGS. 49A-D illustrate obscuration techniques according to an exemplary embodiment.

FIGS. 50A-B illustrate obscuration techniques according to an exemplary embodiment.

FIGS. 51A-C illustrate obscuration techniques according to an exemplary embodiment.

FIGS. 52A-C illustrate obscuration techniques according to an exemplary embodiment.

FIGS. 53A-B illustrate obscuration techniques according to an exemplary embodiment.

FIGS. 54A-C illustrate obscuration techniques according to an exemplary embodiment.

FIGS. 55A-C illustrate obscuration techniques according to an exemplary embodiment.

FIGS. 56A-D illustrate obscuration techniques according to an exemplary embodiment.

FIGS. 57A-G illustrate obscuration techniques according to an exemplary embodiment.

FIGS. 58A-J illustrate obscuration techniques according to an exemplary embodiment.

FIGS. 59A-N illustrate obscuration techniques according to an exemplary embodiment.

FIG. 60 illustrates a computing environment that may be employed in implementing the embodiments of the invention.

FIG. 61 illustrates a network environment that may be employed in implementing the embodiments of the invention.

FIGS. 62A-B illustrate pixel oscillations according to an exemplary embodiment.

FIG. 62C illustrates a flow chart for preventing image persistence according to an exemplary embodiment.

FIG. 63A-B illustrate obscuration techniques according to an exemplary embodiment.

FIG. 64 illustrates reversing an oscillation according to an exemplary embodiment.

FIG. 65 illustrates cycling versions of content according to an exemplary embodiment.

FIG. 66 illustrates a flow chart for preventing image persistence according to an exemplary embodiment.

FIG. 67 illustrates checkerboard masks according to an exemplary embodiment.

### DETAILED DESCRIPTION

This disclosure describes aspects of embodiments for carrying out the inventions described herein. Of course, many modifications and adaptations will be apparent to those skilled in the relevant arts in view of the following description in view of the accompanying drawings and the appended claims. While the aspects of the disclosed embodiments described herein are provided with a certain degree of specificity, the present technique may be implemented with either greater or lesser specificity, depending on the needs of the user. Further, some of the features of the disclosed embodiments may be used to obtain an advantage without the corresponding use of other features described in the following paragraphs. As such, the present description should be considered as merely illustrative of the principles of the present technique and not in limitation thereof.

The disclosed embodiments address preventing circumvention (e.g., via screen capture) of content subject to digital rights management (“DRM”) running on computing platforms. The exemplary embodiments significantly improve the content sender's ability to regulate use of content after the content is distributed.

For the sake of convenience, this application refers to unmodified (e.g., not obscured or censored) content sent by the sender's device as “source content.” Source content may be encrypted, compressed and the like, and multiple copies of the source content (each copy also referred to as source content) may exist. In addition, content, as disclosed herein, refers to any type of digital content including, for example, image data, video data, audio data, textual data, documents, and the like. Digital content may be transferred, transmitted, or rendered through any suitable means, for example, as content files, streaming data, compressed files, etc., and may be persistent content, ephemeral content, or any other suitable type of content.

Ephemeral content, as used herein, refers to content that is used in an ephemeral manner, e.g., content that is available for use for a limited period of time. Use restrictions that are characteristic of ephemeral content may include, for example, limitations on the number of times the content can be used, limitations on the amount of time that the content is usable, specifications that a server can only send copies or licenses associated with the content during a time window, specifications that a server can only store the content during a time window, and the like.

Screen capture is a disruptive technology to ephemeral content systems. It allows the content to persist beyond the ephemeral period (e.g., it allows ephemeral content to become non-ephemeral content). SnapChat, for example, is a popular photo messaging app that uses content in an ephemeral manner. Specifically, using the SnapChat application, users can take photos, record videos, and add to them text and drawings, and send them to a controlled list of recipients. Users can set a time limit for how long recipients can view the received content (e.g., 1 to 10 seconds), after which the content will be hidden and deleted from the recipient's device. Additionally, the Snapchat servers follow distribution rules that control which users are allowed to receive or view the content, how many seconds the recipient is allowed to view the content, and what time period (days) the Snapchat servers are allowed to store and distribute the content, after which time Snapchat servers delete the content stored on the servers.

Aspects of the disclosed embodiments enable the use (including rendering) of DRM-protected content while frustrating unauthorized capture of the content (e.g., via screen capture), and while still allowing the user (recipient) to visually perceive or otherwise use the content in a satisfactory manner. This is particularly useful when the content is rendered by a DRM agent on a recipient's non-trusted computing platform. This may be achieved through the application of an obscuration technique (OT) that obscures part or all of the content when the content is rendered. With respect to ephemeral content, obscuration is an enabling technology for ephemeral content systems in that it thwarts a set of technologies that would circumvent the enforcement of ephemeral content systems. The techniques described herein have been proven through experimentation and testing, and test results have confirmed the advantages of the results.

An obscuration technique may be applied during creation of the content or at any phase of distribution, rendering or other use of the content. For example, the obscuration technique may be applied by the sender's device, by the recipient's device, by a third party device (such as a third party server or client device), or the like. When an obscuration technique (OT) is applied to content during its creation or distribution (e.g., by an intermediate server between the content provider and the end user), the resulting content may be referred to as “obscured content.” When an obscuration technique is applied during the rendering of content the resulting rendering may be referred to as “obscured rendering” or the resulting rendered content as “obscurely rendered content.” In addition, the application of an obscuration technique may include the application of more than one obscuration technique. For example, multiple obscurations can be applied during an obscured rendering, either simultaneously or using multi-pass techniques. Thus, the exemplary obscuration techniques described herein may be applied in combination, with the resulting aggregate also being referred to as an obscured rendering.

While aspects of the disclosed embodiments relate to the obscuration technique applied to source content, the obscuration techniques may instead be applied to content in general. For example, the obscuration may be applied to censored content or applied to the rendering of censored content. “Censored content,” as used herein, refers to content that has been edited for distribution. Censored content may be created by intentionally distorting source content (or other content) such that, when the censored content is displayed, users would see a distorted version of the content regardless of whether a user is viewing an obscured rendering or an unobscured rendering of the censored content. Censored content can include, for example, blurred areas. The content can be censored using any suitable means, and censored content can be displayed using a trusted or non-trusted player.

Regarding obscured rendering, aspects of the disclosed embodiments take advantage of the differences between how computers render content, how the brain performs visual recognition, and how devices like cameras capture content rendered on a display. Embodiments of the invention apply obscuration techniques to a rendering of content in a manner that enables the content to be viewed by the user with fidelity and identifiability, but that degrades images created by unwanted attempts to capture the rendered content, e.g., via screen capture using a camera integrated into a device containing the display or using an external camera. As an example, identifiability may be quantified using the average probability of identifying an object in a rendering of content. The content may be degraded content, obscurely rendered content or source content. At one end of the identifiability score range would be the identifiability score of a rendering of the source content, whereas the other end of the range would be the identifiability score of a rendering of a uniform image, e.g., an image with all pixels having the same color. The uniform image would provide no ability to identify an object. The identifiability score of the obscurely rendered content would fall between the scores of the degraded content and the source content, whereas the identifiability score of the degraded content would fall between the scores of the uniform image and the score of the obscurely rendered content. The average probability of identifying the object in content may be determined as an average over a sample of human users or over a sample of computer-scanned images using facial or other image recognition processes and the like. As an example for fidelity, fidelity may be quantified by comparing the perceived color of one or more regions in rendered degraded content with the perceived color of the one or more regions in the rendered original content, where deviations of the color may be measured using a distance metric in color space, e.g., CIE XYZ, Lab color space, etc. As another example regarding a fidelity metric see (http://live.ece.utexas.edu/research/quality/VIF.htm). The degraded images captured in this manner will have a significantly reduced degree of fidelity and identifiability relative to the human user's view of content as displayed in an obscured rendering or a non-obscured rendering. Embodiments of the invention also enable a scanning device, such as a bar code or QR code reader, to use the content in an acceptable manner, e.g., to identify the content being obscurely rendered, while degrading images created by unwanted attempts to capture the obscurely rendered content.

Computers often render content in frames. When an image is captured via a screen shot or with a camera operating at a typical exposure speed (e.g., approximating the frame rate for the display device, e.g., 20-120 Hz), a single frame of the obscurely rendered content may be captured, which will include whatever obscuration is displayed in that frame of the obscurely rendered content. Alternatively, a screen capture or the like may capture multiple frames depending on exposure speed, but embodiments of the invention nevertheless may apply obscuration techniques that cause images captured in this manner to be degraded such that the resulting images have a significantly reduced degree of fidelity and identifiability relative to a human user's perception (or scanning device's scanning and processing) of the obscurely rendered content. In contrast, for a human user, due to persistence of vision and the way the brain processes images, the user will be able to view or otherwise use the obscurely rendered content perceived over multiple frames with fidelity and identifiability.

Ideally, the user will perceive the obscurely rendered content as identical to an unobscured rendering of the content (whether source content, censored content, etc.). The human user may not always perceive the obscurely rendered content as a perfect replication of the unobscured rendering of content because application of the obscuration technique may create visual artifacts. Such artifacts may reduce the quality of the rendering of the content perceived in the obscured rendering, although not so much as to create an unacceptable user experience of the content. An unacceptable user experience may result if objects in the obscurely rendered content are unrecognizable or if the perceived color of a region in the obscurely rendered content deviates from the perceived color of the region in the rendered source content by a measure greater than what is typically accepted for color matching in various fields, e.g., photography, etc.

When considering which obscuration technique should be used, a content provider or sender may consider how the obscuration technique will affect the user's perception of the obscurely rendered content, and also the effect the obscuration technique will have on how degraded the content will appear in response to an attempt to copy of the content via, e.g., a screenshot. For example, a content provider may want to select an obscuration technique that minimizes the effect the obscuration technique will have on the user's perception of an obscured rendering of content, while also maximizing the negative effects the obscuration technique will have on the degraded content.

To determine how the obscuration technique will affect the display of the content, previews of the obscurely rendered content and the degraded content may be displayed to the user. For non-human scanning devices, the content provider or sender may conduct testing of the ability of the scanning device to use obscurely rendered content (e.g., to identify desired information from the obscurely rendered content) subject to varying parameters, e.g., spatial extent and rate of change of the obscuration.

Thus, in summary, when a content supplier wants to distribute source content, the content can be distributed in any form (source content, censored content, etc.). Embodiments of the invention may apply obscuration techniques that enable authorized/intended users or scanning devices to use the obscurely rendered content or the obscured content in a satisfactory manner, while causing unauthorized uses of obscured renderings to result in degraded content.

In this regard, a content provider or sender may consider how the application of the obscuration technique will affect the appearance of the content when displayed in an obscured rendering in the following instances:
1) Authorized User, Proper Use of the Content: When the user is authorized and the use of the content is permitted by a usage rule or usage condition, the application of an obscuration technique may cause an animated obscuration to appear in the obscured rendering, but the content can still be perceptible to the user. The movement of the obscuration will not prevent the user from perceiving the content in the permitted manner.
2) Authorized User, Improper Use of the Content: When the user is authorized to view the content but other use of the content is not permitted by the usage rule, unauthorized uses may result in the creation of degraded content, as described above. For example, when a user takes a screen capture, the movement of the obscuration effects described above will no longer occur, and instead, the positions of the obscuration effects will be fixed, thereby degrading portions of the content.
3) Unauthorized User or Non-Trusted Application: When the user is not authorized to use the full content or when the content is displayed using a non-trusted application, content can be displayed as censored content. Censored content is content that has been edited for distribution, and may include elements that are blocked (e.g., blurred faces, blacked out text and the like) so that the content cannot be effectively perceived.

Aspects of the disclosed embodiments focus on inter-related processes to effectively utilize obscuration techniques through the use of a system that can include, for example:
1) Specific content obscuration techniques
2) Selection, distribution, and management of software routines or parameters (implementing the content obscuration techniques) which can be paired to the content
3) DRM integration that binds the selected obscuration technique to the content during protection/distribution and presentation

System Embodiments:

Static/Symmetric Obscuration Technique

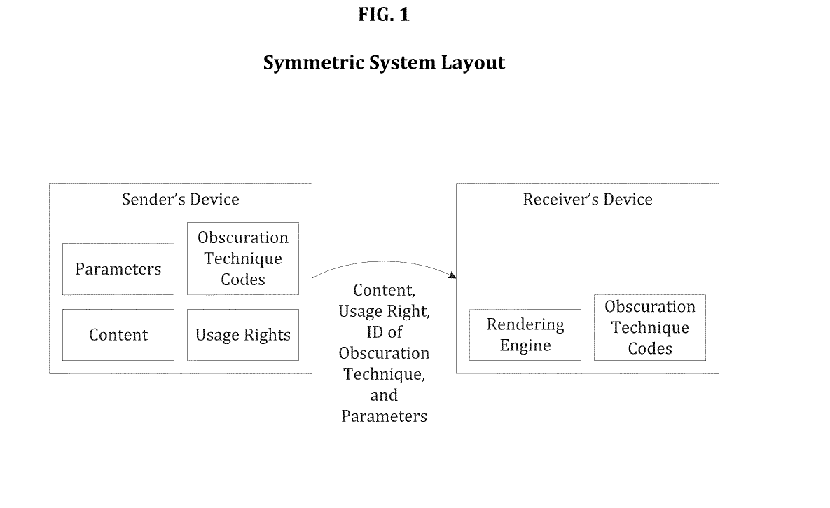

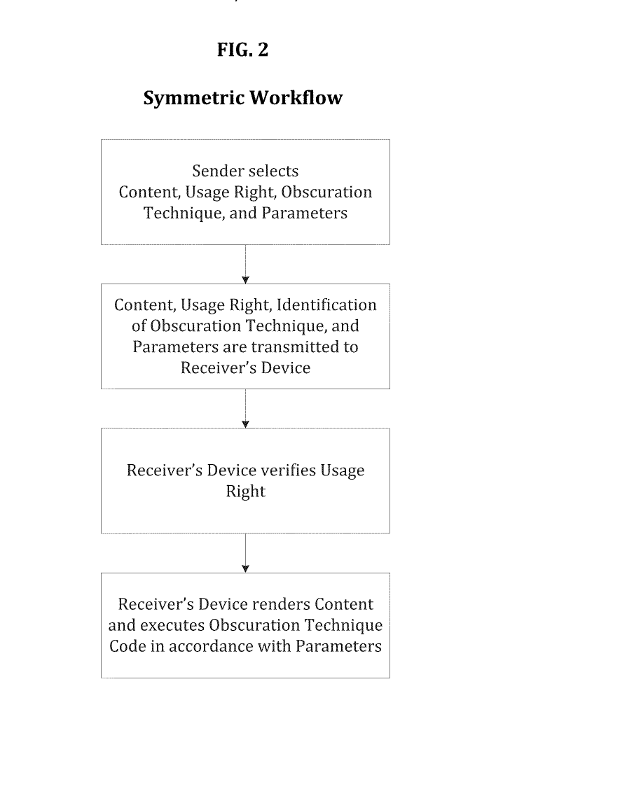

In a symmetric obscuration technique workflow, the program code for the obscuration technique may exist on both the sender's device and the receiver's device. FIGS. 1 and 2 illustrate, respectively, an exemplary system layout and a workflow associated with the use of symmetric obscuration techniques. In this scenario, the sender's device may have access to only a single fixed obscuration technique, which allows the user to apply the obscuration technique during rendering of the source content. The sending client can be a DRM protection agent capable of encrypting and transmitting the source content to a receiver's device. According to some embodiments, the receiver's device can receive the content through a content distribution network, a third-party server, or any other suitable source. The receiver's device can use standard DRM techniques to recover the source content from a package and find the usage rules. One of the usage rules can be a Boolean value to turn on the obscuration technique that is common between the sender's device and receiver's device. The receiver's device should honor all the DRM usage rules, including applying the obscuration technique that is common to both the sender's device and the receiver's device.

More specifically, in an exemplary symmetric system, the sender's device can select and transmit source content and a usage rule associated with the content to the receiver's device. The usage rule may indicate one or more conditions corresponding to how the source content may be rendered by the receiver's device. The sender's device can also transmit an identification of an obscuration technique known to both the sender's device and the receiver's device for obscuring the source content during rendering and, optionally, one or more parameters associated with the obscuration technique, to the receiver's device. The receiver's device can then determine how the source content should be rendered based at least in part on whether the one or more conditions are satisfied, and can render the source content in accordance with the determination of how the source content should be rendered. As described herein, the rendering can include executing program code corresponding to the obscuration technique to thereby obscure the rendered source content in accordance with the identified obscuration technique, conditions, and one or more parameters.

Streaming Obscured Content

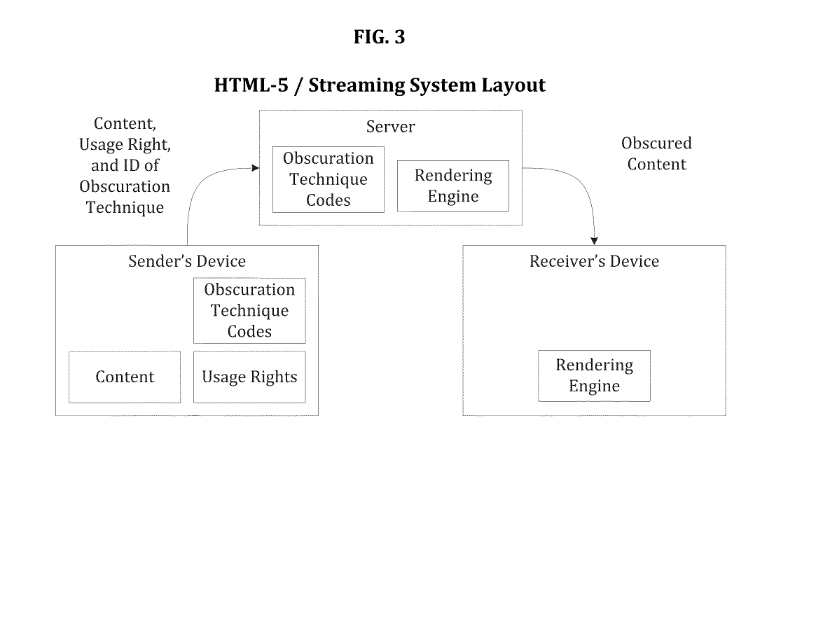

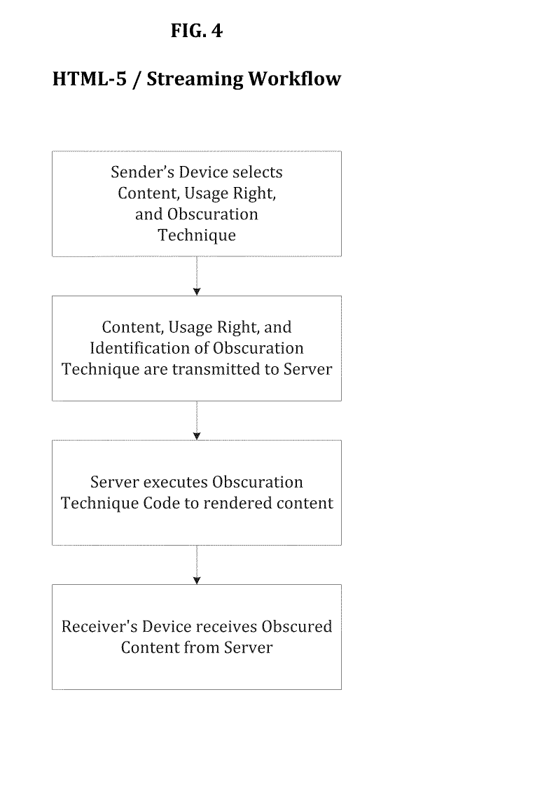

FIGS. 3 and 4 illustrate an alternative configuration in which an obscured rendering of content can be streamed from a server. In this configuration, a server can be used to apply an obscuration technique to source content, and then transmit an obscured rendering of the source content to a receiver's device, for example, by streaming video. In this configuration, the server can receive the source content and an identification of the obscuration technique from either the sender's device or receiver's device. The server's device may receive either the source content or may instead receive a rendered version of the source content. Either way, the server can apply the obscuration technique to the content by executing program code corresponding to the obscuration technique, and transmit the obscured rendering of the source content to the receiver's device for display. The obscured rendering of the source content can be transmitted via streaming video to ensure that the source content is displayed with the proper obscuration. In this configuration, the receiver's device can display the streaming source content using a browser, for example. An advantage to this approach is that the receiver's device does not have to be entirely trusted because the source content and rules are being handled by a trusted server instead. Well known technologies like Widevine/Silverlight, HTML5 Encrypted Media Extensions, and the like can be used to encrypt and deliver the video stream to the receiver's device.

Asymmetric Obscuration Technique

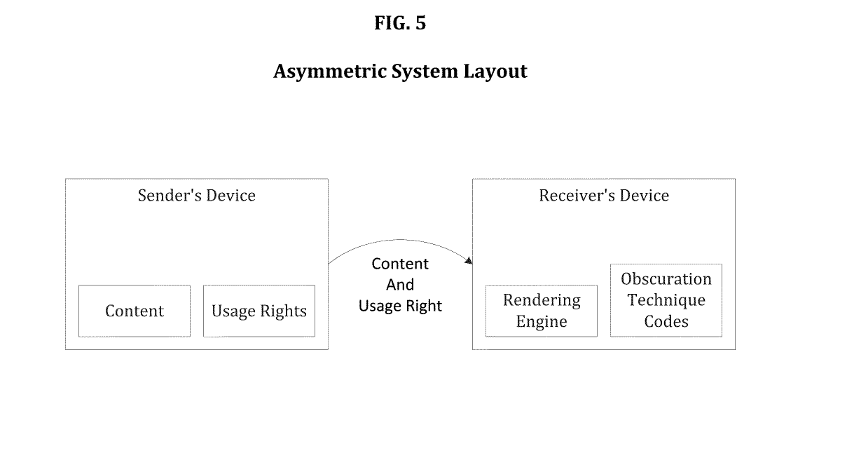

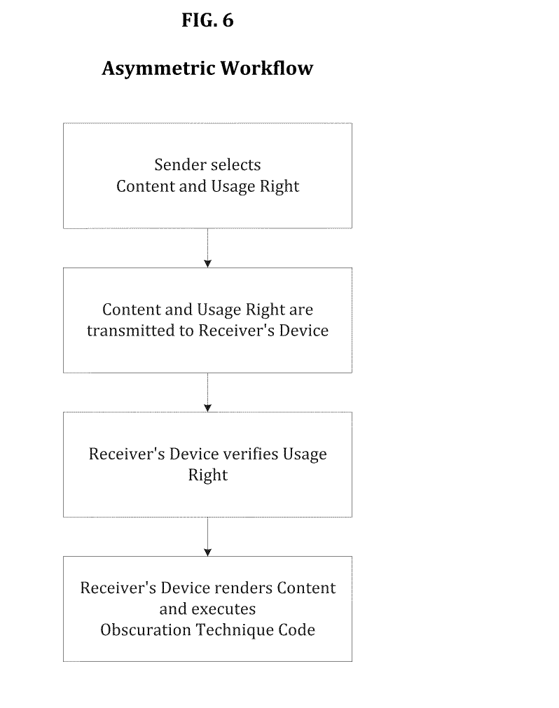

As an alternative to the Static/Symmetric obscuration techniques above, in an asymmetric obscuration technique workflow, the program code for the obscuration technique may exist only on the receiver's device. FIGS. 5 and 6 illustrate an exemplary system layout and workflow, respectively, associated with the use of asymmetric obscuration techniques. For example, the receiver may use an obscuration technique that may not be known to the sender. In this model, the sender can simply flag an option for the receiver's device to “apply an obscuration technique”, and the receiver's device can identify an obscuration technique and apply it during rendering of the source content.

According to aspects of the disclosed embodiments, the obscuration techniques can be implemented by creating a set of frames that have the content with an overlaid obscuration pattern. The obscuration pattern is translated relative to the content to create different frames within the frame set. For example, if the obscuration pattern is a single vertical bar, frame one may have the vertical bar on the right hand edge of the content. Frame two may have the vertical bar shifted to the right by one quarter of the width of the content. Frame three may have the vertical bar at the center of the content. Frame four may have the vertical bar shifted by one quarter of the width of the content from the left edge of the content. Frame five may have the vertical bar on the left hand edge of the content. The rendering of the frames on the display gives the viewer the perception that the obscuration pattern is moving across the screen with the content fixed in the background. In the example provided, the vertical bar would move from the right edge of the content to the left edge of the content as frames one to five are rendered in order. If the frames are rendered at a sufficiently high rate, say above 60 Hz, the obscuration pattern is not significantly perceived (e.g., to the point that the content being obscurely rendered is unusable) by the viewer and only the fixed content is perceived.

Furthermore, the obscuration technique can also be selected or customized based on the specific device a recipient is using to view the content. For example, if a recipient renders source content on a mobile device, the obscuration technique may be applied differently (e.g., at a different frame rate) than if the source content is rendered on a desktop computer. In this example, the sender's device may specify the use of a particular obscuration technique (such as RGB splitting), but the actual obscuration technique applied may be different (e.g., frame rates, checkerboard pattern, color order, etc.) based on a determination that a different obscuration technique is needed for the rendering device that is actually used to render the source content. In these cases, computing systems like the content sender's device, content distribution's servers, or even the receiver's device can introduce obscuration rules that control the alternatives based on the specific device of a recipient. As an example, the sender's device may encode a rule such as “If this is rendered by a IPhone 4, animate the obscuration elements at 30 hz, otherwise animate the obscuration elements at 60 hz.” A similar rule may be applied during distribution or at the recipient's device.

Select Obscuration Technique Based on Content

The sender may also be provided a selection of possible obscuration techniques by the program code resident on the sender's device or received from a server. The sender can select an obscuration technique, and preview how the content would appear when obscured with the selected obscuration technique. The sender's device can also display how a screen capture would appear if the selected obscuration technique were used.

As a further example, the sender's device may display a split screen with a section displaying a portion of the content with the obscuration technique being applied, and a sample of what the content would look like if the receiver improperly used the content (e.g., via screen capture). Alternatively, the sender's device may sequentially display the un-obscured content, the obscured rendering of the content, and the degraded content (e.g., result of taking a screen capture during obscured rendering), for example. It is understood that these three displays or a subset of two of the displays may be simultaneously or sequentially rendered by the sender's device. The intent of these displays is to allow the sender to choose an obscuration technique to be applied to the content and suitable parameters for the obscuration technique. There can also be an additional process on the sender's device to select from a multiplicity of possible obscuration techniques or parameters.

Parameter-Based Obscuration Technique

Regarding parameters, the sender may select an obscuration technique and control certain parameters, for example, through a user interface of a sender client application. In some cases, an obscuration technique may have variable parameters like the speed of the movement of the obscuration pattern on the screen, the amount of blur in the obscuration pattern, the color of obscuration, the image region to be blurred, etc. The user may be presented with a preview sample of how the content would be displayed with the obscuration technique applied. The user can also be presented with controls that the user can manipulate to change specific parameters of the obscuration technique. When the user selects a combination of obscuration technique and parameters, the user can also test how a screenshot or other improper use would appear.

If the sender is satisfied with how the content is displayed with the selected obscuration technique and parameters, the content can be further protected using well-known DRM techniques and usage rules. Any suitable DRM techniques can be used, for example, view time, fee, etc. (e.g., a usage license).

Packaging Content and Obscuration Technique Codes

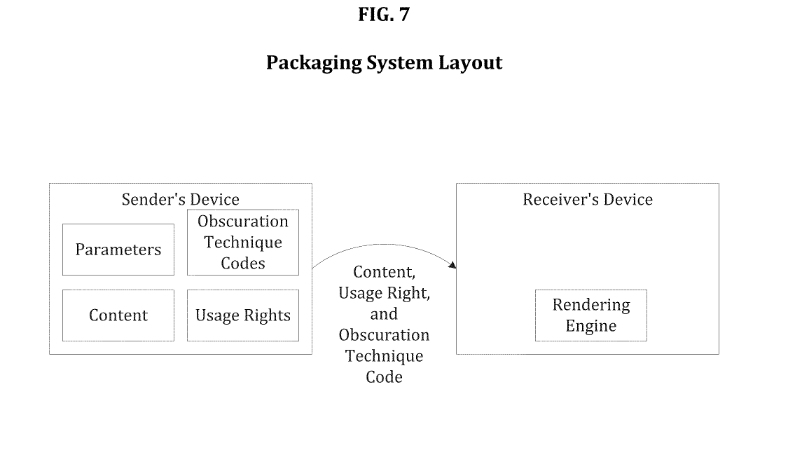

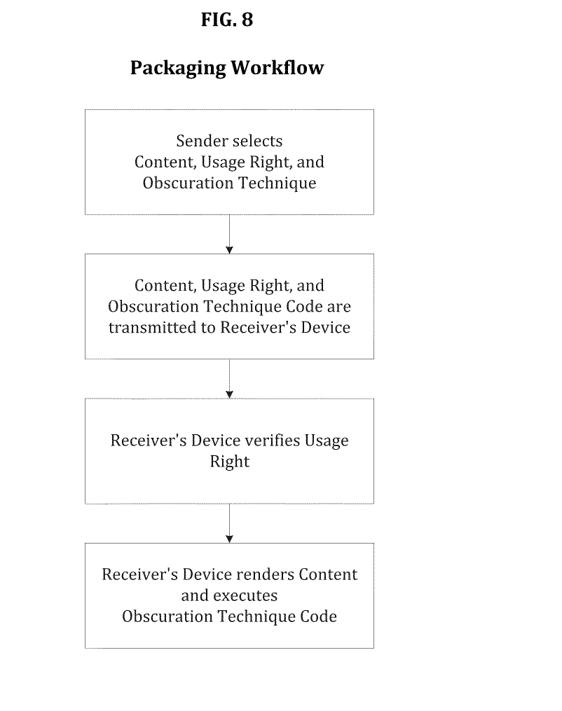

In another aspect of the disclosed embodiment, the sender's device can package together the content, usage rule, and program code for the obscuration technique, and deliver the package to the receiver's device. FIGS. 7 and 8 illustrate exemplary system layouts and workflows associated with the use of this packaging configuration.

More specifically, the sender can select an obscuration technique for obscuring content during rendering, and the content can be associated with a usage rule indicating one or more conditions corresponding to how the content may be rendered. The sender's device can then transmit the content, the usage rule, and program code corresponding to the obscuration technique to the receiver's device. The receiver's device can then determine how the content should be rendered based at least in part on whether the one or more conditions are satisfied, and render the content in accordance with the determination of how the content should be rendered. The rendering may include executing program code corresponding to an obscuration technique for obscuring the content during rendering to thereby obscure the rendered content.

Server Obscuration Technique Library

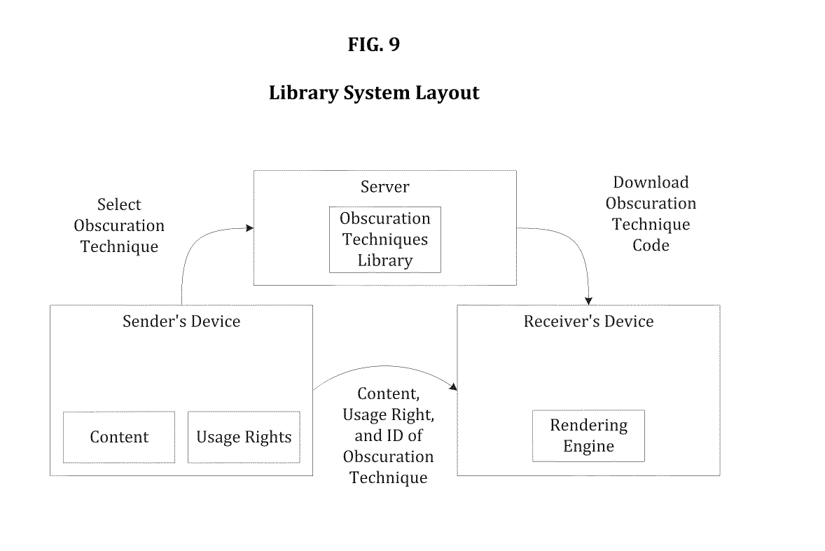

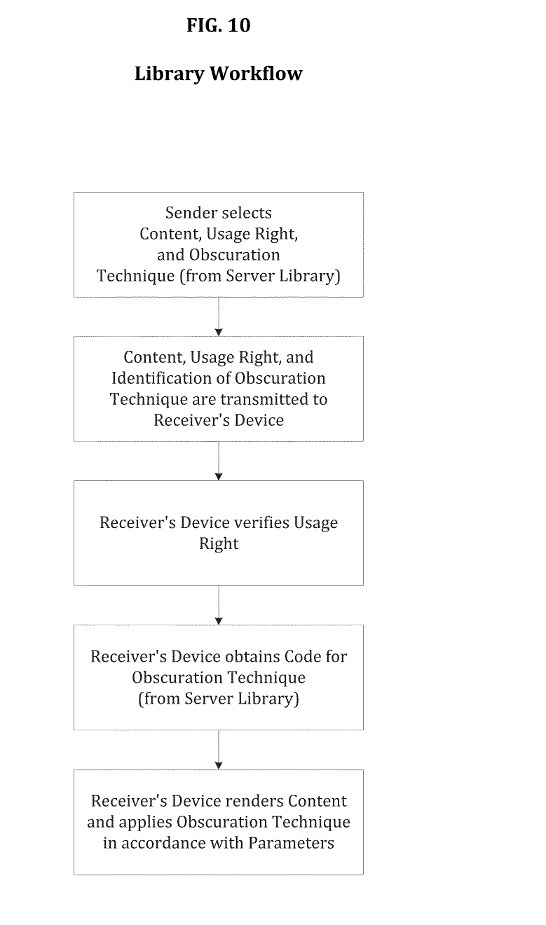

In another aspect of the disclosed embodiment, a library of obscuration techniques and related program code can be stored server-side. FIGS. 9 and 10 illustrate exemplary system layouts and workflows associated with the use of a server-side library of obscuration techniques. These obscuration techniques can be server generated, provided by users, or obtained from any suitable source. In this scenario, the sender can browse available obscuration techniques in the library and select one for application to the content. The sender's device may download the selected obscuration technique, if desired.

More specifically, the sender can select an obscuration technique stored in a server-side library for obscuring content during rendering, the content being associated with a usage rule indicating one or more conditions corresponding to how the content may be rendered, and then transmit the content, the usage rule, and an identification of the obscuration technique to the receiver's device. In one embodiment, a requirement to apply an obscuration technique and/or parameters for an obscuration technique can be encoded within a data structure and associated with the content via usage rules or conditions in a traditional DRM system (such as that described in U.S. Pat. No. 7,743,259, issued Jun. 22, 2010, entitled “System and method for digital rights management using a standard rendering engine”). The receiver's device can then retrieve the program code for the obscuration technique from the library, determine how the content should be rendered based at least in part on whether the one or more conditions are satisfied, and render the content in accordance with the determination of how the content should be rendered. The rendering may include executing program code corresponding to an obscuration technique for obscuring the content during rendering to thereby obscure the rendered content. In an alternative to this arrangement, the obscuration technique may not originate from the server-side library, and may instead be obtained from a community via crowd sourcing, for example. In one embodiment, this obscuration technique library may be implemented using well known technologies like those used by Google and Apple in their respective mobile application stores (e.g., “Play” and “iTunes”).

Transmission of Content

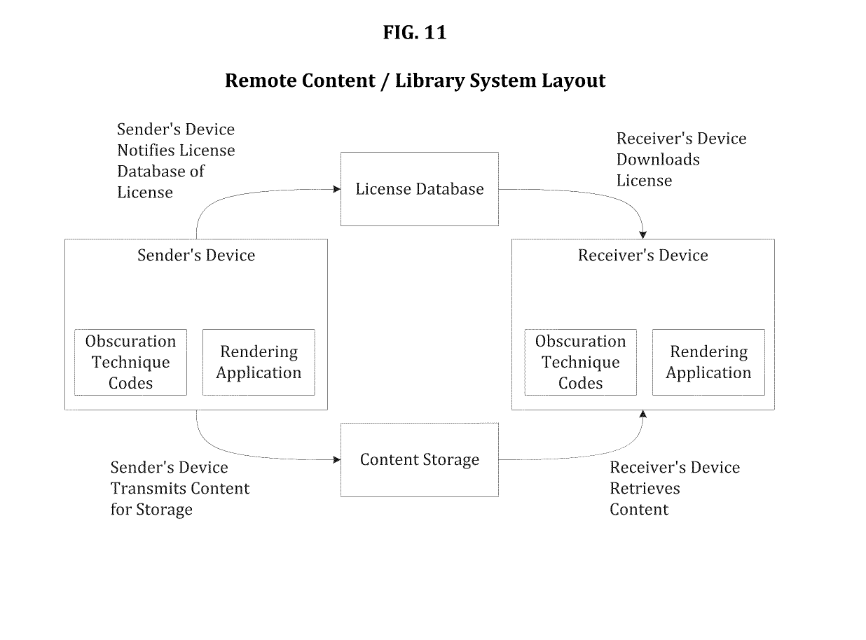

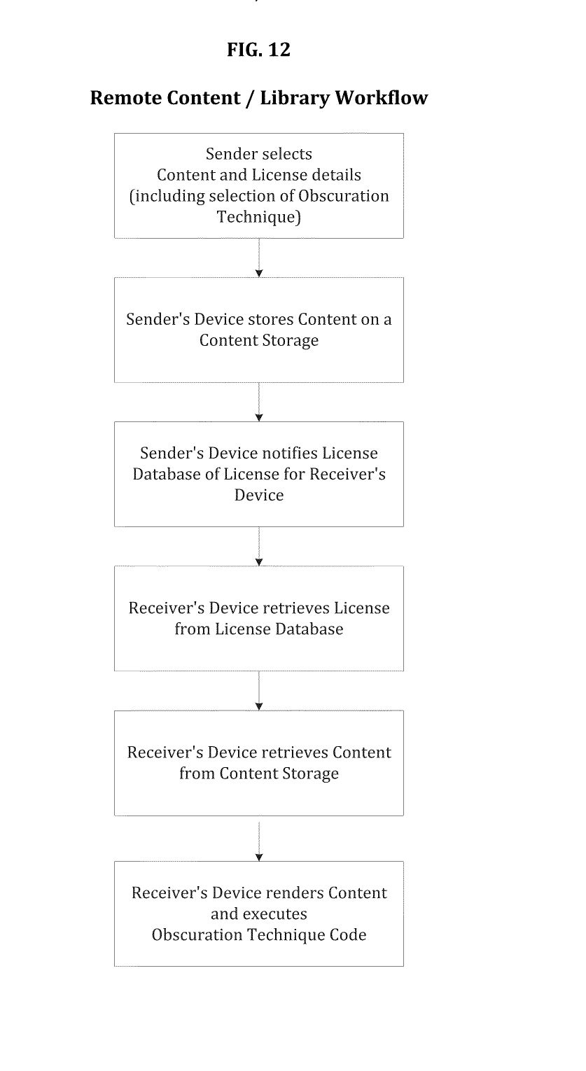

While aspects of the embodiments disclose content being sent from the sender's device to the receiver's device, the content may instead be stored on a server-side content storage or other system storage. FIGS. 11 and 12 illustrate exemplary system layouts and workflows associated with the use of a network-based content storage. In this arrangement, the sender's device can store an encrypted version of the protect content on a network file server or other content storage. The sender's device can then synchronize a license that authorizes use of the content with a license database. The license can be for specified users and authorized applications/devices, and can require that an obscuration technique be applied according to the parameters specified. The receiver's device can then download (or synchronize) the license with the license database. In this manner, the receiver's device can build a database of licenses that can be synchronized as needed with the server (each license has the location of the encrypted content as well as the keys and usage rules including obscuration techniques and parameters). The receiver's device also retrieves the content from the content storage and uses a key in the license to decrypt and render the content according to the usage rules of the specific content including application of the obscuration technique.

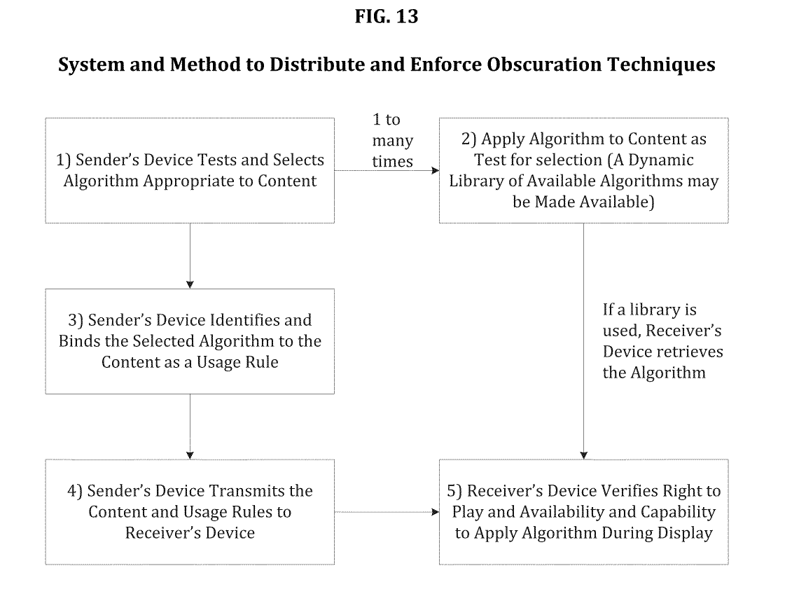

As described above, the disclosed embodiments can be used in a variety of sender device, receiver device, and server configurations. An overall workflow for a variety of these configurations is illustrated in FIG. 13. While many of the embodiments described herein refer to the use of obscuration techniques in conjunction with DRM systems, obscuration techniques can be utilized in systems that are not DRM systems. Exemplary non-DRM systems that can utilize obscuration techniques include web servers that distributed content with code (activex, Javascript and the like). These systems can apply an obscuration technique during rendering of the content in a browser or other application, for example, to protect their content from screen capture or other unauthorized uses. Additionally, rendering applications can unilaterally apply obscuration techniques to all or some content as a general deterrent to screen capture or other unauthorized use (e.g., capturing content displayed on a billboard or a screen in a theater, for example, with a camera). Obscuration techniques can be applied unilaterally (e.g., without specific instruction associated with the content) or selectively in some environments. As an example, Data Loss Prevention (DLP) systems often recognize sensitive content and treat it differently (e.g., if the word “Secret” appears in the document disable “print”). This approach can be expanded using obscuration techniques. For example, if the word ‘Secret’ appears in a document be rendered, the rendering application can automatically apply an obscuration technique).

Obscuration Technique Selection and Distribution Process

The obscuration techniques described herein can be applied to content in a variety of ways. In some embodiments, the following process may be used. First, an image layer can be created for the obscured rendering. This image layer may include the source content (or any other content to be displayed). If a masking obscuration technique is being used, a mask layer can also be created, which may accept user interface elements. This layer can be overlaid over the image layer in the display. The mask layer can be any suitable shape, for example, a circle, a square, a rounded corner square, and the like. During rendering, the mask layer should not prevent the image layer from being viewed unless there are obscuration elements within the mask layer that obscure portions of the image layer. In some embodiments, the mask layer can be configured by a content owner or supplier through any suitable input method, for example, by touching, resizing, reshaping, and the like. Then, one or more sequence of images can be created from the source content, and each image in each sequence can be a transformation of the source content. When the sequences of images are viewed sequentially, for example, at the refresh rate of the display screen or a rate that is less than the refresh rate of the display screen (e.g. every other refresh of the screen, etc.), the displayed result of the sequences of the images approximates the original source image. In some embodiments, multiple sequences of image frames (e.g. 2-100 or more in a sequence) can be generated, and more than one type of transformation technique may be used. The image frames from one or more of the sequences can then be rendered at a rate that can be approximately the refresh rate of the display screen (e.g. 15-240 Hz). In some embodiments, the user can select which sequence of image frames to display (e.g. sequence 1, sequence 2, etc.).

The mask layer can then be used to overlay the rendered sequence over the image layer, which creates a background of the source image via the image layer with the mask layer selecting where to show the sequence of transformed image frames. In some embodiments, the user can manipulate the mask layer while also previewing different sequences of image frames, and the user can also select a combination of a mask shape and/or form with a selection of a sequence. The resulting selections can be stored, associated with the source content, and distributed with the source content.

The source content and the selected mask and sequence(s) can then be transmitted to a receiving device. When the receiving device renders the source content, the selected mask and the selected sequence of image frames can be used to render the content obscurely.

Obscuration Technique Embodiments:

The obscuration techniques described herein can be applied to content during an obscured rendering in a variety of ways. First, the obscuration techniques described herein are often positioned in front of (e.g., overlay) content when the content is displayed. These types of obscuration techniques are sometimes referred to herein as a “mask”, or a “masking obscuration technique”. As described herein, the obscuration elements can be stored as a data structure in a memory of a computing device that is displaying the content. For example, if the obscuration elements have a height and width of 10×10, then it can be stored in memory as a multidimensional array of pixels:

Pixel Output_Image[10][10];

The above pseudo code instantiates a variable “Output_Image” which is comprised of a 10 by 10 matrix (multidimensional array) of variables of the type “Pixel.” Alternatively, the output image can be stored as a one-dimensional array of pixel variables instead of a multidimensional array by instantiating the array to the total number of pixels (e.g., Output_Image[100]).

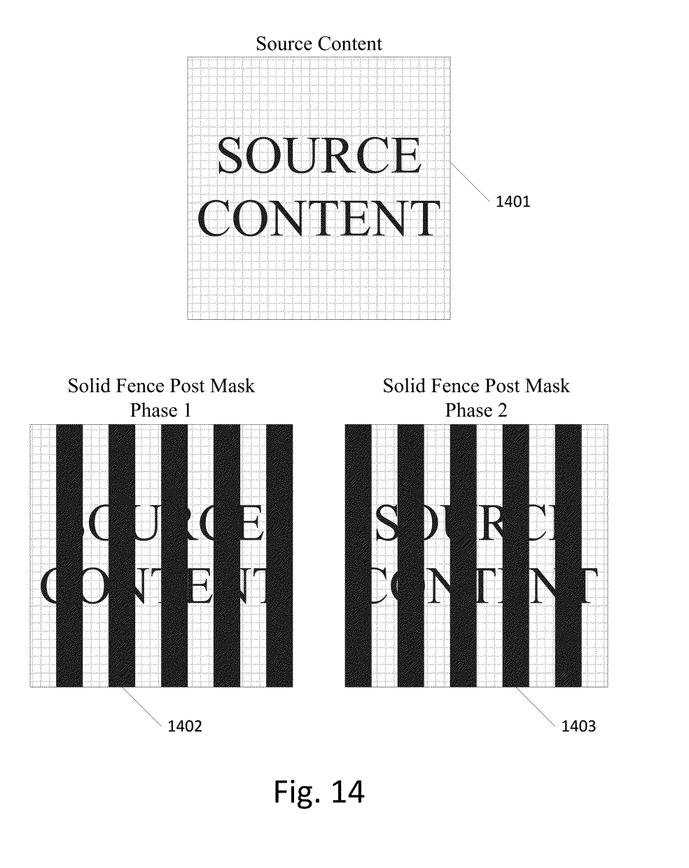

FIG. 14 illustrates a fence post mask according to aspects of the disclosed embodiments, which will be described in more detail below. Box 1401 corresponds to the source content, which can be comprised of pixels (and corresponding data structures) as described above. For example, if the source content is a video comprised of a plurality of frames, then numeral 1401 can represent an individual image frame of the video at time t, where t is any time within the duration of the source content. If the source content is an image, then 1401 can represent the image. For the purpose of this explanation, the source content will be referred to as an image, but it is understood that the source content can be a frame of a video or any other content that is configured for output to a display device. Additionally, although 1401 illustrates a 10×10 sample of the image, this is provided for explanation only, and the actual image size can vary.

When applying a mask, each pixel in the source content is combined with the mask to generate the output pixel. There are many ways to combine the mask with the source content. The mask can define a mask area in which to apply a masking function. Alternatively, the mask can be applied to the entire source content and can define a first set of operations to be performed on pixels falling within a first area and second set of operations to be performed on pixels falling within a second area.

For example, box 1402 of FIG. 14 illustrates the output image after a first phase of applying the fence post mask to the source content. As shown in box 1402, vertical strips of pixels are blacked out by the mask. As discussed above, there are many possible ways to apply this mask, but each method of application will generally:

1) identify a plurality of pixels in the source content to which the mask applies; and

2) perform a masking function on the identified pixels, resulting in a change of one or more data values in each identified pixel's corresponding data structure stored in memory.

For example, if each pixel data structure corresponding to each pixel of the source content includes pixel intensity values for each of the colors and if the colors are red, green, and blue, then the pixel intensity values for a pixel variable could be 31, 63, and 21, indicating a red value of 31, a green value of 63, and a blue value of 21.

When applying the mask shown in box 1402 of FIG. 14, after a mask area including a plurality of pixels is identified, a masking function can be applied to each of the identified pixels in the mask area to “black out” the identified pixels. In this case, the masking function can be:

Mask_Pixel.red=100

Mask_Pixel.green=100

Mask_Pixel.blue=100

As a result of the above operations, each of the color intensity values in the data structure of the pixel “Mask_Pixel” would be set to their highest possible values, resulting in an overall color of black. By applying this masking function to each of the pixel data variables for the pixels in the identified mask area, the values of each of the pixel intensity variables stored in memory for each pixel would be set to 100, and the resulting output image would have black bars as shown in box 1402.

Box 1403 illustrates an output image after a second phase of the solid fence post mask is applied to the source content. As shown in box 1403, the resulting mask is similar to that of box 1402, but the mask area is different.

The mask area can be defined in terms of height and/or width or by some area function. For example, if the source content has a content height H and a content width W, the mask area corresponding to box 1402 can be defined as:

MaskArea Height Area=0 to H

MaskArea Width Area=(W/10) to (2W/10), (3W/10) to (4W/10), (5W/10) to (6W/10), (7W/10) to (8W/10), and (9W/10) to (10W/10).

Each pixel in the source content have associated X and Y coordinates and these X and Y coordinates can be checked against the MaskArea Height Area and MaskArea Width Area to determine if the pixel falls within the mask area. If the X coordinate is within the MaskArea Width Area and the Y coordinate is within the MaskArea Height Area, the pixel falls within the mask area and the masking transformation can be performed on the pixel data values to transform the data values stored in memory for that pixel, resulting in a masked pixel in the output image.

Similarly, the mask area corresponding to the box 1403 can be defined as:

MaskArea Height Area=0 to H

MaskArea Width Area=0 to (W/10), (2W/10) to (3W/10), (4W/10) to (5W/10), (6W/10) to (7W/10), and (8W/10) to (9W/10)

The mask areas for subsequent phases of the solid fence post mask can alternate between the mask area for the first phase and the second phase.

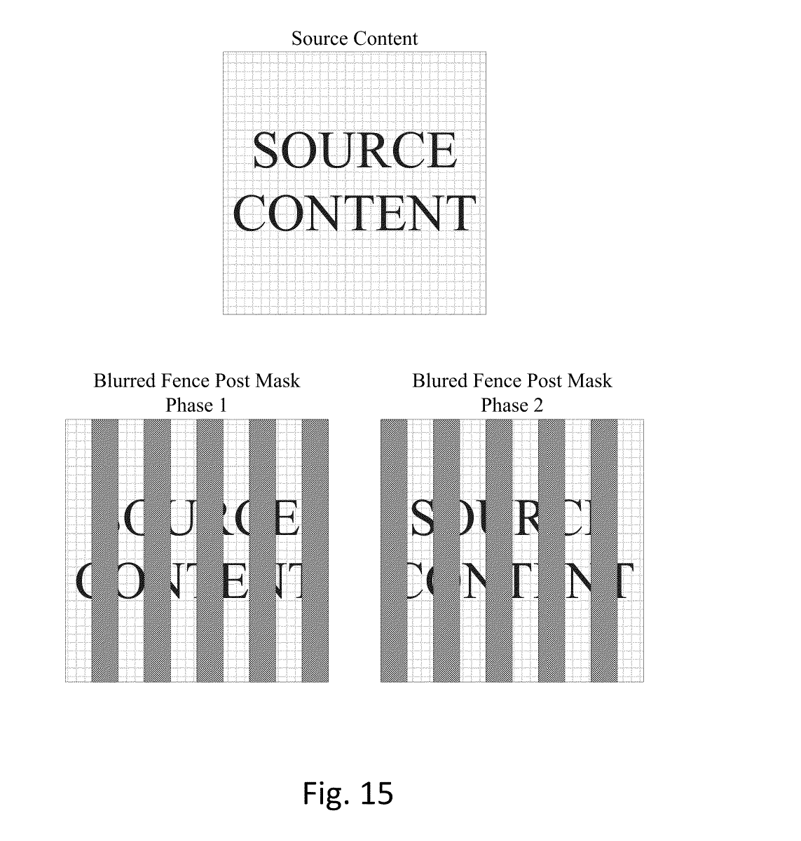

FIG. 15 is similar to FIG. 14 but differs with regard to the masking transformation. In this case, the masking transformation is a blur function. A blur function can combine the pixel intensity values for a pixel with intensity values of surrounding pixels. For example, this can be performed by computing an average intensity for each color for each surrounding pixel around a target pixel and setting the corresponding intensity values for each color in the data structure corresponding to the target pixel to the average intensity values. The surrounding pixels used in the computation can be the nearest neighbors of the target pixel (i.e., within a neighborhood of 1) or can be selected from a larger neighborhood.

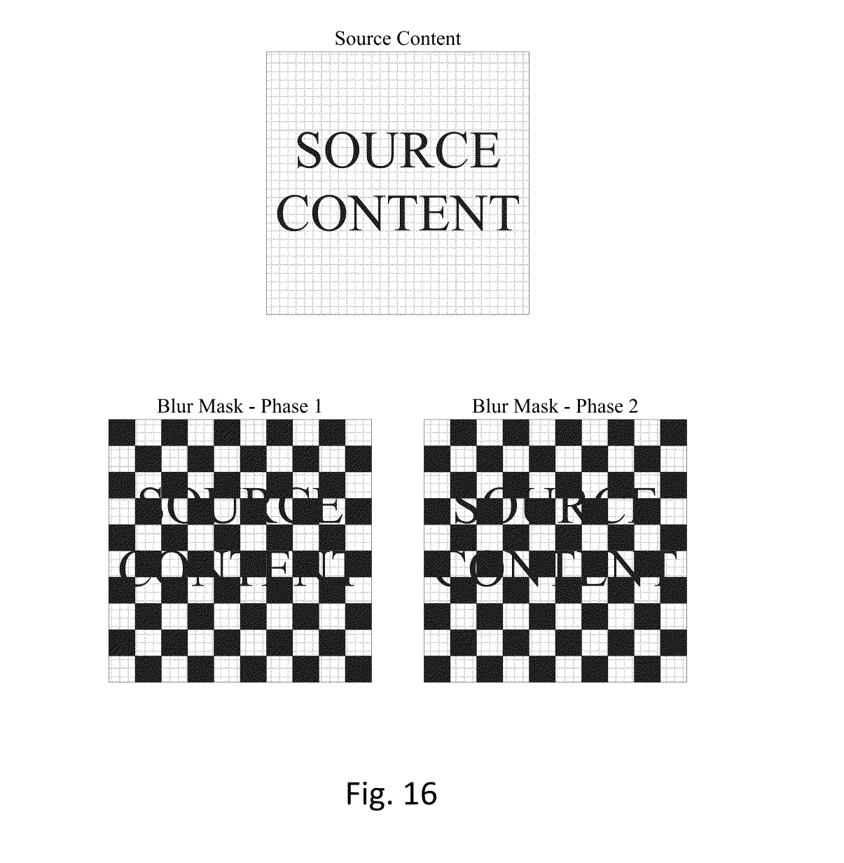

FIG. 16 is similar to FIG. 14 but differs with regard to the masking area. In this case the masking area may be defined through a more complicated set of rules, resulting in the first checkerboard pattern for the first phase and the second checkerboard pattern for the second phase. Subsequent phases can alternate the mask area back and forth between the first and the second checkerboard pattern.

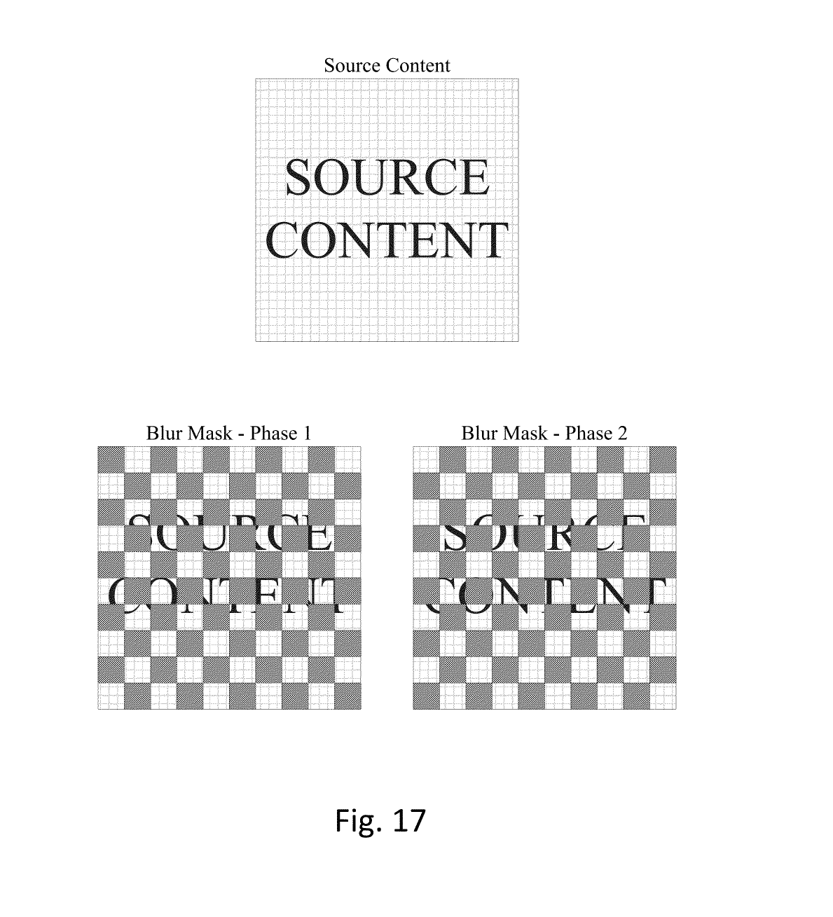

FIG. 17 is similar to FIG. 16 but differs with regard to the masking transformation. In this case, the masking transformation is a blur function as described above.

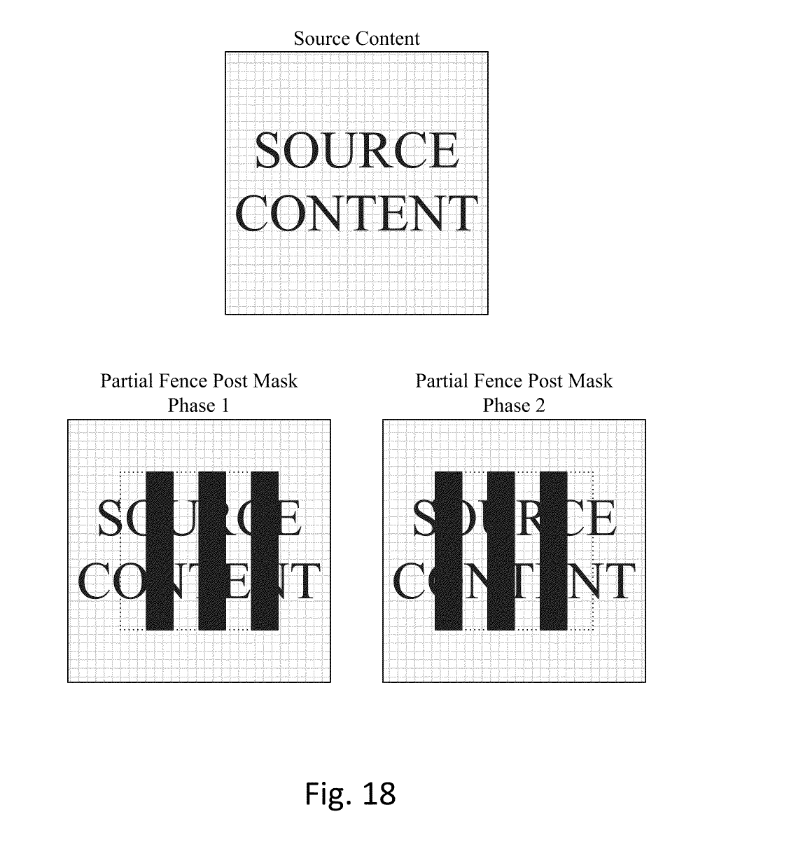

FIG. 18 is similar to FIG. 14 but differs with regard to the masking area. In this case, the masking height area does not include all height values.

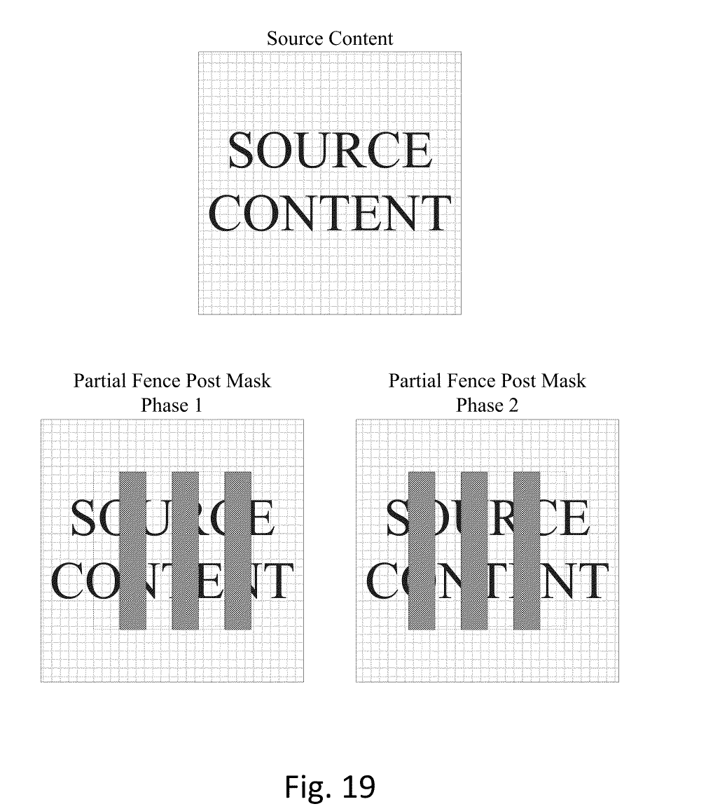

FIG. 19 is similar to FIG. 18 but differs with regard to the masking transformation. In this case, the masking transformation is a blur function as described above.

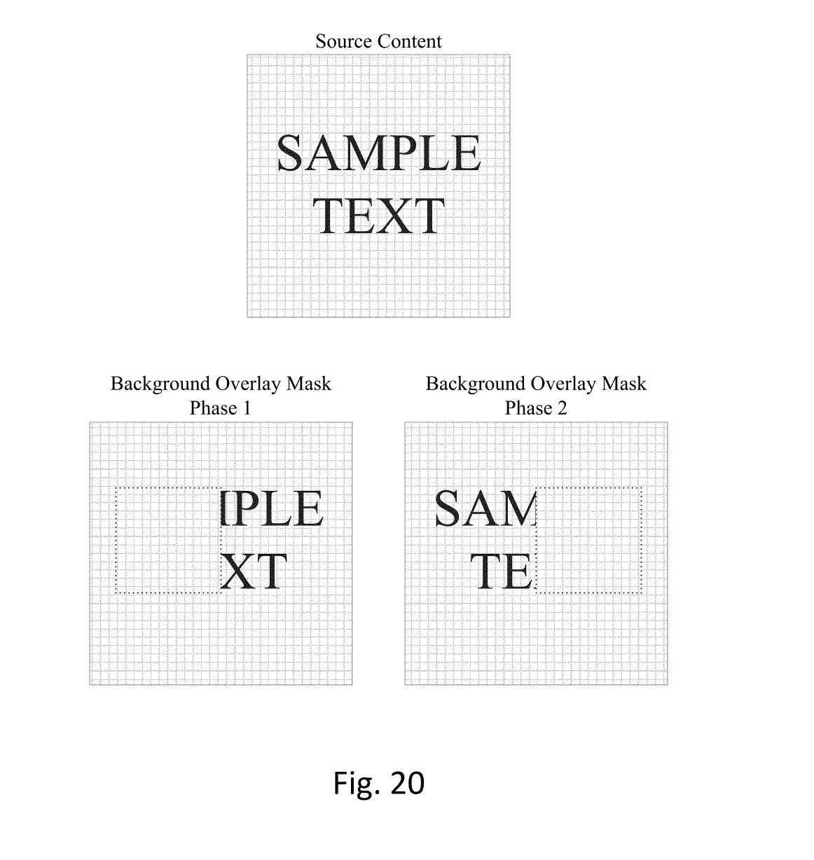

FIG. 20 illustrates a masking transformation that performs a “white-out” of pixels that fall within the masking area. This can be performed by setting the pixel intensity values in memory for all pixels falling within the mask area to zero.

Other embodiments include using obscuration techniques that alter the content itself during the obscured rendering. These types of obscuration techniques are sometimes referred to herein as “transformations”, or “transforming obscuration techniques”. An example of a transforming obscuration technique includes frequently altering the color or brightness of content during obscured rendering.

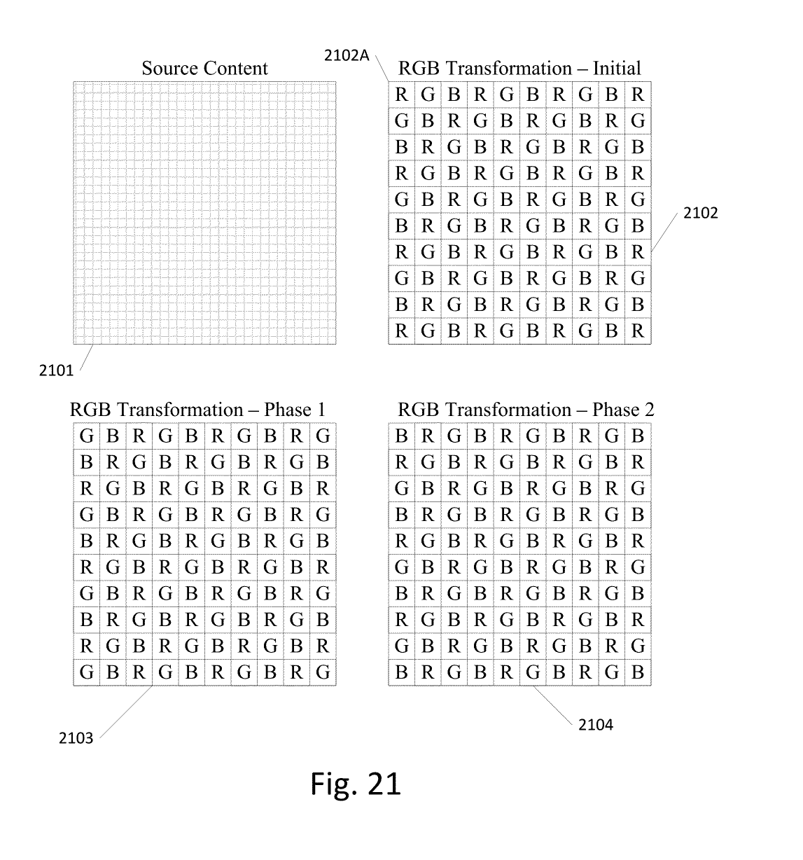

FIG. 21 illustrates an exemplary Red-Green-Blue (RGB) transformation according to aspects of the disclosed embodiments. The top left box, numeral 2101, corresponds to the source content. For example, if the source content is a video comprised of a plurality of frames, then numeral 2101 can represent an individual image frame of the video at time t, where t is any time within the duration of the source content. If the source content is a still image, then 2101 can represent the image.

The top right box, numeral 2102, illustrates the pixel values of the pixels in the source content. For the purpose of this explanation, the source content will be referred to as an image, but it is understood that the source content can be a frame of a video or any other content that is configured for output to a display device. Additionally, although 2102 illustrates a 10×10 sample of the image, this is provided for explanation only, and the actual image size can vary.

As shown in 2102, each pixel is one of three colors red (R), green (G), or blue (B). This can be stored in the Pixel data structure using a variable corresponding to pixel color. The variable can be an integer value which represents the pixel color. For example, the value 0 can correspond to the color red, the value 1 can correspond to the color green, and the value 2 can correspond to the color blue. If a user wanted to instantiate an individual pixel and set it to the color blue, they could use the following pseudo-code:

Pixel SamplePixel;

SamplePixel.color=2;

Referring to box 2102 in FIG. 21, pixel 2102A in the top left corner of the box is red. If a user wanted to change the color of pixel 2102A to green, they could modify the color value stored in memory for that pixel. If the output image is represented as a multidimensional array as discussed above, then the color can be changed using the following pseudo code:

Output_Image[0][0].color=1

In this scenario, the value of the data stored in memory for the color variable of pixel 2102A (at location 0,0) is changed from 0 (for red) to 1 (for green).

Turning to box 2103, the RGB transformation will be described in more detail. Box 2103 represents the output image after a first phase of the RGB transformation. As shown in box 2103, each of the individual pixel values of the source content has been transformed by changing the color to the next color in the red-green-blue spectrum. This can be performed by changing the color variable in the data structure stored in memory and associated with each pixel in the output image. For example, the following pseudo-code can be used to perform the first phase of the RGB transformation:

for (int i=0; i<9;i++)
{
for (int j=0; j<9; j++)
{
Output_Image[i][j].color++;
Output_Image[i][j].color= Output_Image[i][j].color % 3; // in case color
value is 3
}
}

This function increments each of the pixel color values for each of the pixel data structures in the Output_Image data structure stored in memory to the next possible pixel color value. So a color value of 0 becomes 1, a color value of 1 becomes 2, and a color value of 3 becomes 0 (using the modulus operator).

Of course, this example is provided for illustration only, and the actual storage of the pixel color values and data structure and the RGB transformation can take many different forms. For example, each pixel data structure can have intensity variables corresponding to each of the colors that make up each pixel and each of these intensity values may be modified during the RGB transformation to cause, for example, the cumulative color of each pixel to change (e.g. from red to green to blue, etc.) after each phase.

Box 2104 illustrates the output image if the RGB operation were performed again. As shown in box 2104, each of the pixel color values in each pixel data structure has been incremented once more. When the RGB operation is performed again, the previous output image can be used as the source content and the pixel values can be incremented accordingly.

Further embodiments include moving obscuration elements relative to the content during an obscured rendering. This technique is sometimes referred to herein as “animations”, or “animated obscuration techniques”. During an obscured rendering using animations, the content can remain perceptible through the movement of the obscuration relative to the displayed content, as described below. The result can be an animated display of the content in combination with the moving obscuration. However, if the display of the content with the obscuration is frozen at any instance of time (e.g., via screen capture), the obscuration visually obscures at least a portion of the content.

As described above with reference to masks and transformations, there are many possible ways to apply animations, but each method of application will generally:

1) identify a plurality of pixels in the source content to which the animation applies; and

2) perform an animation function on the identified pixels, resulting in a change of one or more data values in each identified pixel's corresponding data structure stored in memory.

While these types of obscuration techniques are described separately above, each type of obscuration technique can be used in combination with one or more of the other types of obscuration techniques. For example, animations can be used in combination with masking obscuration techniques and/or transforming obscuration techniques, and more than one type of obscuration technique can be applied to content during obscured rendering.

During an obscured rendering, the obscuration of each pixel of the content can be balanced over time such that each pixel is obscured for the same amount of time as each other pixel. For example, the refresh rate of the display can be taken into consideration during the application of the obscuration technique to the content such that the rate of movement of the obscurations relative to the displayed content may be adjusted to equalize the obscuration of each pixel, if possible. Thus, the rate of movement of an animated obscuration for a particular obscuration technique may vary depending on the refresh rate of each particular display. In the alternative, the refresh rates of an individual display may be adjusted based on the rate of movement of the obscuration. As an example, often the load of a computing device or the computational/rendering capability of a computing device to calculate rendering transforms may impact the speed at which a screen can render frames of an obscuration technique. A feedback loop may be used to determine how and when each frame is rendered on the display and the obscuration technique can be altered to respond to performance issues related to load/capabilities of the rendering device and the like. Performance issues that may impact rendering may include, for example, feedback from the device frame buffer indicating that frames are not being displayed due to one or more of: (1) bandwidth constraints between the frame buffer and the display, (2) display device refresh rate, (3) frame buffer utilization for other tasks not related to rendering the obscured content or (4) bandwidth constraints between the CPU RAM and the GPU frame buffer.

The process of applying the obscuration techniques according to aspects of the disclosed embodiments as described herein can be summarized as follows. First, the content and any obscuration elements can be placed in a frame buffer. Then, the device applying the obscuration can make a determination regarding when the frame buffer has been used to deliver content to screen (e.g., the refresh rate). Next, a new set of content or obscuration data can be determined for placement in the frame buffer based on a history of which content has been rendered to the screen. As an example, a call can be registered with the platform that is called during the rendering of each frame. This call can track how many frames have been drawn by the system platform (e.g., the 75 frames have been rendered by the hardware platform). This information can be compared to how many frame have been provided by the obscuration algorithm. Each rendered frame from the obscuration algorithm can be counted independent of how many frames have been rendered by the system. In this example, if the obscuration algorithm counts that it has rendered 55 frames, and the system reports 75 frame have been painted, the rendering device (or any other suitable device) can adjust the obscuration algorithm to utilize fewer computation calculations (increase the distance of a moved bar as an example, or cancel blur and the like) in an effort to better synchronize the platform's actual computational capabilities to ensure that each frame of the obscuration gets rendered on time. Finally, the new set of content can be placed in the frame buffer based on the history of which content was rendered on the screen.

This process overcomes the issue of the screen data being delivered to the screen (display refresh) in an asynchronous fashion relative to populating the data in the frame buffer. Without a feedback loop of understanding when the frame buffer was used to deliver data to the screen, many obscuration techniques can develop moire patterns, and the processes that deliver content and obscuration elements may do so in a regular pattern preventing some elements of the content equal time on the screen. When this occurs, the user may perceive a banding effect of the content. Thus, the mixture of content and obscuration data in the frame buffer can be balanced so that over time each element of the content gets rendered on the screen in a balanced fashion to avoid visual occlusions like moire effects or banding.

Obscuration Technique-Fence Posting

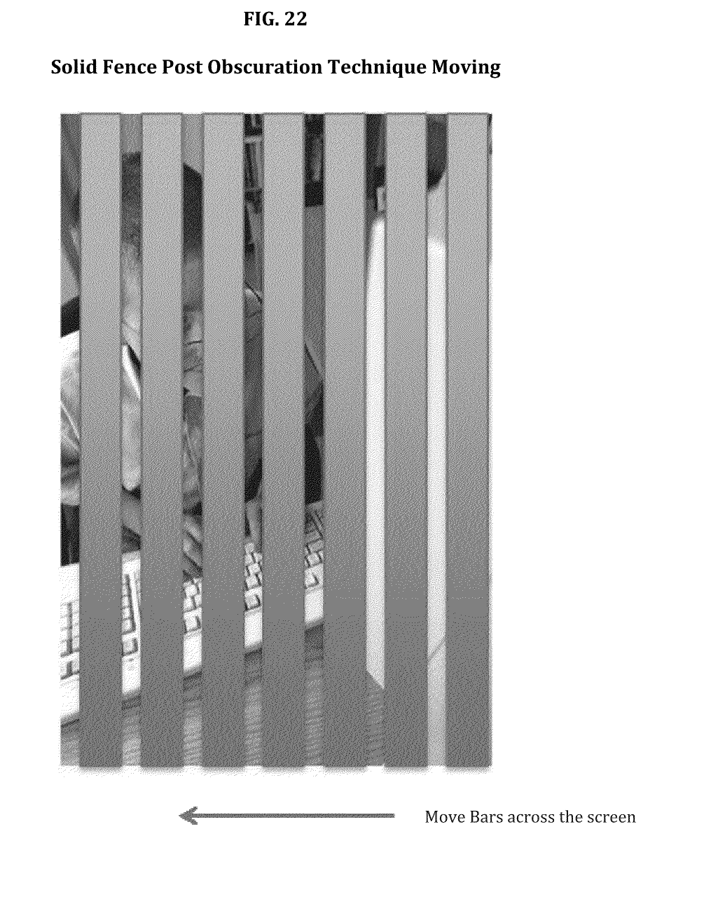

FIG. 22 illustrates a basic “fence posting” obscuration technique. In much the same way as a viewer driving by a fence with gaps between wooden vertical slats can see “through” the fence to the back yard, this technique utilizes the brain's image processing capabilities to construct a valid image formed by piecing together the image behind the fence as seen when slots of the image pass by.

In the most basic case, solid bars can be placed in front of the content with gaps between adjacent bars. The content is obscured by the solid bars and is visible only through the gaps between adjacent bars. The solid bars can move across the image at a rapid rate. In one embodiment, when vertical bars 5 units wide with 1 unit wide gaps between adjacent bars are used, the centerline of each bar may move, for example, six units horizontally in 1/10th of a second (e.g., a screen running at 60 hz would advance the centerline of each bar 1 unit per frame). The bar width, gap width and, hence, the distance between the centerlines of adjacent bars may be preserved as the bars are moved.

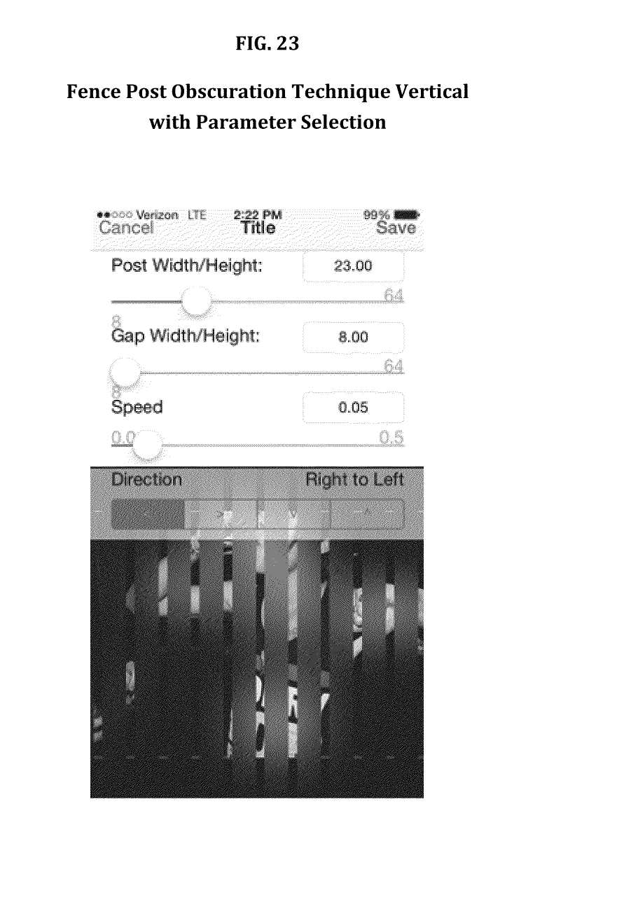

There are many variables or parameters that can be modified with this basic obscuration technique. These may include, for example, the width of the bars, the width of the gaps, the velocity of bar movement, the color of the bars, the orientation of the bars (e.g., vertical, diagonal, etc.), the shape of the bars (e.g., rectangles, curves, waves, abstract, etc.), the direction of movement of the bars (e.g., left to right, right to left, helicopter blades, pie slices, etc.), and the like. FIG. 23 shows an exemplary interface with a variety of parameters.

The term “bar” as used herein refers to any shape that can be moved rapidly relative to the content to allow portions of the content to be both visually perceptible by a user and obscured when a single frame is captured. The movement may occur at a regular rate, or may instead occur at an irregular rate. In some cases, automated multi-frame captures of the obscured content may be attempted. To counter this attempt, the rendering device can alter the rate of movement of the obscuration elements in a random fashion (e.g., instead of 1 unit per frame in the previous example, the movement may be anywhere from 0.5 to 1.5 units per frame randomly). In this manner, a multi-frame capture of 6 frames, for example, would be much more difficult to use to recover the obscured content. The resulting rapid transition of each portion of the image from being exposed to being obscured allows the viewer to construct an image of the content via the brain's image recognition capabilities. Alternatively, if a screen capture was performed, only a portion of the image would available at any given time, with the remainder being obscured. Thus, the screen captured image would be incomplete, and less than useful.

FIG. 23 also shows an aspect of the Fence Posting obscuration technique in which the bars are a derivative of the content they are obscuring. As an example, the original content can be used to create a “blurred” version of the content. The blurred version the content can then be overlaid over the clear content. The “bars” in this scenario can actually be the blurred portion of the image they are overlaying. An analogy of this scenario would be fence posts made of translucent glass. In one embodiment of this approach, graphics transformation algorithms (e.g., GPUImage, found at https://github.com/BradLarson/GPUImage) can be used to generate a blurred version of the content that is being obscurely rendered. Another algorithm (e.g., Apple's iOS call CGImageMaskCreate) can then be used to mask the blurred image so that gaps can be seen between the blurred posts. This process can be used repeatedly to create a sequence of the gaps moving across the image. The resulting masked and blurred image can then be rendered over the content being viewed obscurely and animated using a further algorithm (e.g., Apple's iOS View Architecture, found at https://developer.apple.com/library/ios/documentation/WindowsViews/Conceptual/ViewPG_iPh oneOS/WindowsandViews/WindowsandViews.html#//apple_ref/doc/uid/TP40009503-CH2-SW1).

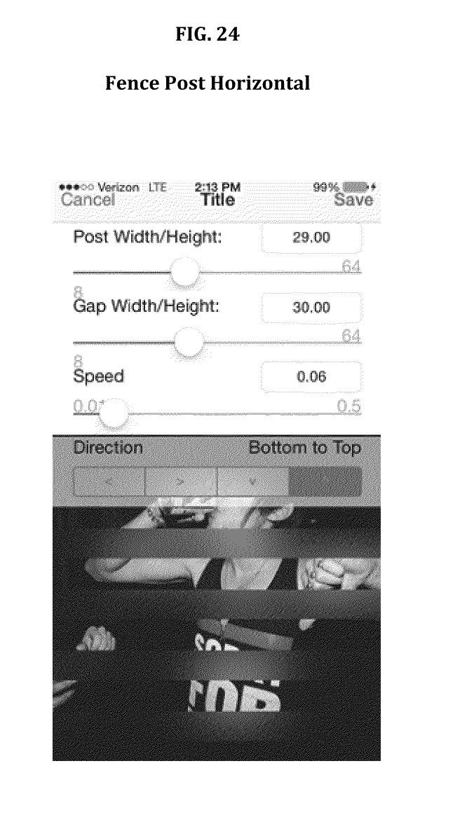

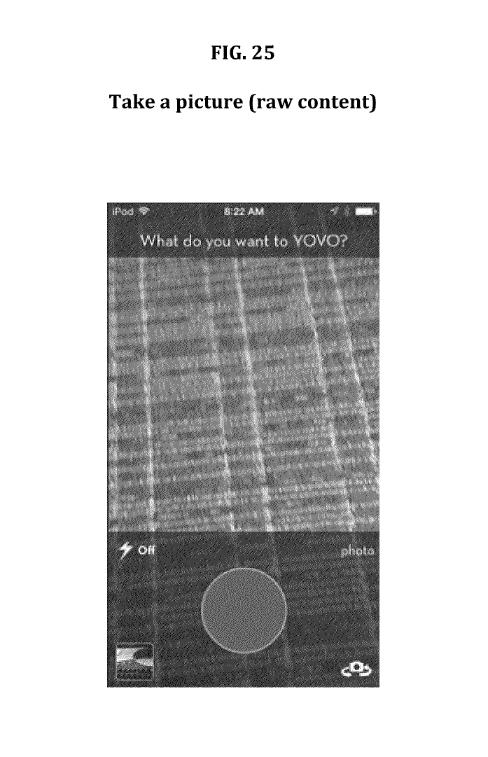

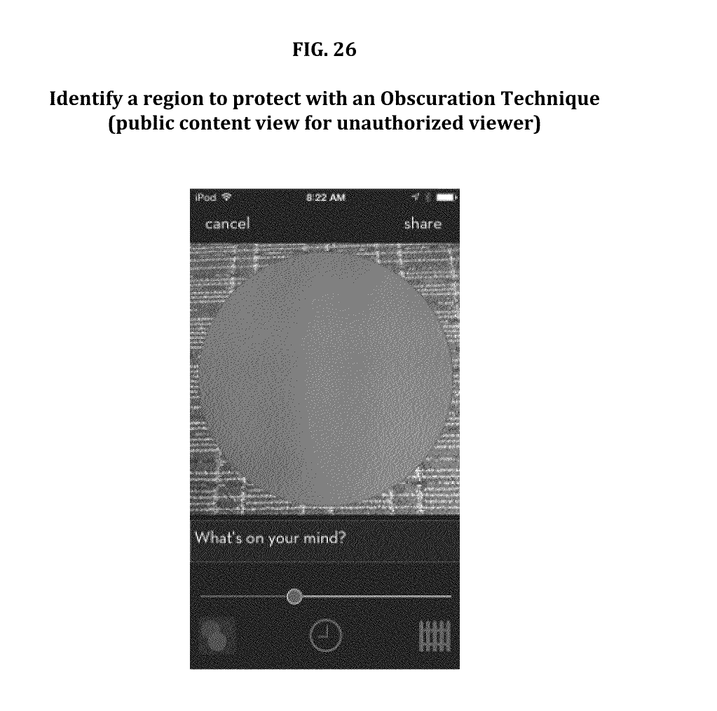

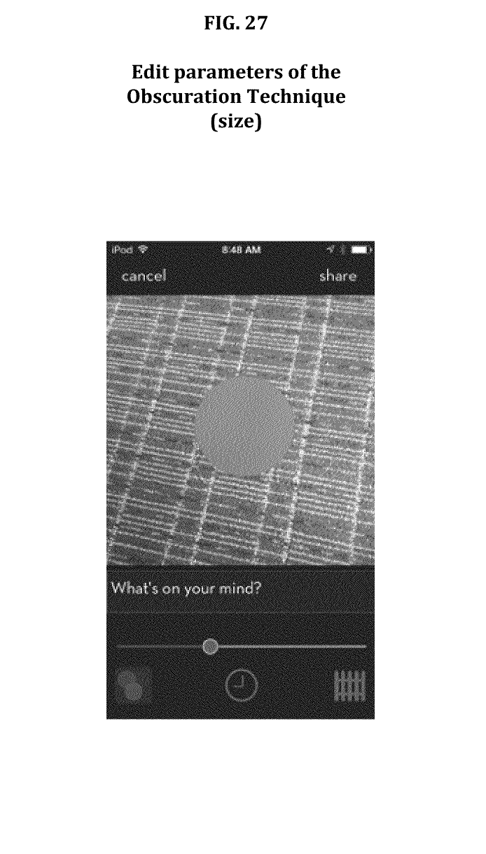

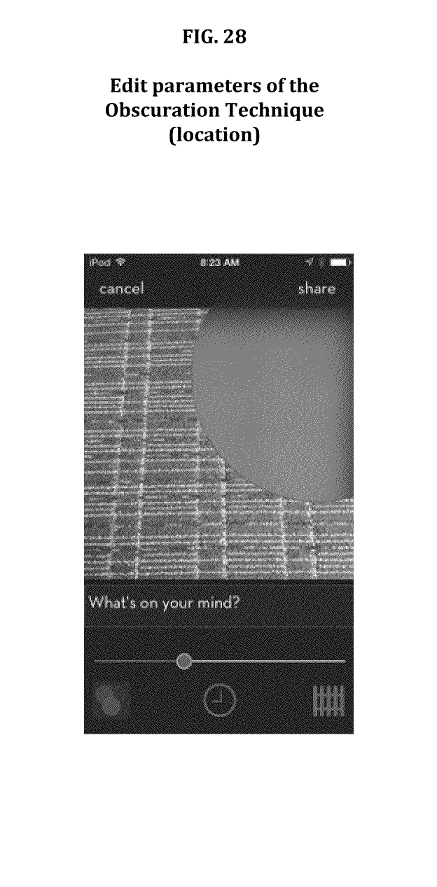

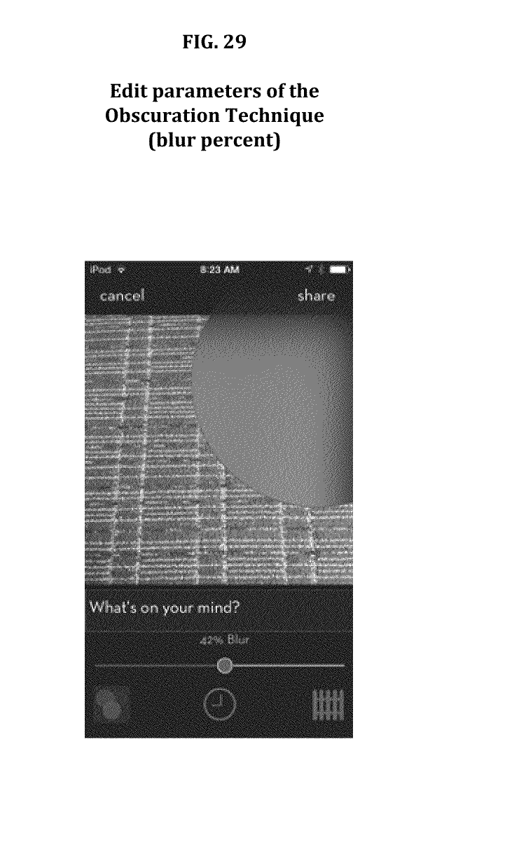

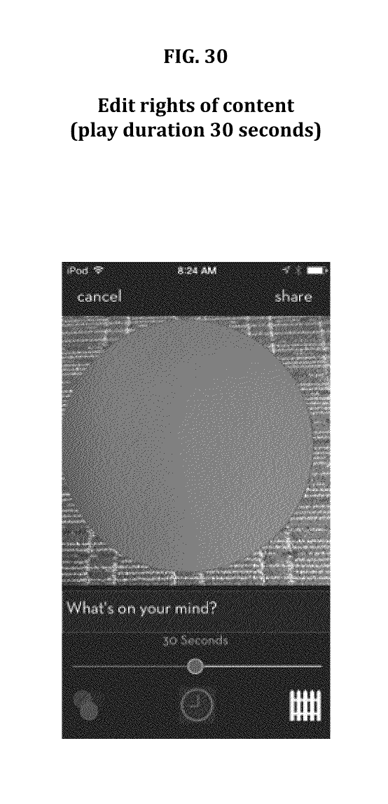

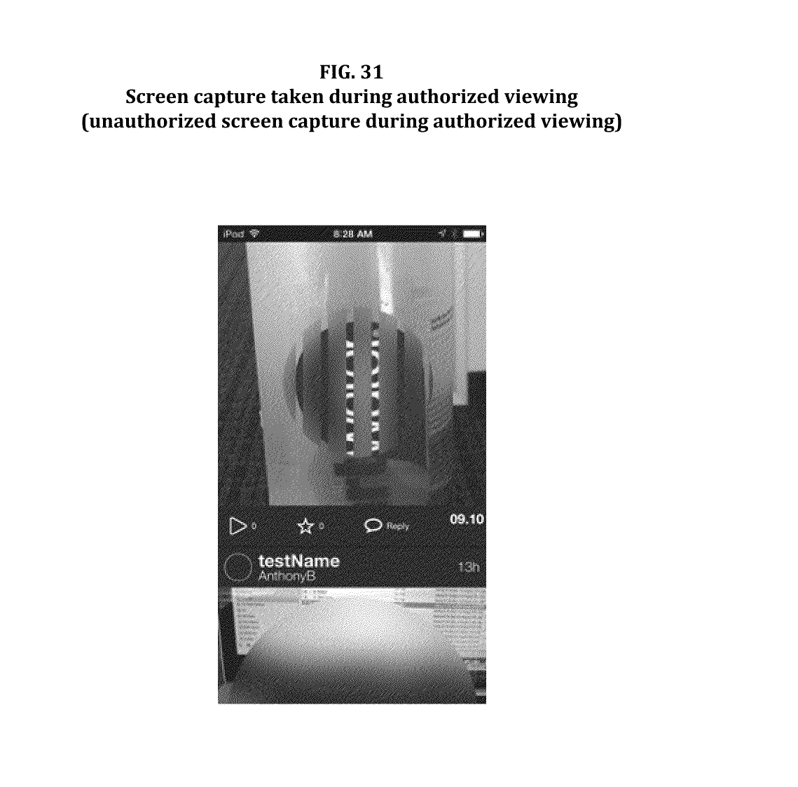

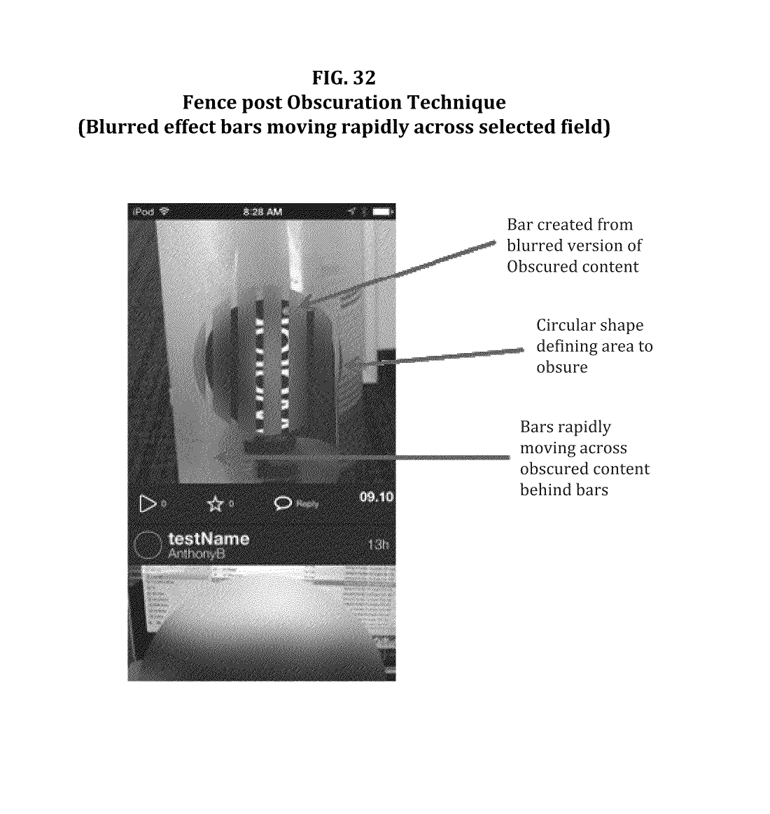

FIG. 24 shows an alternative Fence Posting obscuration technique in which the bars are horizontal rather than vertical. FIGS. 25-32 illustrate the steps of an exemplary selection and application of an obscuration technique according to the disclosed embodiment. FIG. 25 illustrates a picture taken of the original (raw) content. FIG. 26 illustrates the identification of a region to protect with an obscuration technique. This is also an exemplary illustration of how the content can appear to an unauthorized user. FIG. 27 illustrates an exemplary user interface for editing a parameter relating to the size of the obscuration. FIG. 28 illustrates an exemplary user interface for editing a parameter relating to the location of the obscuration. FIG. 29 illustrates an exemplary user interface for editing a parameter relating to the blur percentage of the obscuration. FIG. 30 illustrates an exemplary user interface for editing a parameter relating to the rights of content (e.g., play duration 30 seconds). FIG. 31 illustrates an exemplary screen capture taken during authorized viewing (e.g., an unauthorized screen capture during authorized viewing). FIG. 32 illustrates an exemplary fence post obscuration technique (Blurred effect bars moving rapidly across selected field). FIG. 31 also shows how multiple obscured contents can be offered for viewing.

Obscuration Technique—T-Jigsaw Jitter

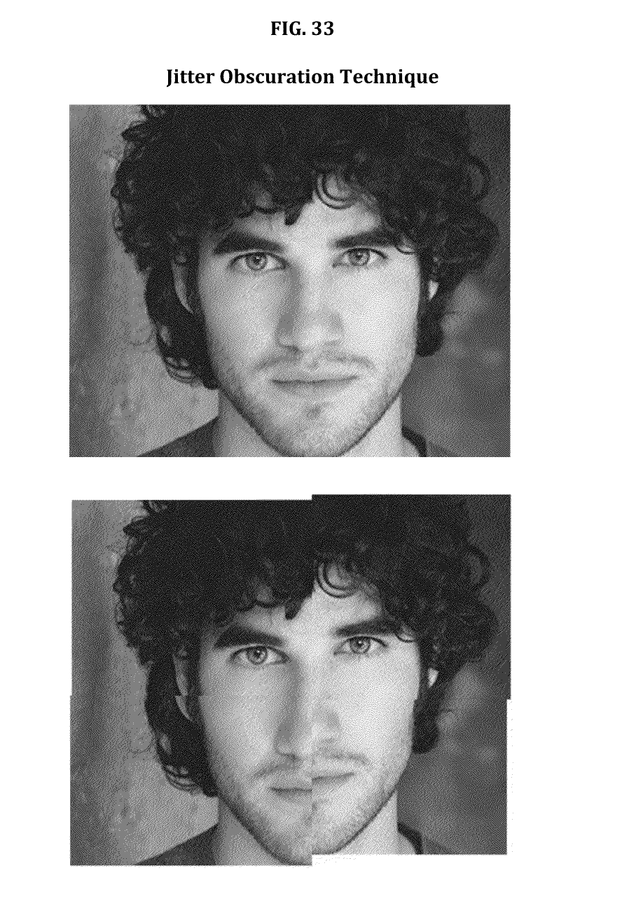

FIG. 33 illustrates an exemplary 2×2 Jitter obscuration technique. This obscuration technique can be used to divide the content into multiple segments (e.g., a 30×30 array), and cause the elements of the content to oscillate in different directions, for example, up, down, left, right, etc. As segments collide and overlap one another, one segment can be chosen to override the other. The distance of oscillation can be determined in any manner, and can be based, for example, on a percentage of the segment size (e.g., each segment of the content can be addressed as a row and column. For example, row 1 column 2 would be addressed 1,2. The obscuration algorithm can then displace each segment using an algorithm like: frame1—displace segment 1,2 by 10% of its height up, frame2—return segment to its center, and frame 3—displace segment 1,2 11% of its width right, etc.)

Obscuration Technique—Rendering Client ID Information

In another configuration, the obscuration can include information that identifies an entity, such as the sender or receiver. For example, the obscuration technique may include placing a transparent window over at least a portion of the content, and the identifying information, such as a phone number, may be placed in the window. The obscuration technique may include moving the identifying information around inside the window. In this manner, not only will the identifying information serve to obscure the content during obscured rendering, but if a screen capture is taken, the identifying information can be shown. In a related embodiment, a font color can be chosen that approximates the surrounding background in the content being obscurely viewed. This can be accomplished through the use of known algorithms (e.g., GPUImageAverageColor, found at https://github.com/BradLarson/GPUImage). The identifying information (e.g., phone number) can then be included in the obscured rendering in that font color and, for example, animated to move every frame (e.g., 60 hz) so as to minimize the viewer distraction. In an alternative configuration, the identifying information may be replaced with other information, such as an advertisement, etc. Thus, information can be conveyed to a user via the screen capture.

Obscuration Technique—Auto Face

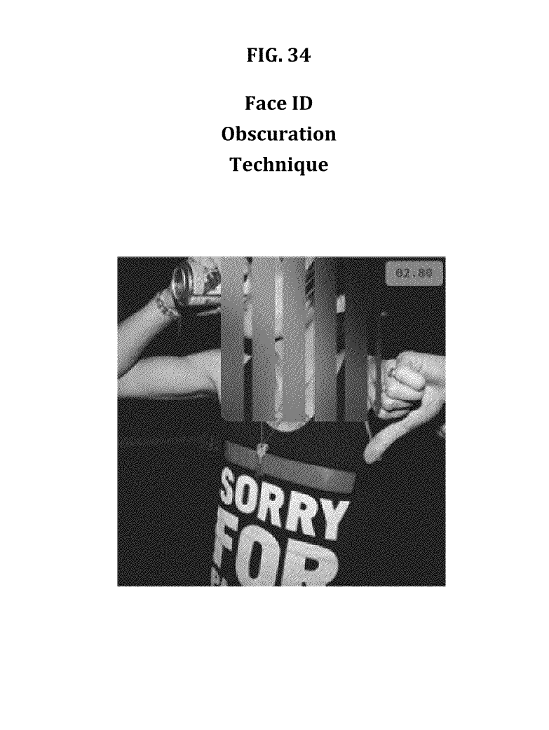

Another aspect of the obscuration techniques is to prevent automated facial recognition of a subject in the images of the content. FIG. 34 illustrates an exemplary Face ID obscuration technique. In some cases, websites, such as social networking sites, can “tag” a person's face and then use the “tagged” person's face to apply facial recognition to find that same person in images where that person was not explicitly tagged. This represents a huge privacy issue as more and more images are managed by big data systems. An aspect of the disclosed embodiments allows for an optimized obscuration technique to counter this privacy threat.

For example, a sender's device can load content into the sending client, and the sending client can use well-known image processing techniques to “find faces” that are in the content image (e.g., Apples iOS library of routines, found at https://developer.apple.com/library/ios/documentation/graphicsimaging/Conceptual/CoreImaging/ci_detect_faces/ci_detect_faces.html). Typically, these algorithms are used to give senders an opportunity to “tag” the identity of the face in the image. However, according to this aspect of the disclosed embodiment, a similar or identical algorithm can be used to identify faces to which a targeted obscuration technique may be applied. In this way, auto facial recognition techniques cannot identify the faces that are included in the content. Thus, a user can quickly and automatically use the disclosed features to protect distributed content from automated facial recognition systems.

At any time during the preparation, distribution, and rendering process, this approach could be used to identify target areas for application of an obscuration technique. For example, during content preparation, the sending application may automatically apply an obscuration technique in an automated fashion (e.g., the application may show an obscured rendering of the content being prepared and offer “we noticed there are faces in this content would you like to apply screen capture protection?”). A similar automated system may be used during distribution. For example, an email server may detect images with faces, automatically convert the images to obscured content, and identifies the faces to be obscured. The server may perform this function by associating an obscuration technique with the content and providing parameters that will place the obscurations over the faces. Another example would be a rendering application that deals with privacy issues (e.g., for a department of motor vehicles for driver's license). The rendering application running on the operator's device may automatically detect faces in a document being processed and render them with an obscuration technique applied to the identified face.

Obscuration Technique—Image Content Splitting

Another obscuration technique involves splitting image content data for pixels across multiple frames. The frames may then be rendered at a sufficiently high rate, e.g., changing frames at >15 Hz, to allow the original image content to be visually perceivable by the viewer. In some embodiments, the frame rendering rate may be: (1)>30 Hz, (2)>60 Hz, (3)>120 Hz, (4) 240 Hz or higher. Higher frame rates permit increased obscuration by reducing the amount of image content data included in each frame. Specifically, each frame has reduced image content data, thereby increasing obscuration. The perception of the image content data from a rendering of the multiple frames is based at least in part upon persistence of vision. Persistence of vision may be characterized by the duration of time over which an afterimage persists (even after the image is no longer being rendered). The duration of time over which an afterimage persists is a function of factors such as image content, which part of the retina captures the image, and physiological factors (such as age, etc.) of the viewer. Because the duration of time over which an afterimage persists is limited (typically < 1/15 second), the multiple frames that make up the image content data should be rendered within that duration. However, if only one single frame is rendered, for example, via screen capture, then that frame would contain transformed image data that obscures at least a portion of the image content.

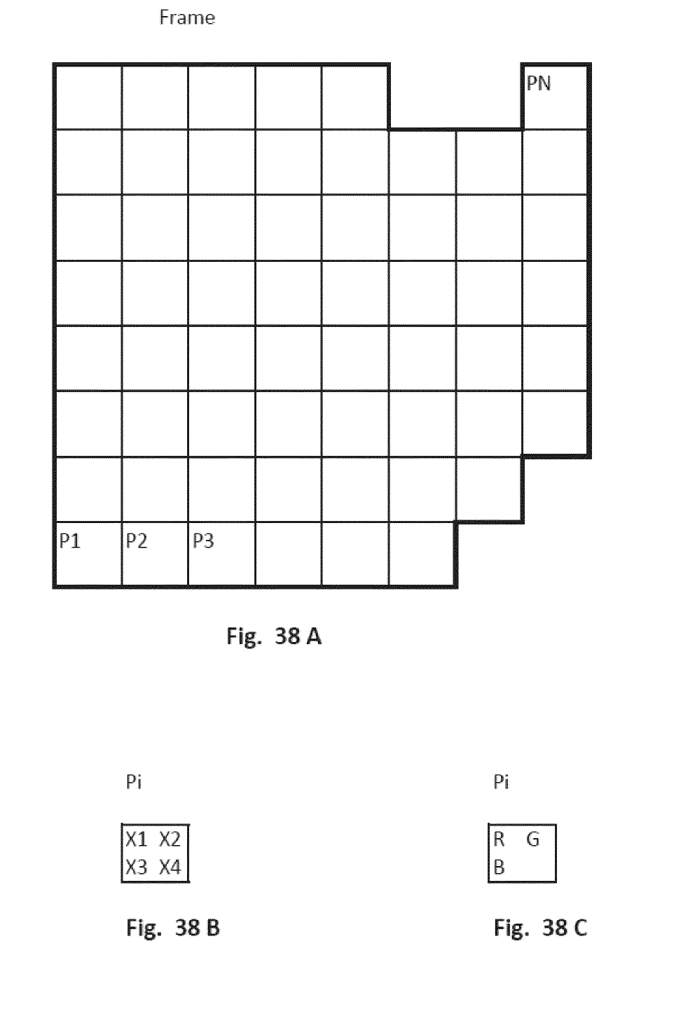

FIG. 38 A shows an exemplary representation of image content data in a frame comprising pixel data P1, P2, P3, . . . , PN. The pixel data comprises input values for one or more color components. In some embodiments, the pixel data may comprise four input values X1, X2, X3 and X4 for four color components as shown in FIG. 38 B. In some embodiments, the four color components may be red, green, blue and white. In some embodiments, the pixel data may comprise three input values R, G and B for three color components red, green and blue, respectively, as shown in FIG. 38 C. In some embodiments, the input values may be 8-bit numbers selected from zero to 255. For example, the input values R, G and B may be 8-bit numbers 80, 140 and 200, respectively.

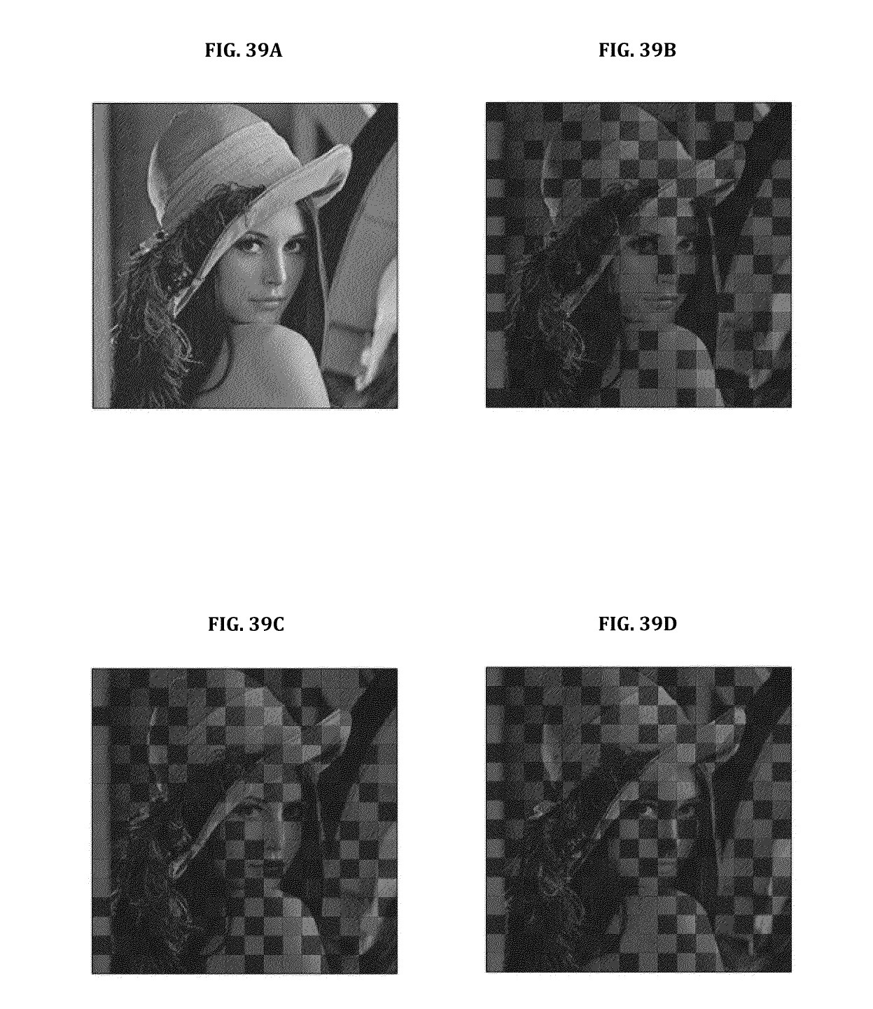

Suppose an image (FIG. 39A) needs to be obscured. In an embodiment of the invention, the (R,G,B) data for a given pixel in the image may be split into three frames, frames 1, 2 and 3, shown in FIGS. 39B, 39C and 39D, respectively. Assume that R, G and B are coloration values for red, green and blue intensities for the pixel ranging from 0 to 255 (8-bit color). For pixel 1, frame 1 (FIG. 39B) includes only the red data (e.g., blue and green are set to zero), frame 2 (FIG. 39C) includes only the green data (e.g., red and blue are set to zero), and frame 3 (FIG. 39D) includes only the blue data (e.g., red and green are set to zero). Pixels that are adjacent to pixel 1 may show a different color (possibly selected at random) in each frame. For example, the pixels adjacent to pixel 1 may show blue or green data in frame 1 (e.g., with red set to zero). In this embodiment, each frame may be made up of pixels that have only one color data with the displayed color varying across the pixels in the frame. Cycling the three frames at a high refresh rate on the display recreates the original image at reduced brightness. The device backlight intensity may be adjusted to compensate for any loss of brightness due to color data splitting. This technique may be applied with any number of frames. For example, additional frames 4, 5 and 6 (not shown) may be used with a different color order for a given pixel than the color order used for frames 1, 2 and 3. For example, if the data shown in frames 1/2/3 was R/G/B for a given pixel, frames 4/5/6 may show B/R/G for the same pixel. Frames 1/2/3 are an exemplary frame set that reproduces the original image data. Frames 4/5/6 are another exemplary frame set that reproduces the original image data. Frame sets may be interspersed. During rendering, frames may be shown, for example, in the following order: 1, 5, 6, 2, 4, 3. In some embodiments, the frame set may be rendered such that the minimum number of frames from another, non-matching frame set are interspersed (i.e., keeping frames from the original frame set from being rendered consecutively) before the full original frame set is rendered. In the example where the frame set has 3 frames, the minimum number of intervening frames from another frame set is 2, for example, the frame order may be 1, 5, 2, 6, 3 (using the frame set 1/2/3 as the original frame set and the frame set 4/5/6 as the non-matching frame set with frames 5 and 6 separating frames 1/2/3, see above).

If a given pixel has the color R/G/B for frames 1/2/3 (respectively), the adjacent pixel may have the colors G/B/R or B/R/G for frames 1/2/3 (respectively) so that the pixels do not have the same color in any frame. For example, if, instead, the adjacent pixel has G/R/B as its color in frames 1/2/3, both pixels will be B in frame 3. For a given frame set, the ordered colors R/G/B, G/B/R and B/R/G may be used for frames 1/2/3 (respectively) to avoid having the same colors on adjacent pixels in any given frame. Alternatively, in a given frame set, the ordered colors G/R/B, B/G/R and R/B/G may be used for frames 1/2/3 (respectively) to avoid having the same colors on adjacent pixels in any given frame.

Frame regions may also be broken up into a checkerboard grid (say 32 by 32 pixels) such that pixels in each checkerboard square use the same assignment rule. The pixels in the adjacent checkerboard square may use another assignment rule. FIGS. 39B-39D illustrate the previous embodiment applied to a 32 by 32 pixel checkerboard pattern with adjacent checkerboard squares applying different assignment rules. For a given frame, the pixels in a given checkerboard square are all one color, red for example. In the same frame, the pixels in the adjacent checkerboard square may all be the same color, but a different color may be used as compared to the color used in the first checkerboard square, blue or green for example.

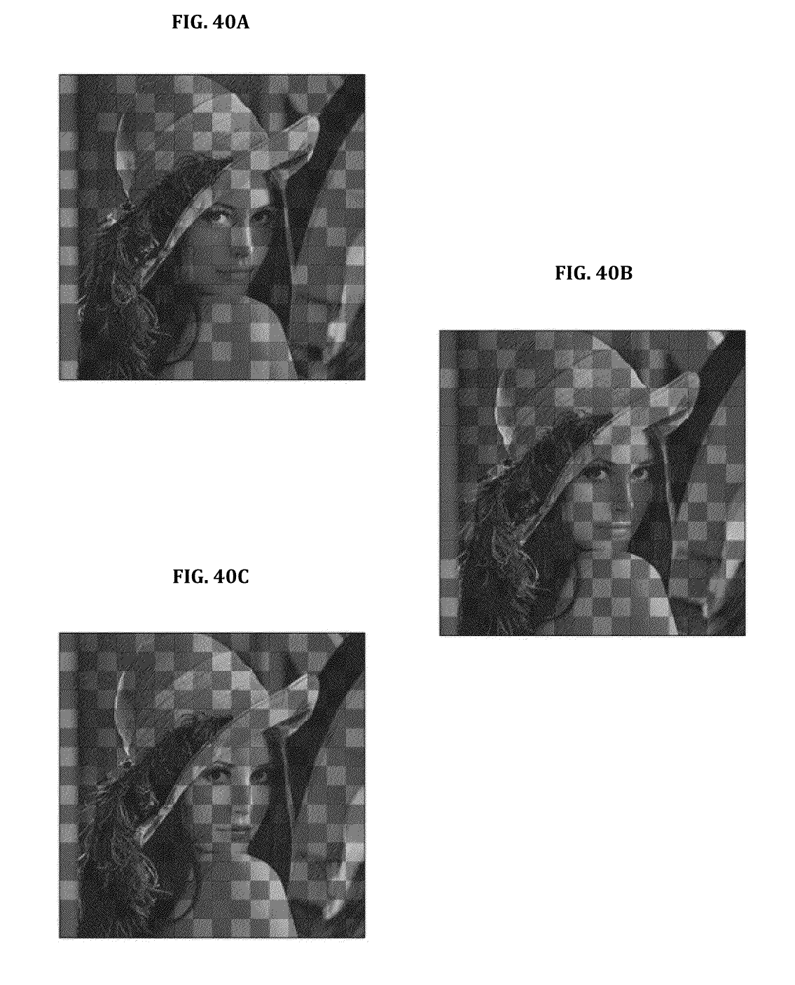

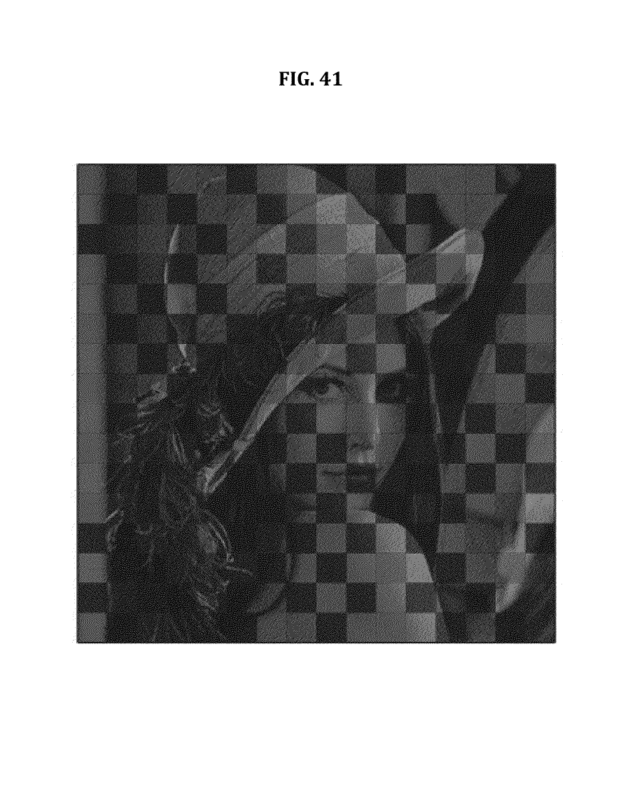

Another exemplary embodiment shown in FIGS. 40A-40C splits the (R,G,B) data for a given pixel in an image again into three frames. However, in this embodiment, each frame shows pixel data for two colors with the third color set to zero. For example, frame 1 (FIG. 40A) may show the RG data (blue set to zero) for a given pixel with frame 2 (FIG. 40B) and frame 3 (FIG. 40C) respectively showing RB and GB data (green set to zero and red set to zero, respectively, for frames 2 and 3). Adjacent pixels in frame 1 may show RB or GB data. Cycling the three frames at a high refresh rate on the display recreates the original image at reduced brightness. The device backlight may be adjusted to compensate for loss of brightness due to color data splitting. FIG. 41 illustrates another embodiment utilizing an RGB transformation.

The perceived output, e.g., luminance or tristimulus value, of a display for a given color input may be characterized by the display's gamma correction curve. The display gamma correction function provides the display pixel's scaled output value for a given scaled color input value driving the display pixels. In simple cases, the gamma correction function is defined by a power-law expression of the form: O=Îγ, where is O is the scaled output (ranging from 0 (no light emitted from the display pixel, pixel's intrinsic black level) to 1 (full intensity of the display pixel)), I is the scaled input (ranging from 0 (input value equal to 0 for a given color when using 8-bits per color channel) to 1 (input value equal to 255 for a given color when using 8-bits per color channel)), and γ is selected to match the display's performance for a given color. In general, a color display may have different values of γ for red, green and blue; however, color displays are typically characterized by a single value of γ for red, green and blue. Cathode ray tubes and LCD displays typically have γ values ranging from 1.8 to 2.5. Although the examples below illustrate the image splitting algorithm using a gamma correction function in a power-law functional form, the image splitting algorithm may be implemented (following the described processes) using an arbitrarily defined gamma correction function. The display gamma correction function as described herein includes display-specific effects, such as color sub-pixel rise and fall times when rendering frames at the desired frame rates (typically>˜15 Hz), when determining the display pixel scaled output O.

The utilization of the gamma correction function in implementing specific obscuration techniques is illustrated below using the example in which γ is 1. In this case, for a given color, the pixel's output scales linearly from 0 to 1 as the normalized input varies from 0 to 1. For example, a pixel's output is approximately half brightness when the pixel is showing a color at 8-bit input value 127 compared to the pixel's output when the pixel is showing the color at 8-bit input value 255. Continuing with the example in which γ is 1 and assuming that the two frames are rendered (in order) cyclically on the display at >˜15 Hz, the eye's perception of a given pixel's luminance (based on persistence of vision) is roughly the same in the following 3 display configurations: (1) the pixel's 8-bit input value set to 255 for a color in the first frame and the pixel's 8-bit input value set to 0 for the color in the second frame, (2) the pixel's 8-bit input value set to 127 for the color in first frame and the pixel's 8-bit input value set to 127 for the color in the second frame, and (3) the pixel's 8-bit input value set to 0 for the color in the first frame and the pixel's 8-bit input value set to 255 for the color in the second frame.

In another example, consider the case where a pixel with an 8-bit input value equal to 100 for one color component is to be rendered on a display with γ equal to 1. The eye's perception of the color (based on persistence of vision) is roughly the same in the following display configurations: (1) the 8-bit color component input value set to 100 for 30 ms, (2) the 8-bit color component input value set to 255 for 10 ms, the 8-bit color component input value set to 45 for 10 ms, and the 8-bit color component input value set to 0 for 10 ms, and (3) the 8-bit color component input value set to 250 for 10 ms, the 8-bit color component input value set to 25 for 20 ms.

Based in part on the discussion above regarding the impact of the display gamma correction function, the eye's perception of rendered frames, and assuming that γ is equal to 1, another exemplary embodiment splits the (R,G,B) data for a given pixel in an image into two frames, frames 1 and 2. For a given pixel, the R, G and B values are doubled. The process for splitting the red color data is described below; the process for splitting the blue and green color data is similar. If 2*R is greater than 255, the red value for the pixel in frame A (high) is set to 255, where A is 1 or 2. The red value for the pixel in frame B (low) is set to R_H*(2*R−255), where B is 2 or 1 (respectively). If 2*R is 255 or less, the red value for the pixel in frame A (high) is set to R_L*(2*R). The red value for the pixel in frame B (low) is set to 0. Here R_H and R_L are scale factors that may be adjusted to tune the perceived image properties, e.g., brightness, color saturation, flickering, etc., when rendering frames 1 and 2. The device backlight may be adjusted to tune the perceived image properties. Repeating the process for blue and green leads to the pixel in frame A having: (1) a red value of 255 or R_L*(2*R), (2) a blue value of 255 or B_L*(2*B) and (3) a green value of 255 or G_L*(2*G). The pixel in frame B has: (1) a red value of R_H*(2*R−255) or 0, (2) a blue value of B_H*(2*B−255) or 0 and (3) a green value of G_H*(2*G−255) or 0. For a given image obscuration technique, the parameters R_H and R_L (and B_H and B_L for blue and G_H and G_L for green) may be adjusted to calibrate the perceived image. The values for X_H and X_L (where X is R, G or B) may be selected to optimize a particular color or portion of the image content, e.g., skin tones or faces, bodies, background, etc. The image content data may be split into a set of 3 frames (R, G and B multiplier of 3) with frames A and B saturating at 255 before frame C is filled. The image data content may also be split across more than three frames in some embodiments.

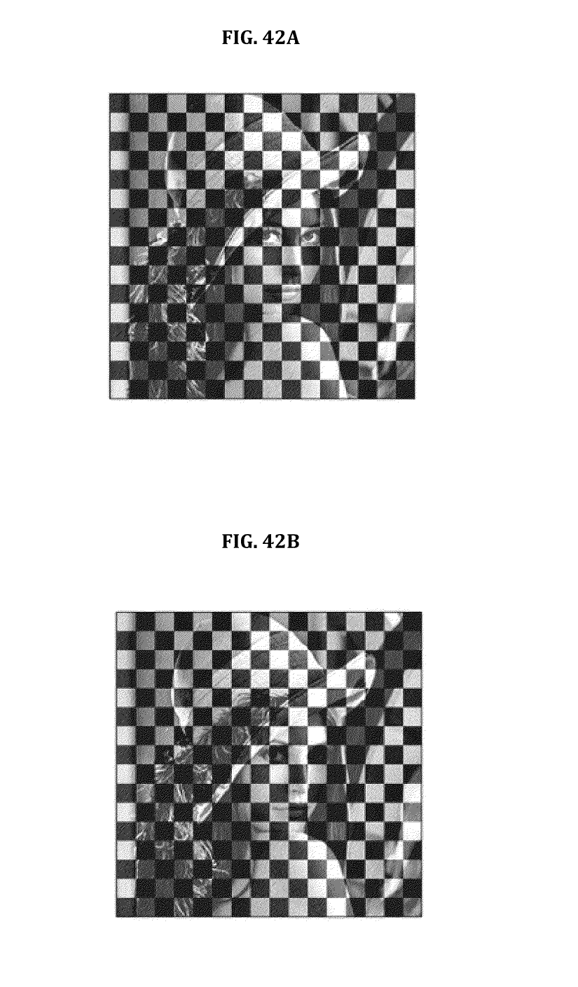

Frame regions may be broken up into a checkerboard grid (say 32 by 32 pixels) such that pixels in the “black” checkerboard squares use one assignment rule and the pixels in the “white” checkerboard squares use another assignment rule. The frame region assignment rule pattern identifies groups of pixels that can use the same image splitting rule, e.g., R to frame 1, G to frame 2, B to frame 3 for RGB splitting or high (A) to frame 1, low (B) to frame 2 for high/low splitting, etc. The frame region assignment rule pattern may include information about (1) the geographic distribution of the pixel regions and (2) what image content splitting rules are to be applied to pixels within the identified pixel regions. FIGS. 42A (frame 1) and 42B (frame 2) utilize a frame region assignment rule pattern that uses a checkerboard to define the geographic distribution of the pixel regions. The image content splitting rule in frame region assignment rule pattern used in FIGS. 42A and 42B sets pixels in the “white” checkerboard squares to A=1 and B=2 and the pixels in the “black” checkerboard squares to A=2 and B=1, where A and B are defined in the embodiment discussed immediately above. The frame set may be made up of the two frames shown in FIGS. 42A and 42B. Cycling the frames in the order 1/2/1/2/ . . . permits the original image content to be perceived by the user, for example.

The above examples split the (R, G, B) data across two frames assuming that the display gamma was equal to 1. The splitting algorithm is modified as illustrated below in cases where the display gamma is not equal to 1. Assume that the display gamma is equal to 2 and that a pixel with (R, G, B) data equal to (80, 140, 200) is to be rendered using two frames. First, the scaled output value for each color is calculated using the gamma correction function. For example, the scaled red output value is given by (80/255)̂2 (approximately 0.1). Next, the integrated scaled luminance perceived by the eye over two frames is calculated. Over two frames, the eye would receive an integrated scaled red luminance of 2*(80/255)̂2 (approximately 0.2), based upon a scaled red luminance of (80/255)̂2 from each frame. Finally, the integrated scaled luminance is distributed over two frames. Given that the integrated scaled red luminance is below 1, the integrated scaled red luminance may be delivered by outputting a 8-bit red value of 255*(2*(80/255)̂2)̂(½) (approximately 8-bit red level of 113) in one frame (high) followed by outputting a 8-bit red value of 0 in the second frame (low). Similarly, the scaled green output value is given by (140/255)̂2 (approximately 0.3). The integrated scaled green luminance perceived by the eye over two frames is 2*(140/255)̂2 (approximately 0.6). Given that the integrated scaled green luminance is below 1, the integrated scaled green luminance may be delivered by outputting a 8-bit green value of 255*(2*(140/255)̂2)̂(½) (approximately 8-bit green level of 197) in one frame (high) followed by outputting a 8-bit green value of 0 in the second frame (low). Similarly, the scaled blue output value is given by (200/255)̂2 (approximately 0.62). The integrated scaled blue luminance perceived by the eye over two frames is 2*(200/255)̂2 (approximately 1.23). Given that the integrated scaled blue luminance is over 1, it is not possible to deliver the integrated scaled blue luminance over a single frame. Instead, a 8-bit blue level of 255 is delivered in one frame (high; delivering an output of 1) followed by a 8-bit blue level of 255*(2*(200/255)̂2-1)̂(½) (approximately 8-bit blue level of 122) in the second frame (low). In summary, the (R, G, B) data of (80, 140, 200) for the pixel may be displayed by rendering red values of (0, 113), green values of (0, 197) and blue values of (122, 255) over two frames. The values displayed in each frame may vary based on the specific value selected from each pair for a given color. For example, frame one may be (0, 0, 122) with frame two equal to (113, 197, 255) for red, green and blue, respectively. Alternatively, frame one may be (0, 197, 255) with frame two equal to (113, 0, 122) for red, green and blue, respectively. In the immediately proceeding example, the output in the high frame was maximized up to a scaled output of 1. In other embodiments, the output in the high frame may be capped, for example at an output of 0.75. In the above example, given that the red and green integrated scaled luminance outputs in the high frame were both less than 0.75, approximately 0.2 and 0.6 respectively, the red and green outputs would remain (0, 113) and (0, 197) for low and high frames, respectively. The blue output in the high frame is reduced from 1 to 0.75, and the corresponding input value is reduced from 255 to 255*(0.75)̂(½) (approximately 8-bit blue level of 220). Because the scaled blue luminance output of the high frame is reduced from 1 to 0.75, the blue output in the low frame is increased from approximately 8-bit blue level of 122 to 255*(2*(200/255)̂2-0.75)̂(½) (approximately 8-bit blue level of 176). In some embodiments, the high frame output cap may vary from pixel to pixel. In some embodiments, the high frame output cap may vary by color. In some embodiments, the gamma corrected high and low outputs may be scaled using X_H and X_L multipliers as discussed in the γ equal to 1 example above.

In the embodiment discussed above, different pairs of color values may be rendered in the two frames to roughly produce the integrated scaled color luminance perceived by the eye over two frames. The scaled red output value for red value 80 is given by (80/255)̂2=0.09842. Over two frames, the eye would receive an integrated scaled red luminance of 2*(80/255)̂2=0.19685. As discussed above, the integrated scaled red luminance may be provided to the eye by rendering red value 113 in frame one and red value 0 in frame two. For this pair of red values, the integrated scaled red luminance is (0/255)̂2+(113/255)̂2=0.19637. The difference in integrated scaled red luminance between rendering two frames with red value 80 versus one frame with red value 113 and another frame with red value 0 is given by 2*(80/255)̂2−((0/255)̂2+(113/255)̂2)=0.00048. The difference in integrated scaled red luminance may be reduced by rendering one frame with red value 113 and another frame with red value 5. With this pair of color values, the difference in integrated scaled red luminance is given by 2*(80/255)̂2−((5/255)̂2+(113/255)̂2)=0.00009. For a given color, the non-zero difference in integrated scaled color luminance is the result of color values being limited to integer numbers from 0 to 255 (for 8-bit color levels). The scaled blue output value for blue value 200 is given by (200/255)̂2=0.61515. Over two frames, the eye would receive an integrated scaled blue luminance of 2*(200/255)̂2=1.23030. As discussed above, the integrated scaled blue luminance may be provided to the eye by rendering blue value 255 in frame one and blue value 122 in frame two. The difference in integrated scaled blue luminance between rendering two frames with blue value 200 versus one frame with blue value 255 and another frame with blue value 122 is given by 2*(200/255)̂2−((122/255)̂2+(255/255)̂2)=0.00140. The integrated scaled blue luminance may be provided to the eye by rendering two frames with the following pairs of blue values: (250, 132), (249, 134) and (248, 136). The difference in integrated scaled blue luminance between rendering two frames with blue value 200 versus rendering (frame one, frame two) blue value equal to (250, 132), (249, 134) and (248, 136) is 0.00117, 0.00066 and 0.00000, respectively.

In the above embodiments, the integrated scaled luminance over two frames for a given color is selected to be double the scaled output value of the original frame. In some embodiments, the integrated scaled luminance over two frames for a given color may be a multiple of the scaled output value of the original frame. In some embodiments, the multiple may be selected from the range of 1 to 3. Multiples may be integer or non-integer values. In some embodiments, the multiple may be different for different colors.

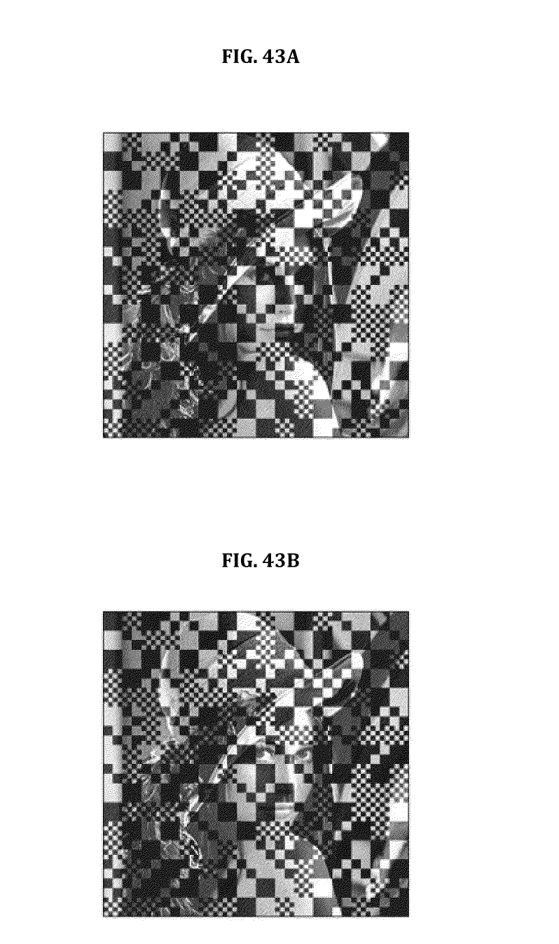

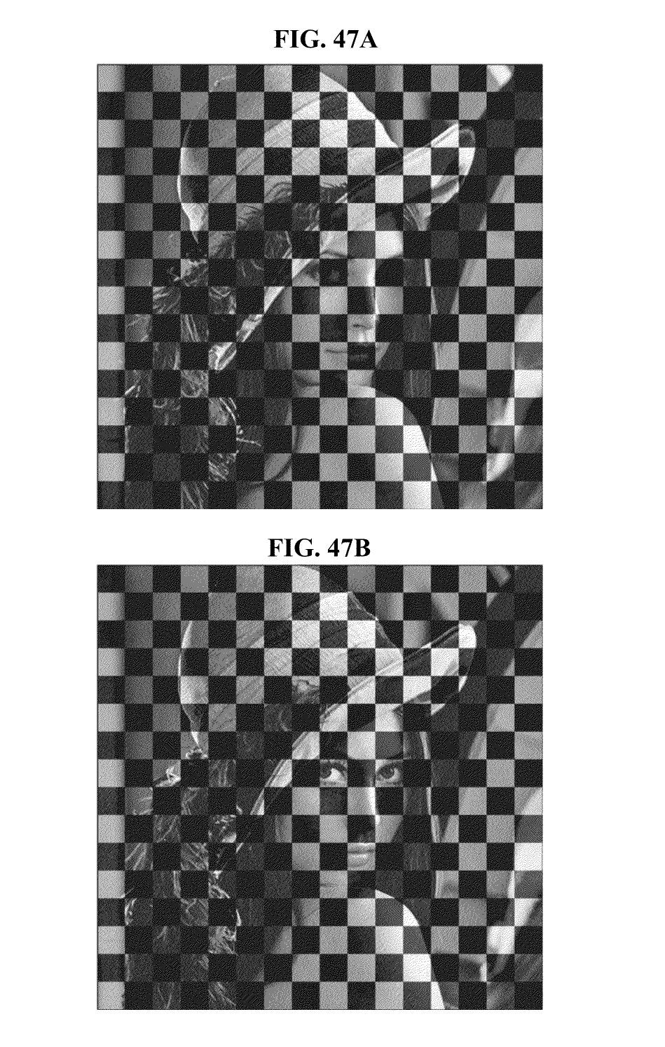

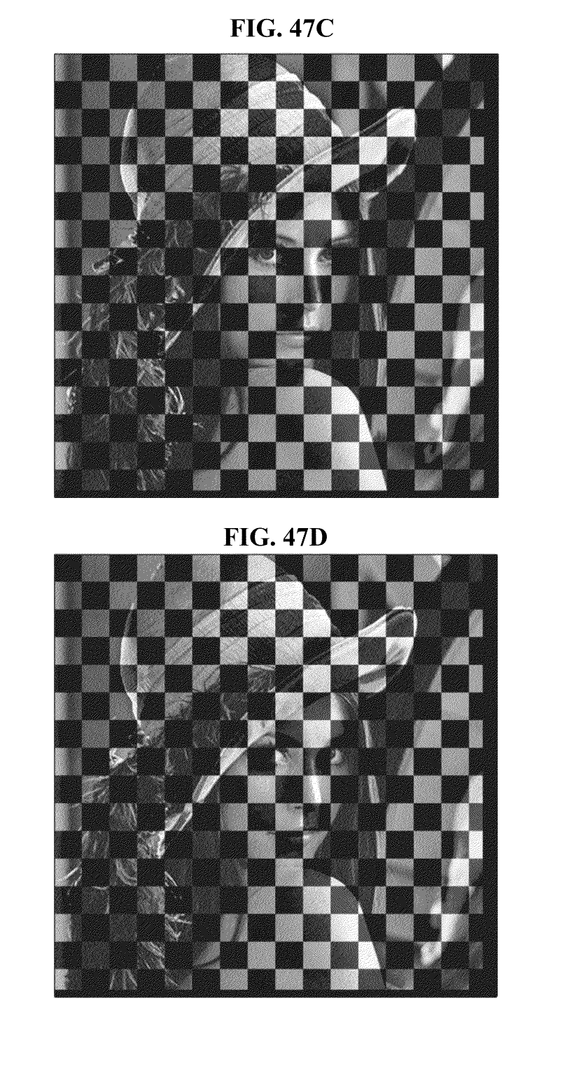

In the embodiments shown in FIGS. 39B-39D, 40A-40C, 42A and 42B, the frame region assignment rule pattern is fixed within each frame set. In some embodiments, the frame region assignment rule pattern may vary or otherwise be changed from one frame set to the next. The change to the frame region assignment rule pattern may include one or more of rotation, translation, magnification (greater or less than 1), or a completely different pattern. For example, the translation based frame region assignment rule pattern change may be implemented by translating the geographic distribution of the pixel regions in the original frame region assignment rule pattern by one or more pixels in a fixed or random direction. Similarly, the rotation or magnification based frame region assignment rule pattern change may be implemented by rotating or magnifying the geographic distribution of the pixel regions in the original frame region assignment rule pattern by a fixed or random amount. In other embodiments, the frame region assignment rule pattern may be changed within a given frame set. In such embodiments, the cycling of frames from the frame set may reproduce the original image data to varying degrees depending on degree of changes to the frame region assignment rule pattern within the frame set. As discussed above, in other embodiments, frames from different frame sets may be interspersed when rendered. In other embodiments, as shown in FIGS. 43A and 43B, the frame region assignment rule pattern may be a checkerboard pattern, for example, with 32 by 32 checkerboard squares, with some squares further broken down into smaller, for example, 16 by 16, 8 by 8, etc., checkerboard squares. The selection of which checkerboard squares are further refined may be predetermined or selected at random. The arrangement of the refined squares may vary from frame set to frame set. In other embodiments, the checkerboard square size may be tuned to match spatial data, such as the distance between facial features (eyes, etc.), in a region of the image. In some embodiments, the original image data of the source content may be changed within a frame set or from one frame set to the next while keeping the frame region assignment rule pattern fixed. In some embodiments, the image data change may be implemented by one or more of rotating, translating, or magnifying the original image data. Two exemplary frame sets illustrating the translation of the original image data are shown in FIGS. 47A, 47B, 47C and 47D. FIGS. 47A and 47B show one frame set created from the original image data. FIGS. 47C and 47D show another frame set created by translating the original image data while keeping the frame region assignment rule pattern fixed. The change to the original image data may constitute movement of one or more image data features by one or more pixels. In the exemplary images shown in FIGS. 47C and 47D, the change to the original image data is a translation of 16 pixels in X and 8 pixels in Y.

In some embodiments, the image data splitting may be implemented using a recursively refined block pattern—see exemplary code below. The block refinement process in these embodiments checks to see if the block splitting criterion (see below) is satisfied. If the block splitting criterion is not satisfied, each pixel in the block may be assigned an RGB value in frame A and each pixel in the block may be assigned a residual/completing RGB value in frame B. In some embodiments, all the pixels in the block in frame A may have the same calculated RGB value. In some embodiments, the pixels in the block in frame A may have different RGB values. In some embodiments, all the pixels in the block in frame B may have the given pixel's residual/completing color value. In other embodiments, the pixels in the block in frame A or B may have either the calculated RGB value or the given pixel's residual/completing color value. In some embodiments, each pixel in a given block may be assigned a value for each color, where the value is selected from the range of values for the color in the block. The block splitting criterion is not satisfied if each pixel in the same block may be assigned a residual/completing RGB value so that two frames (one frame's pixels having one set of RGB values and the other set having another set of RGB values, where one set of RGB values is assigned and the other set of RGB values is residual/completing) together provide the required total output luminance for each color for every pixel in the block. If the block splitting criterion is satisfied, the block size is reduced (by splitting the block into smaller blocks) and each of the smaller blocks is checked against the block splitting criterion to determine the block's pixel RGB assignment for the two frames. In some embodiments, the block may be split into equally sized blocks, e.g. into blocks of equal area, equal circumference, etc. In some embodiments, the block may be split into blocks of the same shape. If the block splitting process leads to a block containing only one pixel, the pixel may be assigned the same or different RGB values in frames A and B. In some embodiments, the single pixel block may be assigned the same RGB value (for example, equal to the pixel's RGB value in the image data) in frames A and B. In some embodiments, the single pixel block may be assigned the pixel's high/low values in frames A/B.

In some embodiments, the block splitting criterion checks to see if particular RGB values (“block value”) may be assigned to the block's pixels in one frame such that a residual/completing color value (“residual value”) is available for each pixel in the block in a second frame so that the two frames together provide the required total output luminance for each color for every pixel in the block (e.g., double the color output luminance for the pixel based on the image data). In the embodiment described below, each color is tested before deciding if the block splitting criterion is met. In other embodiments, the block splitting criterion may be tested for one or more color at a time such that each one or more color's block arrangement/size is determined separately. In the embodiment described below, the block splitting criterion is based in part on high/low output luminance for each color.

In some embodiments, the image data splitting using the recursively refined block pattern may use the high/low output luminance splitting as discussed above. This embodiment may be implemented by calculating a set of six source frames (low_r, high_r, low_g, high_g, low_b and high_b), two frames for each color R, G and B. For each color, one frame contains the high frame output luminance for the color—the three (high) source frames may be set equal to: (1) the output cap value (1, 0.75, etc. as described above if double the output luminance for the pixel color is greater than the cap value) or (2) double the output luminance (if double the output luminance for the pixel color is less than the cap value). For the same color, the other frame contains the low frame output luminance for the color—the three (low) source frames may be set equal to: (1) double the output luminance minus the output cap value (if double the output luminance for the pixel color is greater than the cap value) or (2) zero (if double the output luminance for the pixel color is less than the cap value). The block splitting criterion may be implemented by comparing the maximum of the block's data in the low source frame with the minimum of the block's data in the high source frame for each color. If each color's maximum of the block's data in the low source frame is less than the minimum of the block's data in the high source frame, a color pixel value with an output luminance that lies between the maximum (low) value and the minimum (high) value may be assigned to the pixels in the block in one frame. In some embodiments, an output luminance in the middle (average) of the maximum (low) value and minimum (high) value may be used. In some embodiments, an output luminance just above/below the maximum (low)/minimum (high) value may be used. In some embodiments, an output luminance may be selected, between maximum (low) value and minimum (high) value, based on the average luminance of the color in the block. The pixel's color value in the second frame may be calculated based on the output luminance of the pixel's color value in the first frame and required total output luminance of the pixel's color value based on the image data (e.g., double the color output luminance for the pixel based on the image data). If any color's maximum of the block's data in the low source frame is greater than the color's minimum of the block's data in the high source frame, the block splitting criterion is satisfied and the block is split into smaller blocks. The smaller blocks are checked against the block splitting criterion to determine the block pixel's RGB values in the two frames.

As an example of the above embodiment, assume that a given block only has pixels of two colors: Pixel1 with RGB equal to (80, 140, 200) and Pixel2 with RGB equal to (200, 200, 200). Assuming that γ is equal to 2 and scaled output luminance is capped at 1, the scaled output luminance of Pixel1 pixels is (0.1, 0.3, 0.62). The total scaled output luminance provided over two frames is (0.2, 0.6, 1.23). The low frame output luminance is (0, 0, 0.23), and the high frame output luminance is (0.2, 0.6, 1). The scaled output luminance of Pixel2 pixels is (0.62, 0.62, 0.62). The total scaled luminance provided over two frames is (1.23, 1.23, 1.23). The low frame output luminance is (0.23, 0.23, 0.23), and the high frame output luminance is (1, 1, 1). For the block, the maximum of the low source frame output luminance is (0.23, 0.23, 0.23). For the block, the minimum of the high source frame output luminance is (0.2, 0.6, 1). For this block, the red color low source frame maximum output luminance (0.23) is greater than the red color high source frame minimum output luminance (0.2). Hence, the block splitting criterion is satisfied, and the block is split into smaller blocks. Note that the green color low source frame maximum output luminance (0.23) is less than the high source frame minimum output luminance (0.6) for this block. Note that the blue color low source frame maximum output luminance (0.23) is less than the high source frame minimum output luminance (1) for this block.

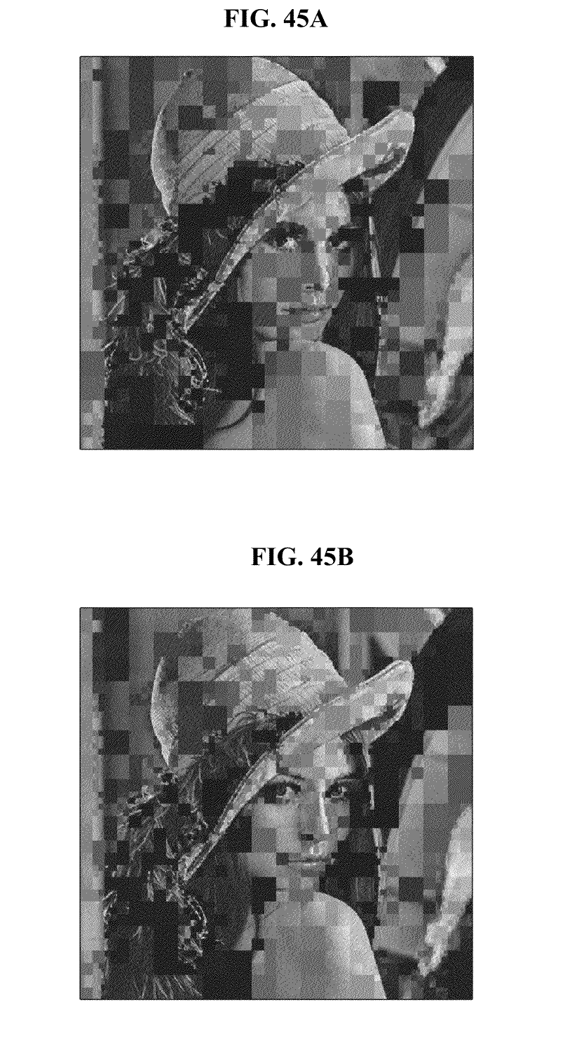

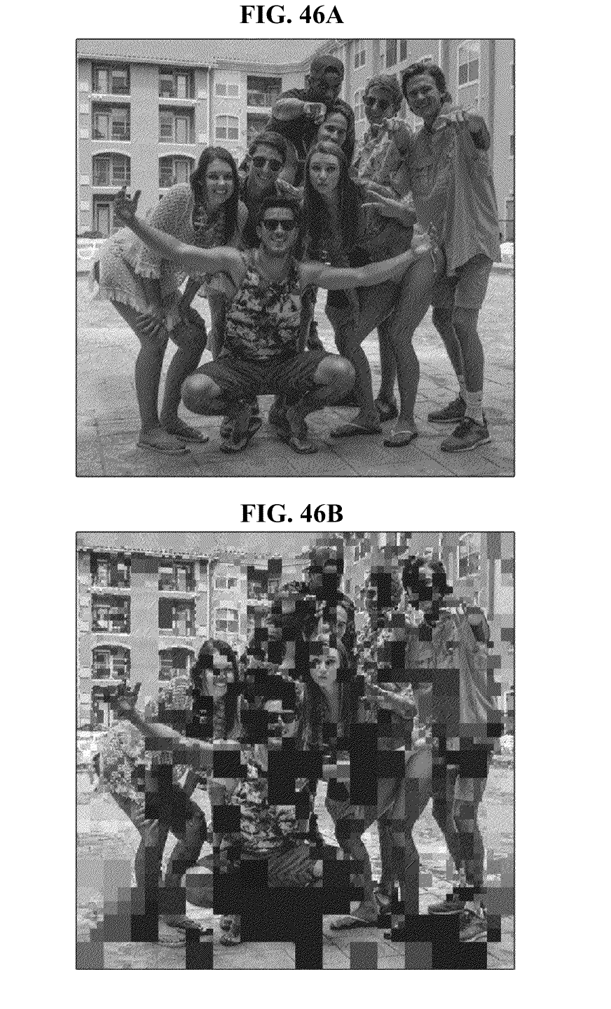

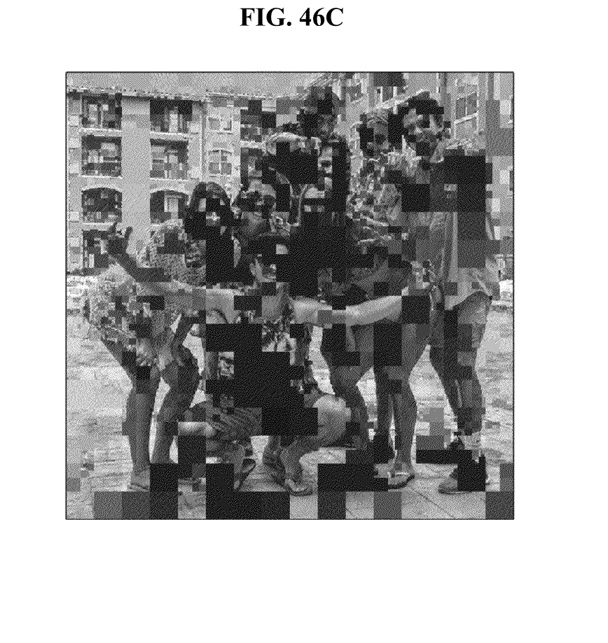

Continuing with the above example, assume that another block again only has pixels of two colors: Pixel1 with RGB equal to (80, 140, 200) and Pixel3 with RGB equal to (190, 200, 200). Assuming that γ is equal to 2 and scaled output luminance is capped at 1, the scaled output luminance of Pixel1 pixels is (0.1, 0.3, 0.62). The total scaled output luminance provided over two frames is (0.2, 0.6, 1.23). The low frame output luminance is (0, 0, 0.23), and the high frame output luminance is (0.2, 0.6, 1). The scaled output luminance of Pixel3 pixels is (0.56, 0.62, 0.62). The total scaled luminance provided over two frames is (1.11, 1.23, 1.23). The low frame output luminance is (0.11, 0.23, 0.23), and the high frame output luminance is (1, 1, 1). For the block, the maximum of the low source frame output luminance is (0.11, 0.23, 0.23). For the block, the minimum of the high source frame output luminance is (0.2, 0.6, 1). Note that the red color low source frame maximum output luminance (0.11) is less than the high source frame minimum output luminance (0.2) for this block. Note that the green color low source frame maximum output luminance (0.23) is less than the high source frame minimum output luminance (0.6) for this block. Note that the blue color low source frame maximum output luminance (0.23) is less than the high source frame minimum output luminance (1) for this block. Given that all three colors have low source frame maximum output luminance less than high source frame minimum output luminance, the block splitting criterion is not satisfied; the block is not split into smaller blocks. In one frame, the pixels in the block may be assigned RGB values such that the output luminance lies between 0.11 and 0.2 for red, 0.23 and 0.6 for green and 0.23 and 1 for blue. These output luminance ranges translate to 8-bit RGB values between 84 and 113 for red, 122 and 197 for green and 122 and 255 for blue. Assuming that the average of the output luminance values (0.15, 0.42, 0.62) are used, all the pixels in the block may be assigned the 8-bit RGB values of approximately (99, 164, 200) (“block value”) in one frame. Pixel1 pixels in the block may be assigned the 8-bit RGB values of approximately (53, 110, 200) (“residual value”) in the second frame; the 8-bit RGB values correspond to output luminance of (0.04, 0.19, 0.62). Pixel3 pixels in the block may be assigned the 8-bit RGB values of approximately (249, 230, 200) (“residual value”) in the second frame; the 8-bit RGB values correspond to output luminance of (0.96, 0.81, 0.62). See FIGS. 45 A-B for frames 1/2 (respectively, based on original image data shown in FIG. 39A) and 46 B-C for frames 1/2 (respectively, based on original image data shown in FIG. 46A).

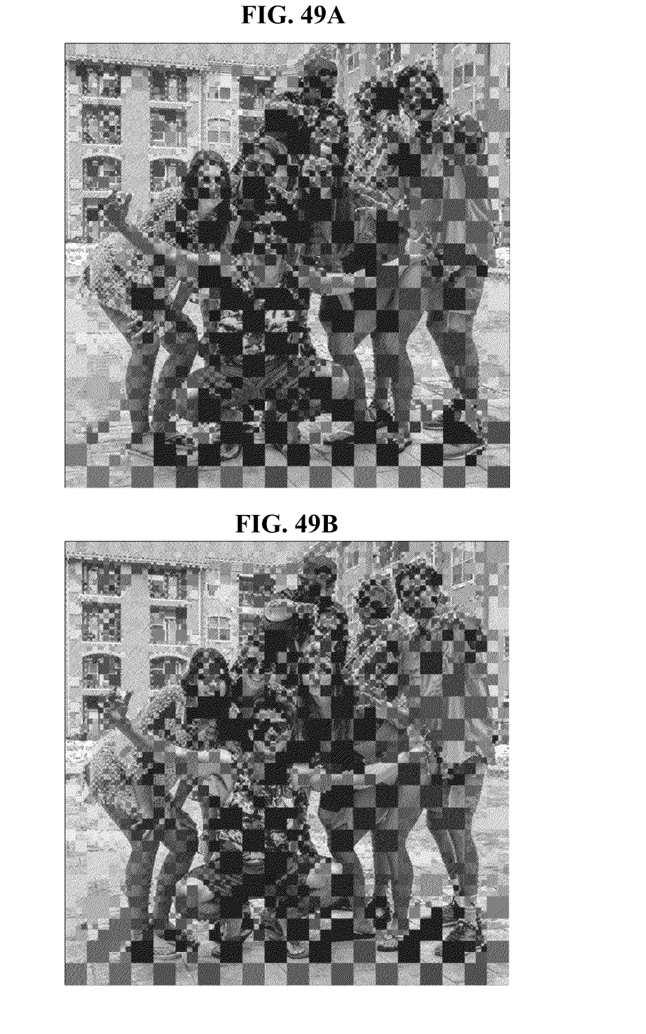

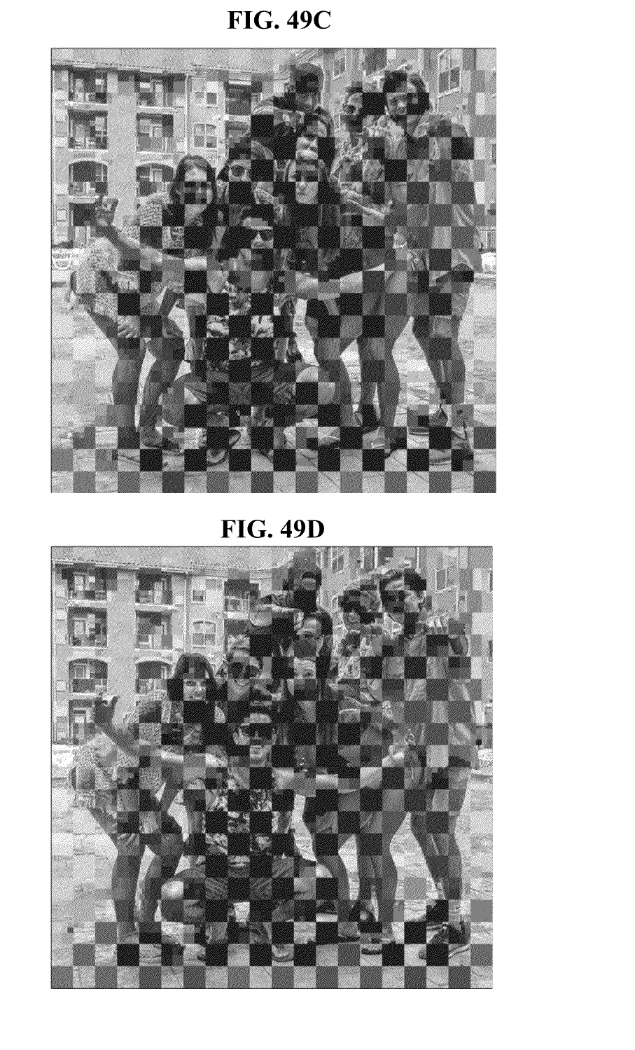

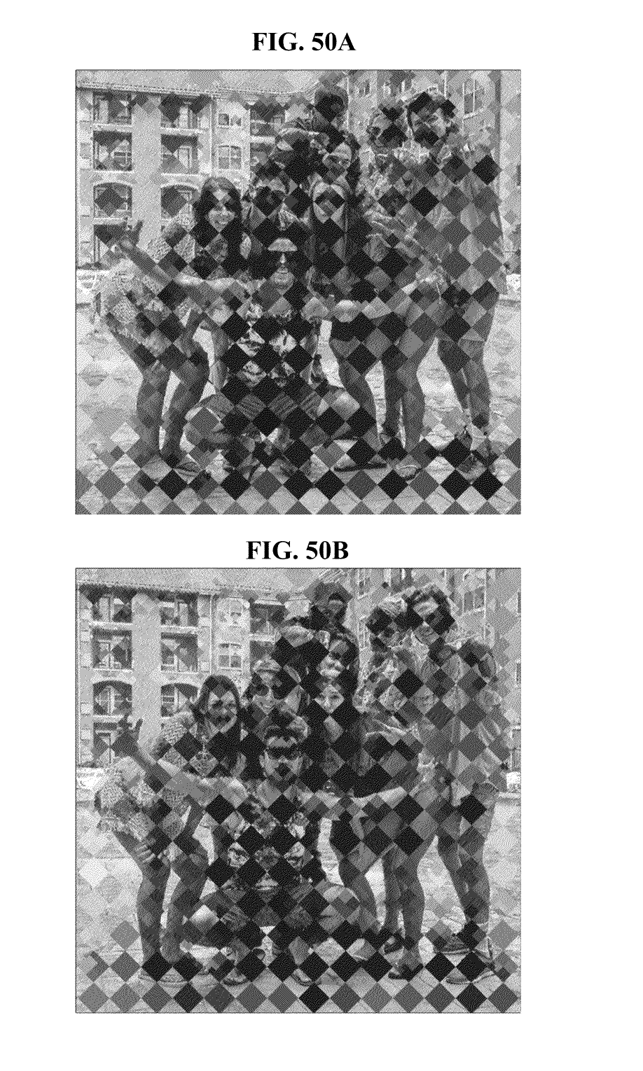

In some embodiments, the assignment of the “block value” to frame 1 or 2 (and, hence, the assignment of the “residual value” to frame 2 or 1) may be selected at random as shown in FIGS. 45 A-B and 46 B-C. In some embodiments, the assignment of the “block value” to frame 1 or 2 may follow a pattern, for example, as shown in FIGS. 49 A-B (based on original image data shown in FIG. 46A). In the embodiment shown in FIGS. 49 A-B, the assignment of the “block value” to frame 1 or 2 follows the checkerboard pattern even as the blocks are split to smaller sizes. For example, if a 32 pixel wide block having “block value” assigned to frame 1 is split, the resulting four 16 pixel wide blocks may have two blocks with “block value” assigned to frame 1 and two blocks with “block value” assigned to frame 2 (again, in a checkerboard pattern). In some embodiments, the assignment of the “block value” to frame 1 or 2 may follow a pattern as the blocks are split, for example, as shown in FIGS. 49 C-D (based on the original image data shown in FIG. 46A). In the embodiment shown in FIGS. 49 C-D, the assignment of the “block value” to frame 1 or 2 propagates to sub blocks if the larger block is split. For example, if a 32 pixel wide block having “block value” assigned to frame 1 is split, the resulting four 16 pixel wide blocks also have “block value” assigned to frame 1. In some embodiments, the edges of the recursively refined block pattern may be oriented at an angle relative to the edges of the image data content, for example, as shown in FIGS. 50 A-B.

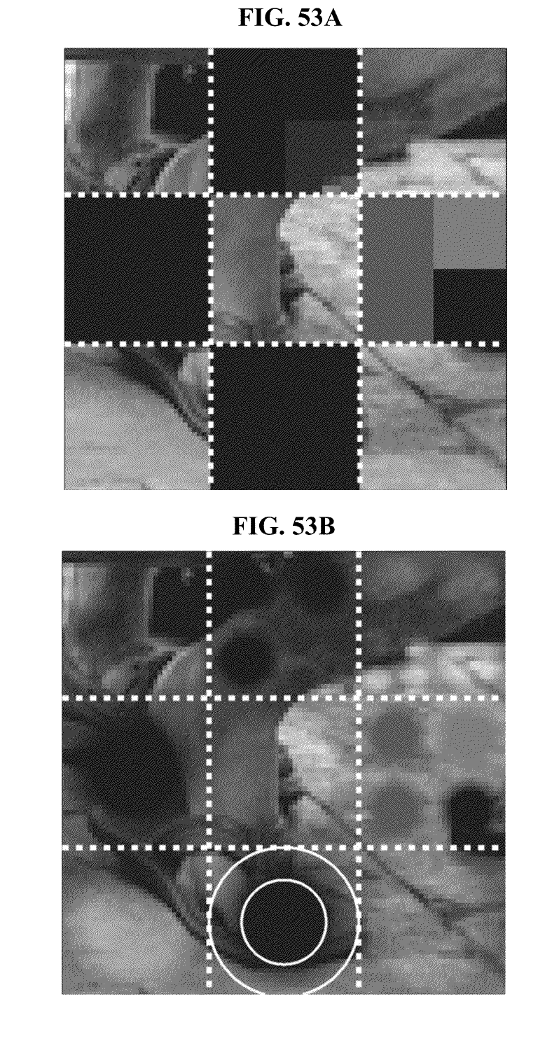

In some embodiments, one or more portions of the image data content may be split across frames where as other portions of the image data content may remain unaltered in the generated frames. The image data content portions selected to be split across frames may include, for example, faces, facial regions (e.g., eyes, lips, etc.), identifiable body markings (e.g., tattoos, birth marks, etc.), erogenous zones, body parts (e.g., hands creating a gesture, etc.), text, logos, drawings, etc. As discussed above, a block of pixels may be analyzed to determine how the pixel color data is split across frames. In some embodiments, each color of the pixel may also be analyzed separately during the block splitting process. In some embodiments, the pixel data on either side of an interface between adjacent blocks in a given frame may be matched, for example, as shown in FIG. 53B, which can be compared to FIG. 53A, which shows an exemplary frame without pixel data matching at the interface. The dashed white lines highlight the interface at the 32 by 32 pixel blocks in FIGS. 53 A-B. In some embodiments, the pixel data matching at the block interface may be implemented by using the image content data on either side of the interface as shown in FIG. 53B. In some embodiments, the transition from the matching data (used at the block interface) to the block data (used in the inner portion of the block) may be implemented over a transition region. In the embodiment shown in FIG. 53B, the transition from the matching data to the block data occurs over the annular region between the two circles shown in FIG. 53B.

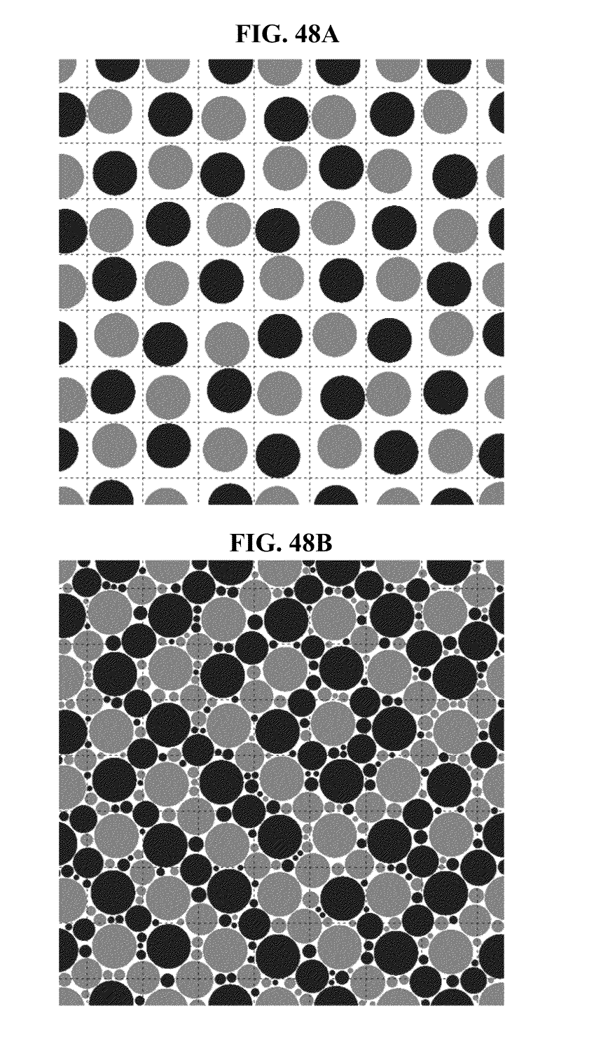

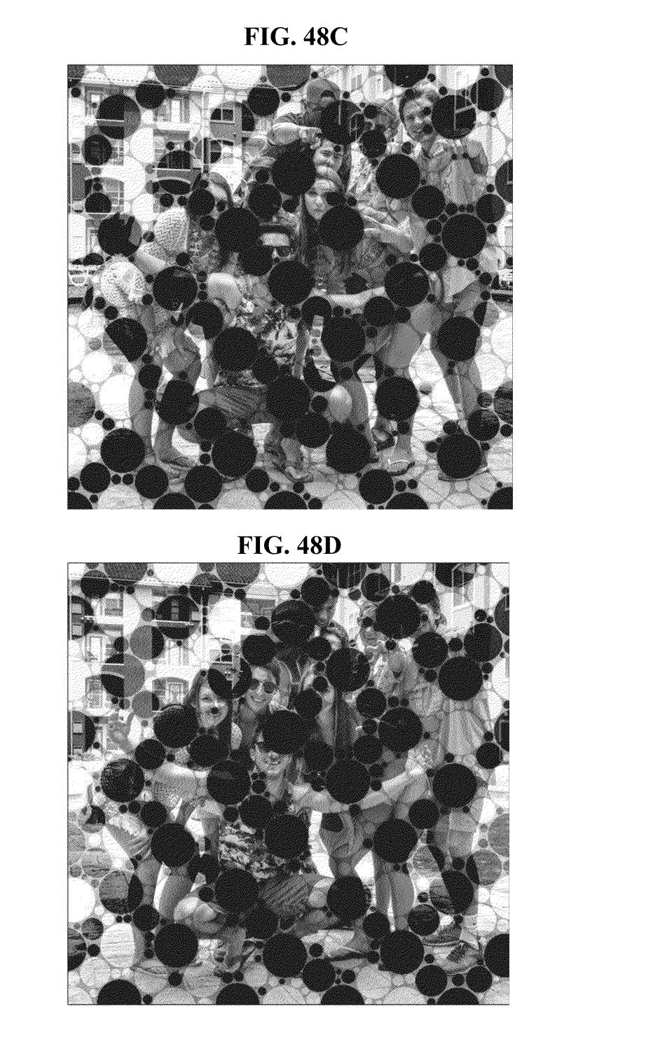

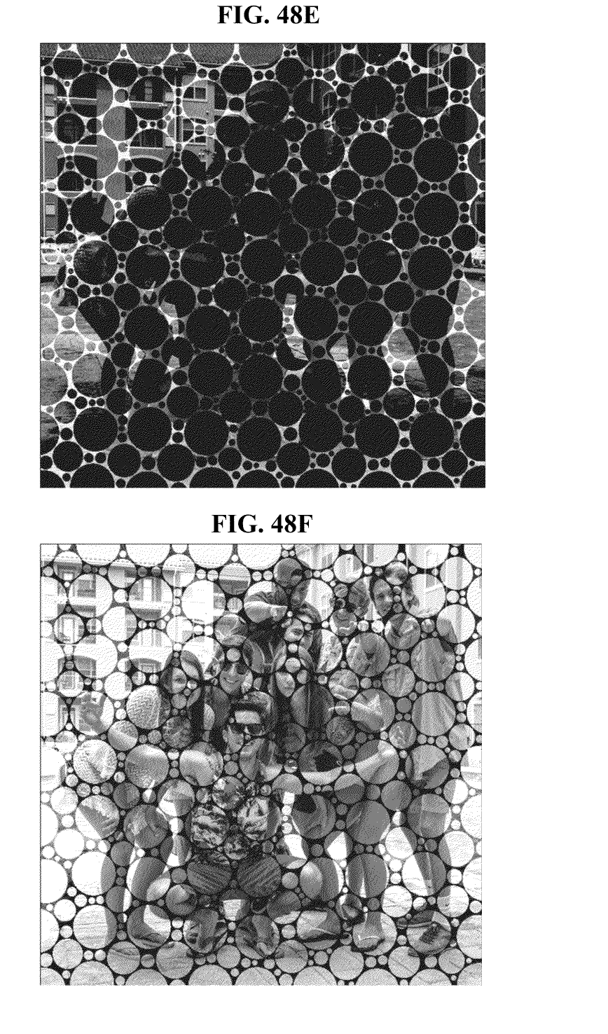

In some embodiments, the geographic distribution of the pixel regions in the frame region rule assignment pattern may take the shape of circles. In some embodiments, circles of a given radius may be randomly located within a grid space region of a periodic grid. In some embodiments, the grid space region takes the shape of a rectangle. In some embodiments, the grid space region takes the shape of a square. In some embodiments, the grid space region takes the shape of a triangle. In some embodiments, the grid space region takes the shape of a hexagon. The periodic grid may be made up adjacent, closely packed grid space regions. In some embodiments, the radius of the circle may be selected to encompass a given fraction of the grid space region. For example, if the grid space region is a square and a 50% circle to grid space region fill fraction is selected, the length of the side of the square is given by sqrt(2*pi)*R, where R is the radius of the circle. The 50% circle to square fill fraction is satisfied using these parameters because the area of the circle, pi*R̂2, is one half of the area of the square, 2*pi*R̂2. In some embodiments, the periodic grid may be larger than the size of the image data, e.g. to account for overfill related to the grid space region shape. The arrangement of circles for an exemplary geometric distribution of pixel regions is shown in FIG. 48A. In this particular arrangement, the image data is 640 pixels on a side, and circles (black and grey) having a radius of 32 pixels are placed randomly within square grid space regions (identified by dashed black lines) that are approximately 80 pixels on a side. The square size is selected to yield approximately 50% circle to grid space region fill fraction−sqrt(2*pi)*32 is approximately 80. The image splitting rule applied to pixels in the 3 types of regions, black circles, grey circles and white space (including the dashed black lines), is described below. In some embodiments, shapes other than circles may be used (e.g., ellipses, ovals, same shapes as the grid space regions, and the like).

In some embodiments, additional circles are added to the white space (including the dashed black lines). In some embodiments, the added circles do not overlap with the existing circles in the geometric distribution of pixel regions, see FIG. 48A. In some embodiments, the added circles are located and sized to maximize their radii without overlapping with the existing circles. In some embodiments, the location and radius of the largest circle that can be added to the white space region are identified iteratively, after each new circle is added. In some embodiments, the circle adding process continues until the radius of the next circle to be added to the white space region is below a threshold radius. In some embodiments, the circles being added are marked black or grey. In some embodiments, the assignment to the black or grey group may be random. FIG. 48B shows the geometric distribution of pixel regions after circles are added to FIG. 48A with a cutoff threshold radius of 3 pixels.

The frames to be cycled to render the image data content may be calculated using (1) the geometric distribution of pixel regions, shown in FIG. 48B, and (2) image content splitting rules (applied to pixels in the identified circles) based on the shade assigned to the pixels in FIG. 48B (white, black or grey). In one embodiment, the pixels: (1) outside the circles are assigned the value of the pixel in the original image data in both frames 1 and 2, (2) in the black circles are assigned the high/low value in frame 1/2, and (3) in the grey circles are assigned the high/low value in frame 2/1, see FIG. 48C for frame 1 and FIG. 48D for frame 2. Frames 1 and 2 form one frame set. In one embodiment, the pixels: (1) outside the circles are assigned the high/low value in frame 3/4 and (2) inside the circles are assigned the high/low value in frame 4/3, see FIG. 48E for frame 4 and FIG. 48F for frame 4. Frames 3 and 4 form another frame set.

Content identification information (content ID) or other data (such as advertisements, messages, etc.) may also be included in the frame region rule assignment pattern. In some embodiments, the geographic distribution of the pixel regions in the frame region rule assignment pattern may take the shape of text in the included data. In other embodiments, the content ID or other data may be used to define the image content splitting rules applied to pixels within the identified pixel regions in the frame region rule assignment pattern. In other embodiments, the geographic distribution of the pixel regions in the frame region assignment rule pattern may include a graphical code (e.g., 1-dimensional bar code, 2-dimensional QR codes, etc.). The code may be read back from one frame from the frame set to bring the frame content back into the protected environment, and thereby, permit use of the original content. In other embodiments, the code may be repeated in multiple locations within the frame so that a cropped portion of the frame that includes the code can still be read to identify the content ID or other data.

Instead of using a regular checkerboard pattern as the geographic distribution of the pixel regions in the frame region rule assignment pattern, other embodiments use irregular shapes. For example, the geographic distribution of the pixel regions in the frame region rule assignment pattern may use a set of patterns or shapes that can camouflage the underlying image. For example, shapes may be chosen that camouflage the underlying content in a manner similar to the techniques used to camouflage prototype cars. Of course, any suitable shapes may be used.

The disclosed embodiments may also be used to mitigate image capture of text messages, QR codes, and the like. In some embodiments, the processing unit may target the perceived data to be split into a brighter level and a darker level. For example, the text may be shown at the darker level (for example, R, G, and B equal to 100) on a background set to the bright level (for example, R, G, and B equal to 160). Here R, G, and B values for the two levels are matched to each other (grayscale); the may also be unmatched to create two levels that are different colors. The difference between the bright level/colors and the dark level/colors may be optimized for a given frame splitting algorithm.

Assuming that the display γ is equal to 1 and assuming that the bright level is R, G, and B equal to 160 (background) and the darker level is R, G, and B equal to 100 (text or QR code data, for example), the processing unit doubles a given pixel's RGB data (to 320 for background and 200 for text/QR code data). The processing unit splits the doubled pixel R, G, or B into 2 video frames: video frame A is allocated 200 with the remaining pixel data (120 for background and 0 for text or QR code data) allocated to video frame B. The processing unit may apply corrections to the values used in video frames A and B in the form of X_H and X_L. The checkerboard size, if implemented by the processing unit, may be optimized to match the text or QR code data. For example, the checkerboard size may be on the order of the text line width, text character width, or the QR code feature size. The processing unit may optimize the formatting of the text data (e.g., font size, character spacing, text alignment (right/center/left), text justification (right/left), word spacing, line spacing, (background) dead space, etc.) to mitigate image capture.

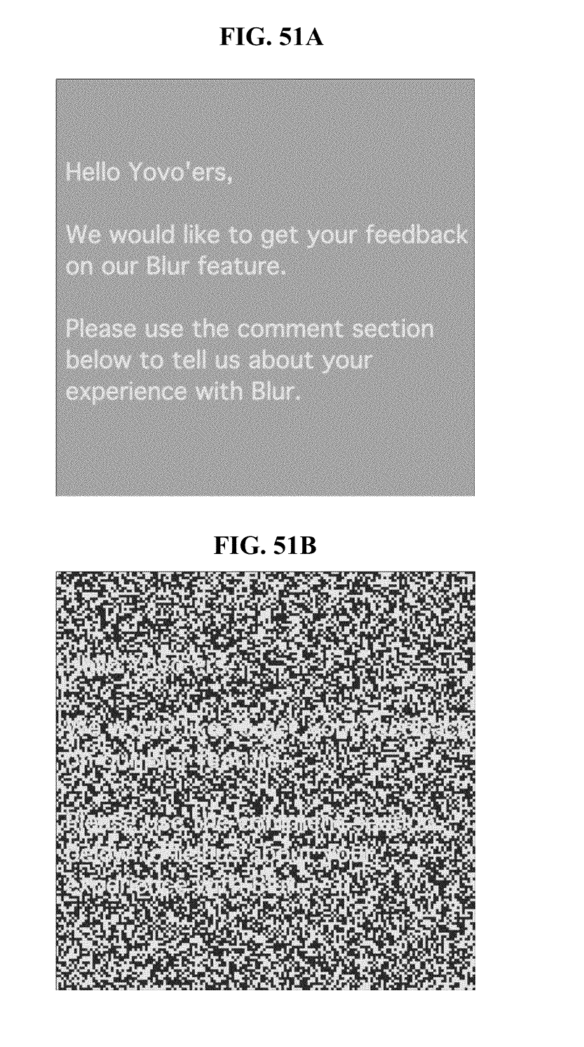

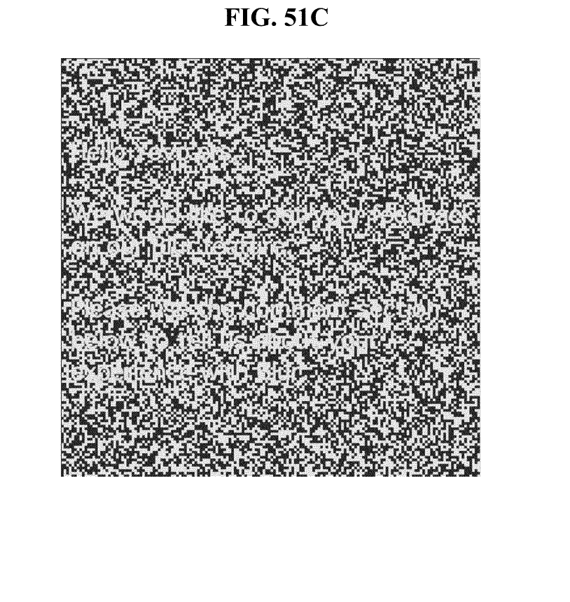

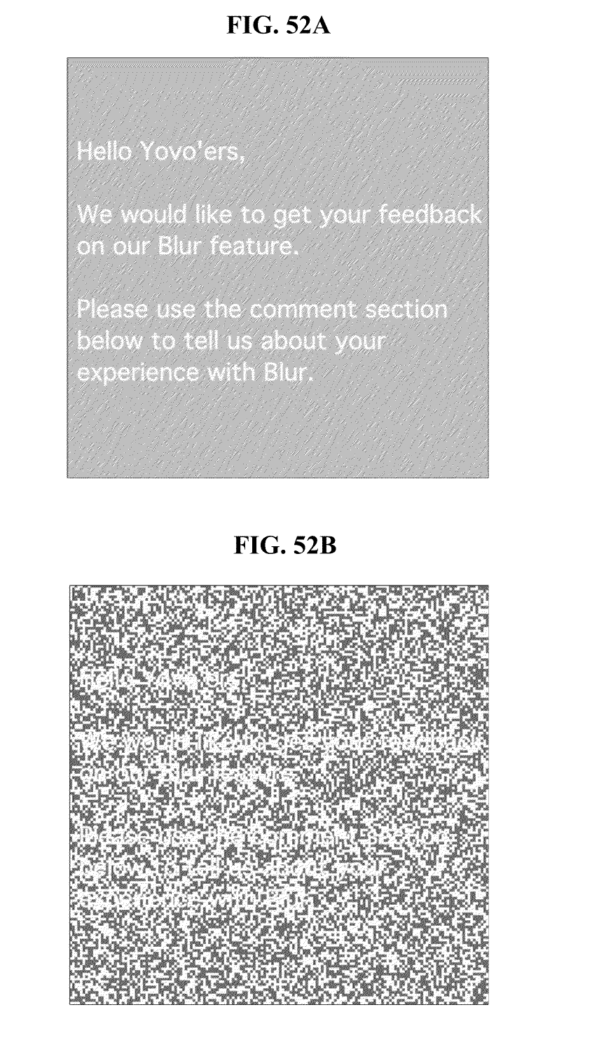

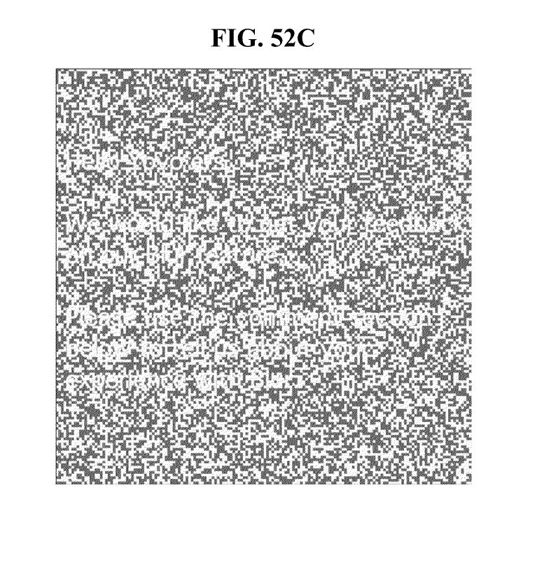

In some embodiments, the bright level for each color may be selected to have a luminance value that is between half and one times the color's luminance in the darker level. In such embodiments, the bright level for a given color is output at the same luminance level in both frames, and the darker level for the same color is output at the bright level's luminance in one frame and at the remaining required luminance output (double the darker level's luminance minus the bright level's luminance) in the other frame. In some embodiments, the background and text data may be split into blocks. In some embodiments, some or all the pixels in the blocks in the background may be set to the same value in each frame. In some embodiments, the size of the blocks may be based on the characteristics of the content, for example, the size of the text characters, the width of the text characters, etc. In some embodiments, the text may be shown at a bright level with the background shown at a darker level. For example, assuming that the display γ is equal to 1, the text may be shown at with bright level with R, G and B equal to 200 and the darker level with R, G and B equal to 100. In this example, the text data may have R, G and B values set to 200 in both frames. The background may have R, G and B values set to 200 in only one of the two frames and 0 in the other frame. FIGS. 51 A-C show the original image data (with text message on a background) and two frames for one exemplary embodiment, respectively. In another example, assuming that the display γ is equal to 1, the text may be shown at with bright level with R, G and B equal to 240 and the darker level with R, G and B equal to 140. In this example, the text data may have R, G and B values set to 240 in both frames. The background may have R, G and B values set to 240 in one frame and 40 in the other frame. FIGS. 52 A-C show the original image data (with text message on a background) and two frames for one exemplary embodiment, respectively.

In some embodiments, calibration of the image content splitting algorithm may be implemented by capturing a video recording of the device's display using a front facing camera while the device is placed in front of a mirror. With the device in this configuration, video data may be captured, for example, while: (1) the display shows the test image content (without image content splitting) and (2) the display shows the frames from one or more frame sets, created using the image content splitting algorithm to be calibrated, cycling at the target frame refresh rate. The video data captured by the front facing camera may be analyzed to determine image content splitting algorithm parameters, such as X_H and X_L. In other embodiments, the image content splitting algorithm parameters, such as the values for X_H and X_L, may be provided in a look-up table on the device. In other embodiments, the image content splitting algorithm calibration may be implemented by analyzing long exposure snapshots of the display, showing (1) the test image content and (2) the rendered frame sets, using the front facing camera with the device in front of a mirror rather than by capturing a video as described above.

Using the techniques described herein, contrast loss that is typically perceived when image data is combined with other (non-image) data to generate frames to be rendered for image obscuration can be reduced or eliminated.

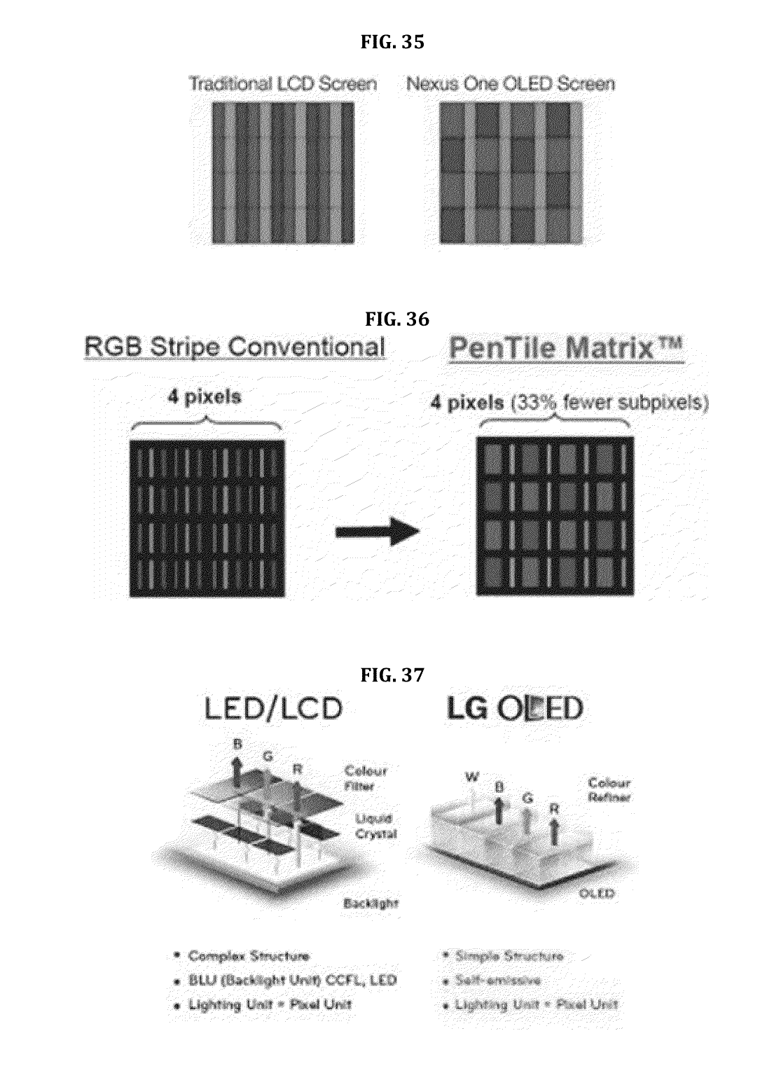

The disclosed image content splitting algorithms may be used to obscure content shown on displays using different pixel configurations. Pixel configurations may include RG, BG, RGB, RGBW, RGBY, and the like. The display may be an LCD, OLED, plasma display, thin CRTs, field emission display, electrophoretic ink based display, MEMs based display, and the like. The display may be an emissive display or a reflective display. FIGS. 35, 36, and 37 illustrate a subset of the contemplated pixel and display configurations. Not all displays are equal, and obscuration techniques like image splitting can be tailored to be optimized (e.g., best content fidelity during obscured rendering and least identifiability of degraded content that is a result of screen capture or other unauthorized use of obscurely rendered content). An obscuration technique can be optimized based on the type of display being used or the device rendering the content to the display, to display the obscured rendering (e.g., if rendering on an iPhone 4, render the obscuration at 30 Hz instead of 60 Hz).

The selection of image content splitting algorithm and tuning of image content splitting algorithm parameters, such as X_H and X_L, may be based in part on specific types of displays, including LCD, OLED, plasma, etc. As discussed above, the display gamma correction function may be a function of the display type and, hence, may change the values used in the image content splitting algorithm. The selection of image content splitting algorithm and tuning of image content splitting algorithm parameters, such as X_H and X_L, may be based in part on specific types of pixel configurations, including RGB per pixel, RG or GB per pixel, or WRGB per pixel, etc. For example, the embodiment splitting the RGB data into three frames described above may be modified to split the RGB data into 4 frames if the display pixel has WRGB per pixel instead of the typical RGB per pixel. In this embodiment, the pixel data in three of the four frames may be only R, only G or only B as described above; the pixel data in the fourth frame may be equal parts of R, G and B (to be rendered by the W sub-pixel).

FIG. 39B-39D illustrates image content split into 3 frames. When the frames are rendered at 60 Hz, the rendered image content may be captured on video at a rate of ˜24 Hz. The three frames together are cycling at 20 Hz if each frame (1, 2 and 3) is being shown at 60 Hz. Based on these values, each captured video frame contains data from 2.5 frames of the image content split data (e.g., ⅚ths of a three-frame set).

If the image were split into 2 frames per set using an obscuration technique described herein, a video capture has nearly all the content in each video frame (each video frame averages 2.5 split frames and thereby nearly reconstructs the original content). With this in mind, the split-in-2 frames per set obscuration technique may be implemented (to mitigate video capture) by splitting the two frames with a frame from a different frame set in between. For example, if the split-in-2 frame obscuration technique is implement with the images shown in FIGS. 42A and 42B being frames 1 and 2 (Set A) and the images shown in FIGS. 43A and 43B being frames 3 and 4 (Set B), one implementation cycles the frames in the order 1, 3, 2, 4. A video capturing this implementation contains captured video frames that average frames 1/3, 3/2, 2/4, etc. (and a bit more actually, 2.5 frames). Each resulting captured video frame has data averaging a frame from Set A and a frame from Set B and, hence, would not nearly reconstruct the original content. In some embodiments, the number of sets intermixed may be selected based on the MPEG compression used during video capture (including the spacing between I-frames).

Video screen capture also can be impeded further by ensuring that checkerboard square boundaries (crossing lines forming a “+”) of the checkerboard pattern described herein fall in as many MPEG macroblocks as possible. For fixed bit-rate video capture, this method can increase compression artifacts or noise; for variable bit-rate video capture, this method can increase file size to maintain video quality. Specifically, raw video frames (e.g., in .mp4 files) are typically decomposed into macroblocks of 8×8 (also 16×16 and 32×32 if uniform enough, and now 64×64 superblocks in H.265), and then a 2D DCT is applied to each block. If the checkerboard squares have sides of power-of-two length starting at the upper left corner of the image, the checkerboard boundaries can coincide with DCT block boundaries. This registration improves compression. By offsetting such checkerboard by 4 pixels each, for example, from the upper left corner of the image, resulting in the first row and column containing 4×4 squares, MPEG blocks can contain a “+” boundary, leading to larger high-frequency components that cannot be quantized as efficiently.

In another aspect of the disclosed embodiment, a related video to video screen capture method includes dithering or strobing the first checkerboard corner location between upper left (0,0) and (7,7), for example, which would also lower picture quality or increase file size with MPEG video encoders that, for efficiency, do not look far enough back for matching macroblocks, again forcing lower compression quality or size.

With an external device camera, checkerboard registration would be dependent on the position of the camera, and dithering would likely occur by the slight movements of a hand trying to hold the camera steady. Thus, the above techniques would be effective, for example, in the case of internal video screen capture by the display device itself.

Another aspect of the disclosed embodiments includes varying the frame rate in the displayed image (e.g., randomly between 50 Hz and 60 Hz), which would maintain image perception while introducing banding or flickering into any fixed frame rate video capture. The resulting video would be less faithful to the original image.

In addition, instead of splitting the image content data in the RGB space as described herein, image content data may also be split in the HSV, HSL, CIE XYZ, CIE Luv, YCbCr, etc. color spaces. Another aspect of the embodiments utilizes the HSV color model, which is a cylindrical-coordinate representation of points in an RGB color model. Using the HSV model reduces flicker while retaining brightness in the obscured rendering of the content.

Using the HSV model, suitable notations can include, for example:

R(1,2)=drop Red from all pixel of element in row1, col2

G(1)=Row 1 that starts with G(1,1) and proceeds B(1,2) . . . R(1,3) . . . G(1,4) . . . .

I(B)=Full image with B(1) as first row, G(2) as second row, R(3) as third row . . . .

Thus, an obscuration technique algorithm may include the steps of:

1) Divide the source content into a grid of 8×8 pixels

2) Create 3 images I(R), I(G), I(B)

3) Cycle 3 images at 60 Hz

By utilizing an algorithm such as the above while applying an obscuration technique, each pixel will preserve its brightness (e.g., reduced flicker) during obscured rendering, and the high contrast between R(20,25) and G(20,25) will create strong edges in degraded content, which will interfere with identification of the obscured content.

Obscuration Technique—Hexagonal Frame Sequence

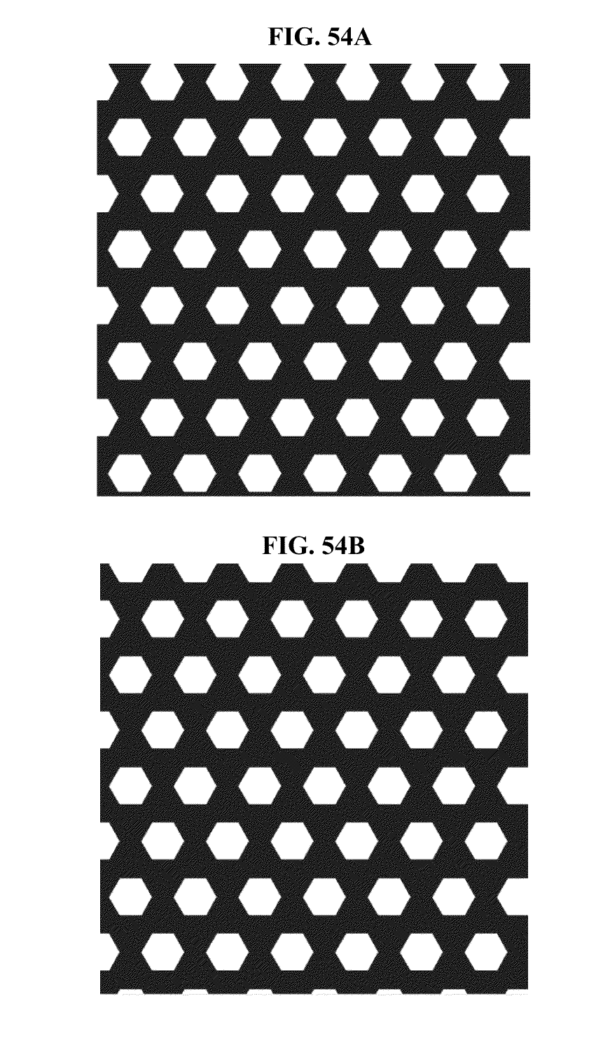

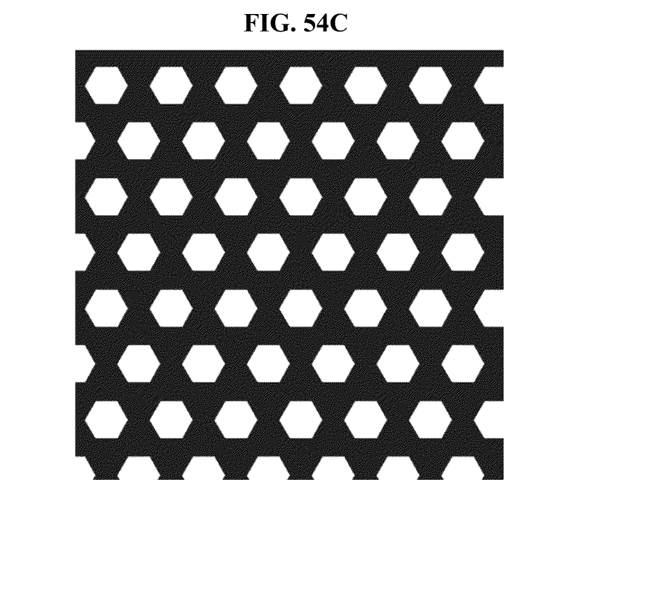

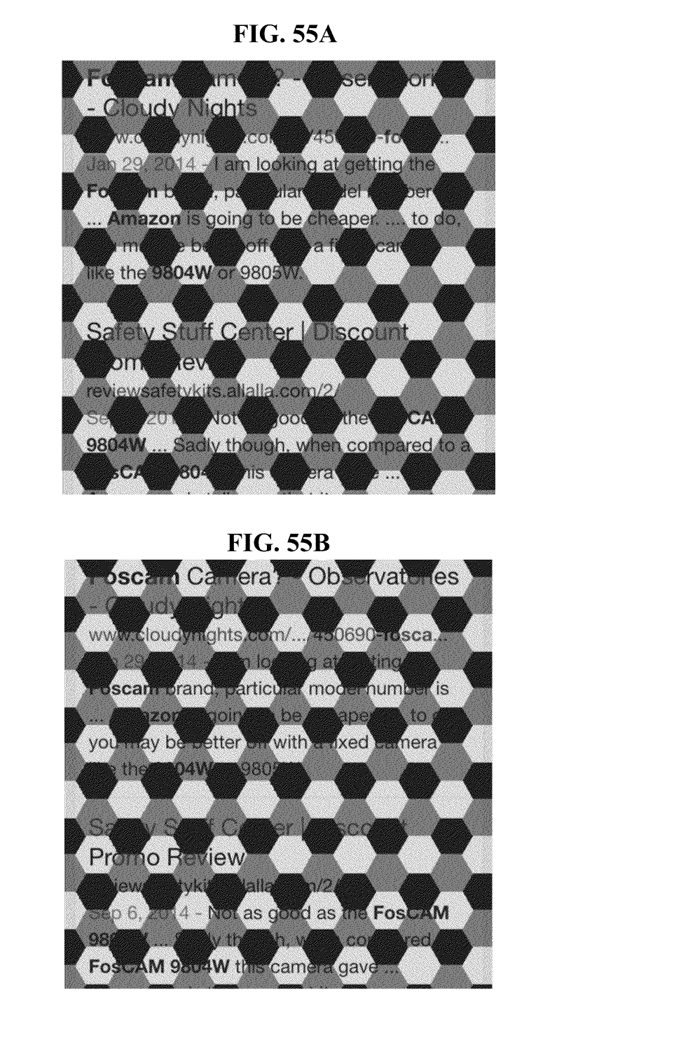

Another obscuration technique according to the some embodiments utilizes a combination of masking and transforming obscuration techniques. This technique is illustrated in FIGS. 54A-C, 55A-C, and 56 A-D. In some embodiments, a mask of a hex grid can be created over a source image wherein only ⅓ of the hexes are masked using a given masking technique, and wherein no two hexes masked with the same technique are adjacent. See, for example, FIGS. 54A-C.

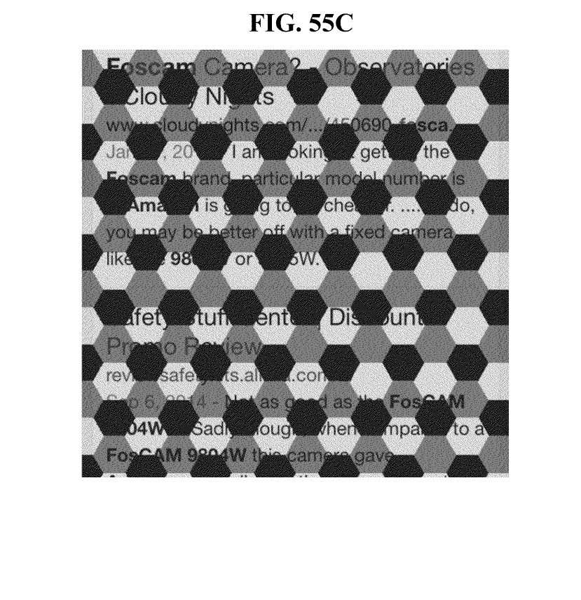

Next, in some embodiments, three color transformations of the source image can created (e.g. ImageNoGreen, ImageNoBlue, ImageNoColor, etc.). A first frame can be created by using hex grid mask to mask ⅓ of the hexes with the first color transformation (e.g. ImageNoGreen), ⅓ of the hexes with the second color transformation (e.g. ImageNoBlue), and the final ⅓ of the hexes with the third transformation (e.g. ImageNoColor). A second and third frame can be created using the same method, but adjusting which hexes receives which transformation. See FIGS. 55A-C. As shown in the figures, each hex displays a different version of the transformed source image. When the above described color transformations are averaged over the set of three frames, the Green is reduced by ⅔rds, the Blue is reduced ⅔rds, and the Red is reduced ⅓.

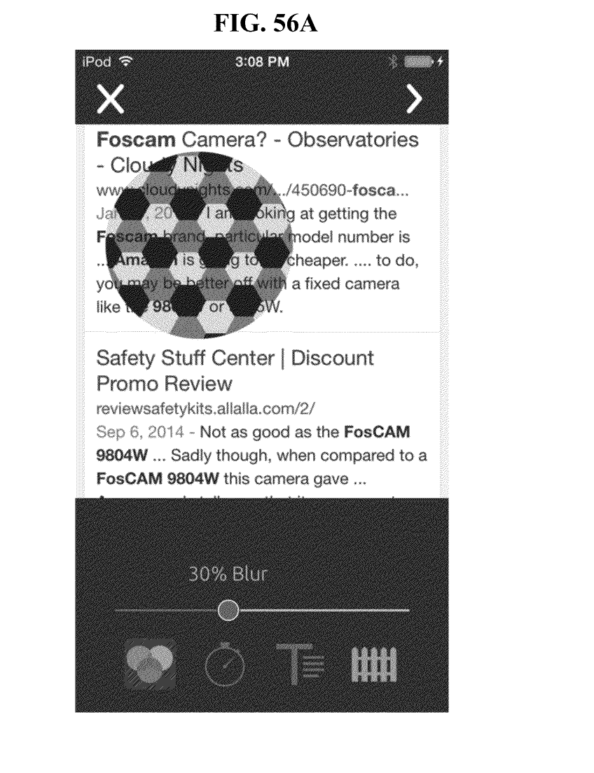

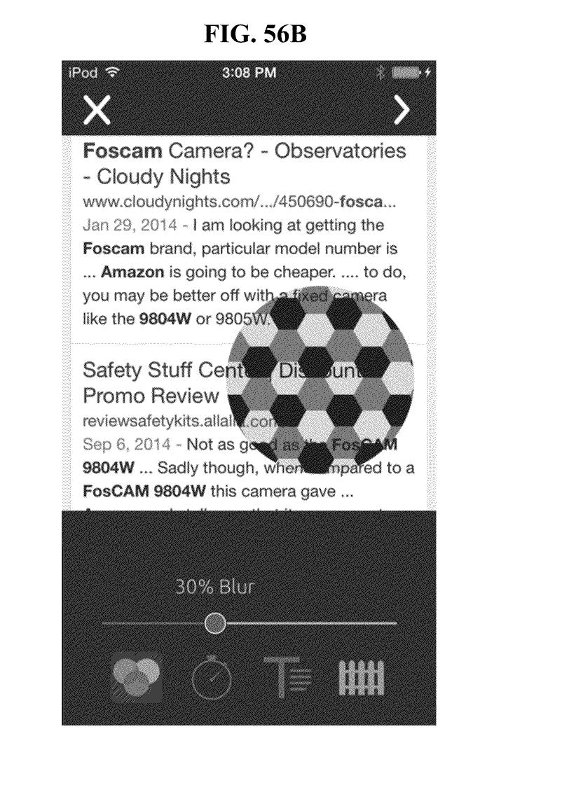

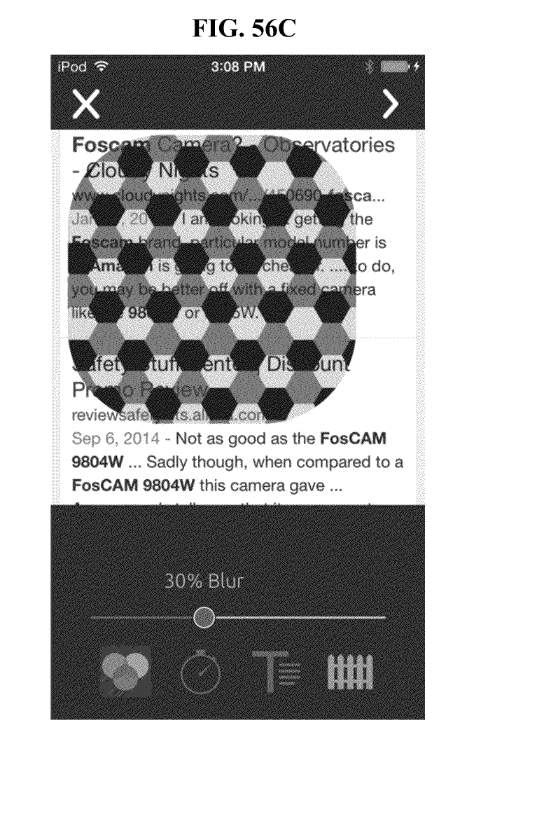

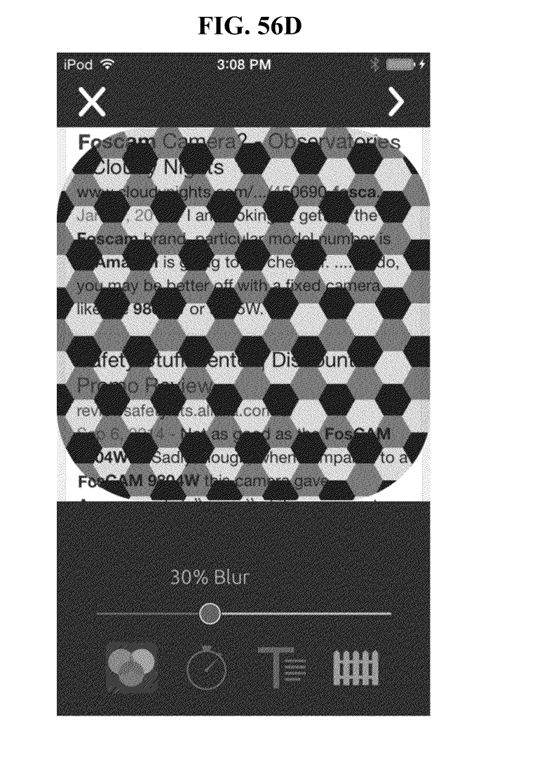

Any number of color transformations and/or frames may be used, and the grid may be designed with shapes other than hexes. This technique can also allow code readers, such as a QR code reader, to read the obscured content during an obscured rendering, but not if the obscured rendering is captured via screen capture. FIGS. 56A-D illustrate how this technique can be used in combination with mask layers of various shapes and sizes within a display.

Obscuration Technique—Color Blur

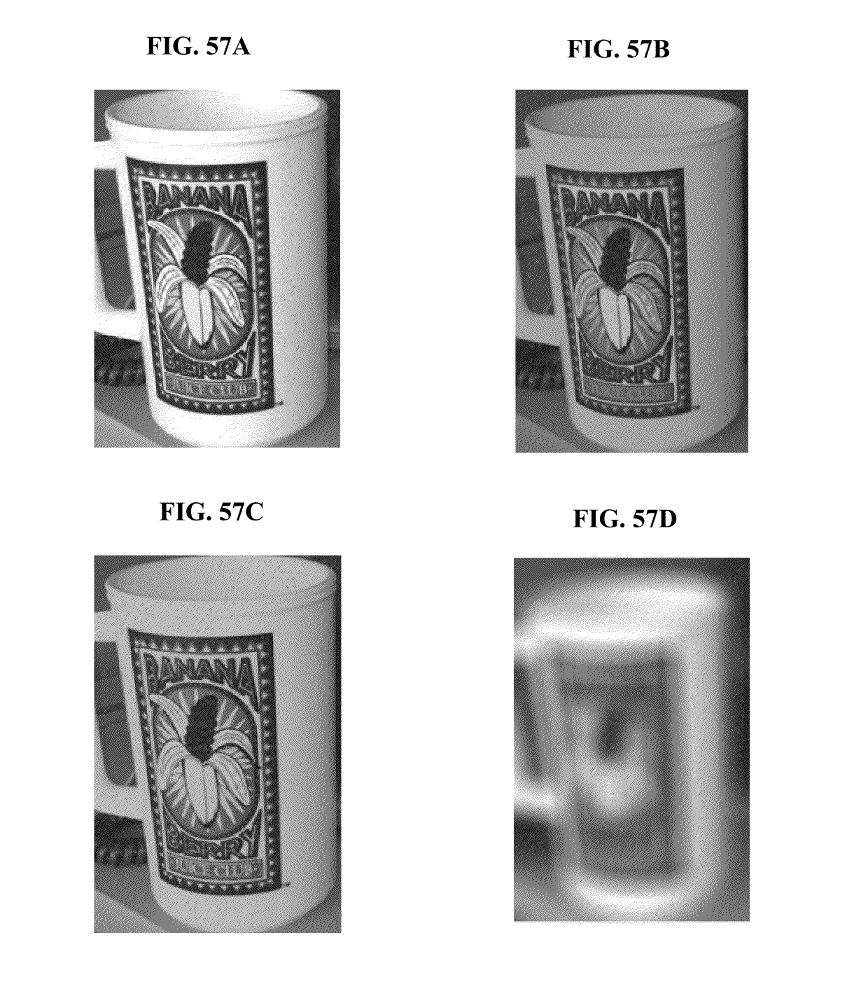

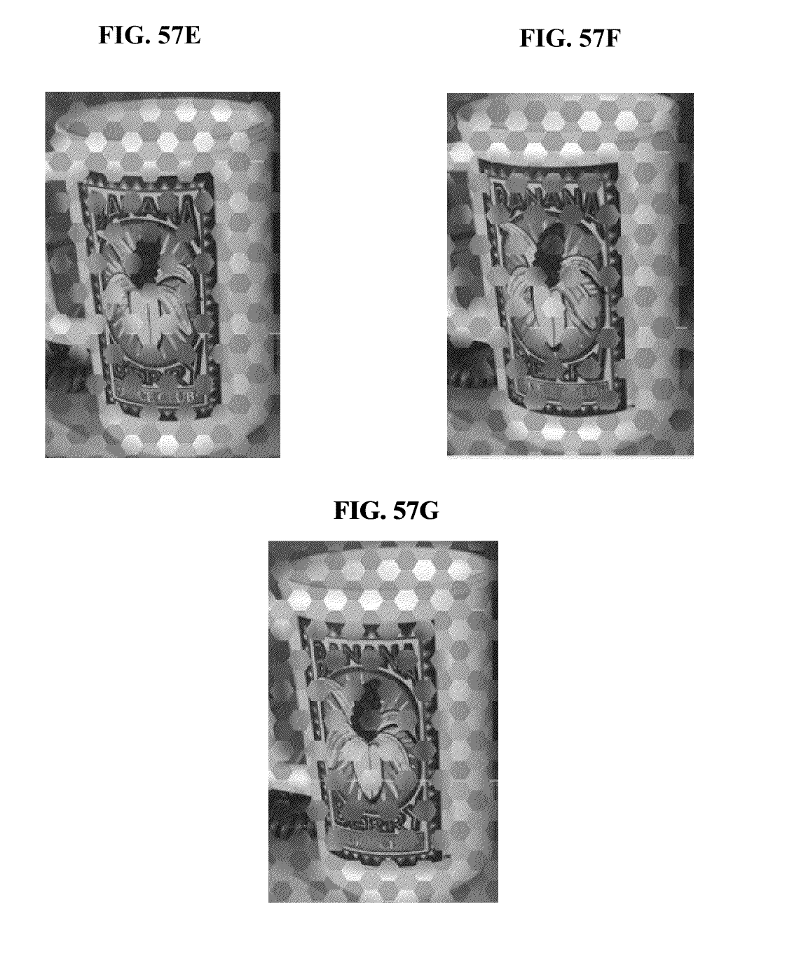

Another obscuration technique according to the disclosed embodiments also utilizes a combination of masking and transforming obscuration techniques. This technique is illustrated in FIGS. 57A-G. In this technique, a grid template may be created, for example, a hexagonal grid as described above. This grid may be a three phase hexagonal grid with each hex in the grid being masked in a group of three. The source content can then be transformed in three different ways corresponding to the masking of each hex. For example, FIGS. 57A-D illustrate the source content, a first transformation with the green coloration modified, a second transformation with the red coloration modified, and a blur transformation, respectively.

The transformed versions of the content may be used in the masking layer as described above. Specifically, the three transformation images may be used in conjunction with the grid templates and displayed in sequence as follows, for example:

Sequence Image 1=mask1+trans1, mask 2+trans2, mask3+trans3 (FIG. 57E)
Sequence Image 2=mask1+trans2, mask 2+trans3, mask3+trans1 (FIG. 57F)
Sequence image 3=mask1+trans3, mask 2+trans1, mask3+trans2) (FIG. 57G)

In this example, FIG. 57B shows a transformation in which each pixel is transformed according to the following algorithm: (redout=redin+green*multiplierp+blue*multiplierp) (greenout=greenin−redin*multiplierm−bluein*multiplierm) (blueout=bluein+red*multiplierp). FIG. 57C shows a transformation in which each pixel is transformed according to the following algorithm: (redout=redin−green*multiplierm−blue*multiplierm)(greenout=greenin−red*multiplierm−blue*multiplierm)(blueout=bluein−red*multiplerm). FIG. 57D shows a transformation in which the content is transformed using a Gaussian blur. Thus, as shown in the figures, the first two transformations alter the RGB value out for each pixel based on the RGB value in. Each pixel can receive bonus R, G, B in one cycle and negative R, G, B in a different cycle, and the luminance of each pixel over a three image cycle can be controlled to minimize flicker, while also creating perceived boundaries (edges) between each hex boundary.

An exemplary transformation matrix for this technique in some embodiments is shown below:

$$float plusColor = .10 ;$$

$$float minusColor = - .25 ;$$

$$GPUMatrix 4 \times 4 matrix 1 = \{ \\ \{ 1 , plusColor , plusColor , 0 \} , \\ \{ minusColor , 1 , minusColor , 0 \} , \\ \{ plusColor , 0 , 1 , 0 \} , \\ \{ 0 , 0 , 0 , 1 \} , \\ \} ;$$

$$GPUMatrix 4 \times 4 matrix 2 = \{ \\ \{ 1 , minusColor , minusColor , 0 \} , \\ \{ plusColor , 1 , plusColor , 0 \} , \\ \{ minusColor , 0 , 1 , 0 \} , \\ \{ 0 , 0 , 0 , 1 \} , \\ \} ;$$

$$GPUMatrix 4 \times 4 matrix 3 = \{ \\ \{ 0 , 0 , 0 , 0 \} , \\ \{ 0 , 0 , 0 , 0 \} , \\ \{ 0 , 0 , 0 , 0 \} , \\ \{ 0 , 0 , 0 , 1 \} , \\ \} ;$$

Any number of color transformations and/or frames may be used, and the grid may be designed with shapes other than hexes. This technique can also allow code readers, such as a QR code reader, to read the obscured content during an obscured rendering, but not if the obscured rendering is captured via screen capture.

Obscuration Technique—Edge Detection

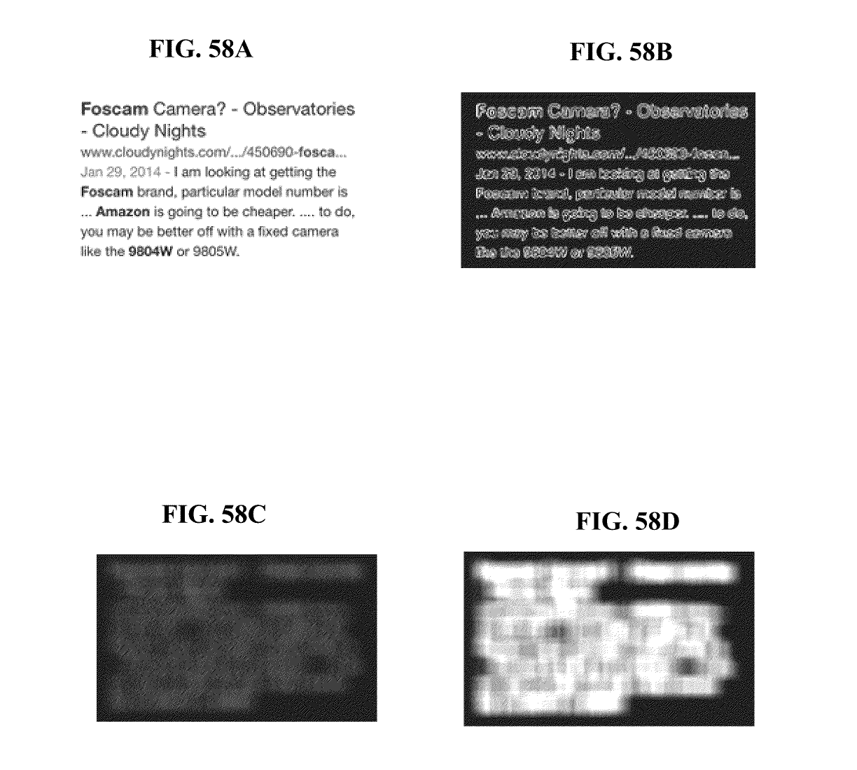

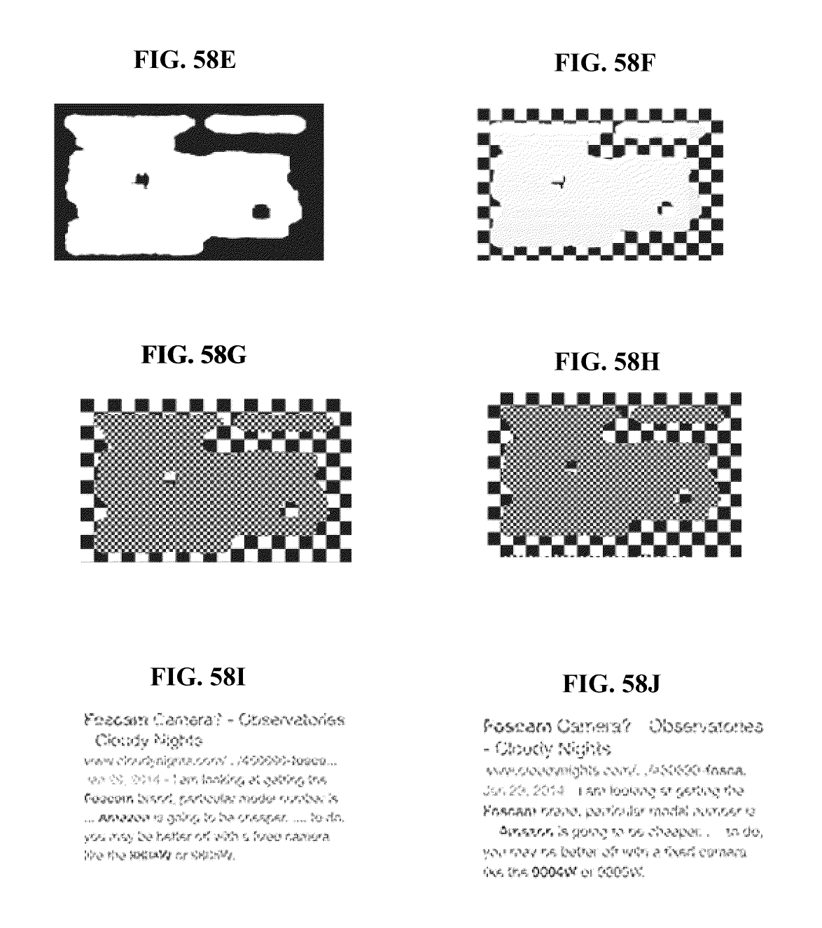

This masking and transformation technique is illustrated in FIGS. 58A-J. In this technique, a mask can be created that is based, for example, on a checkerboard where the density of the checkerboard is based on the density of edges in the source content. In some embodiments, the source content can be filtered with an edge detection routine, for example, GPUImageCannyEdgeDetectionFilter from the GPUImage Frame work from https://github.com/BradLarson/GPUImage. As shown in FIGS. 58 A-J, the resulting image can be blurred using, for example, a Gaussian blur transformation. The image can then be lightened using, for example, an exposure filter such as GPUImageExposureFilter. The result can be posterized to create a mask that exposes the high edge density areas using, for example, GPUImagePosterizeFilter (with only 2 levels black and white in this example). The posterized mask may be used to integrate two checkerboards where the lower density aligns with the low edge density and the higher density aligns with high edge density. A second mask can be created by inverting the posterized mask. The background color of the source content can be identified to create an image of the background color.

The posterized mask can be used to create a first image using the following exemplary algorithm: image1=mask1+sourceimage+backgroundimage.

The inverted mask can be used to create a second image using the following exemplary algorithm: Image2=mask2+sourceimage+backgroundimage.

During rendering, image1 and image2 can be cycled as described herein, and a configurable mask may also be used to allow the author to select where the cycling images will appear on the source image.

Obscuration Technique—Logo Obscuration

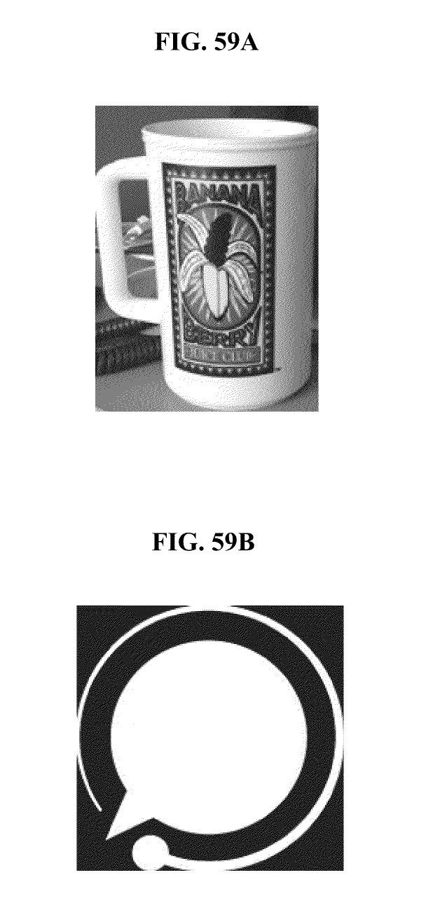

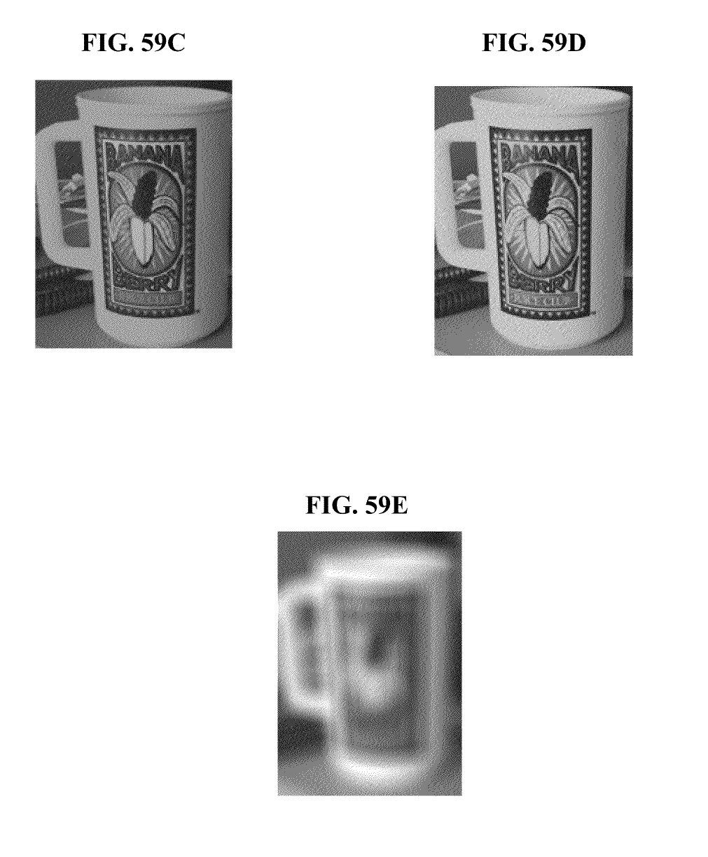

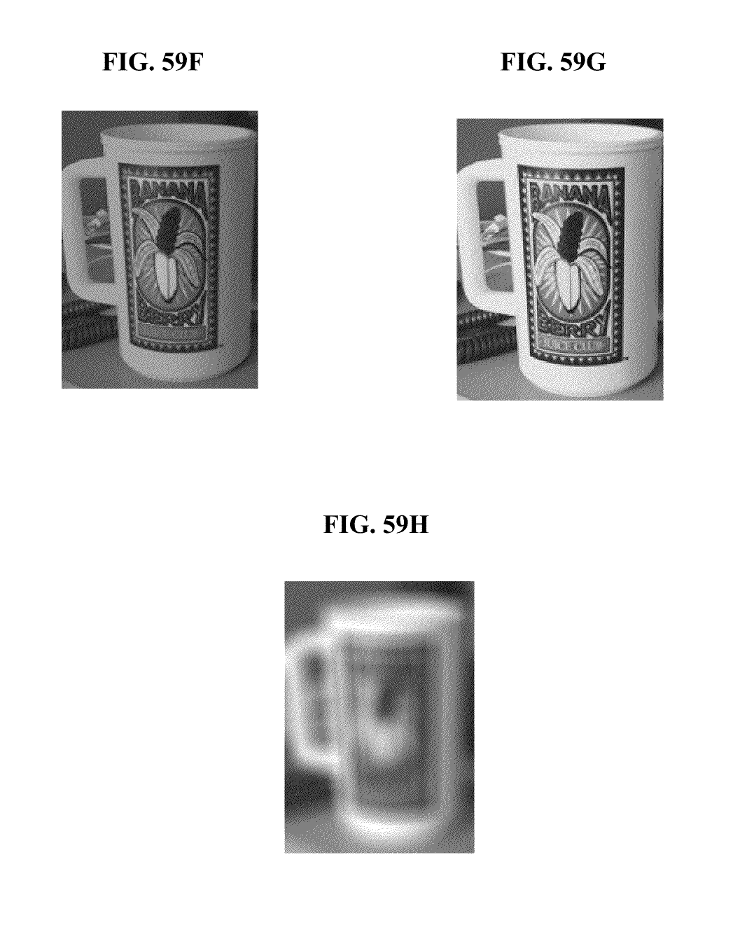

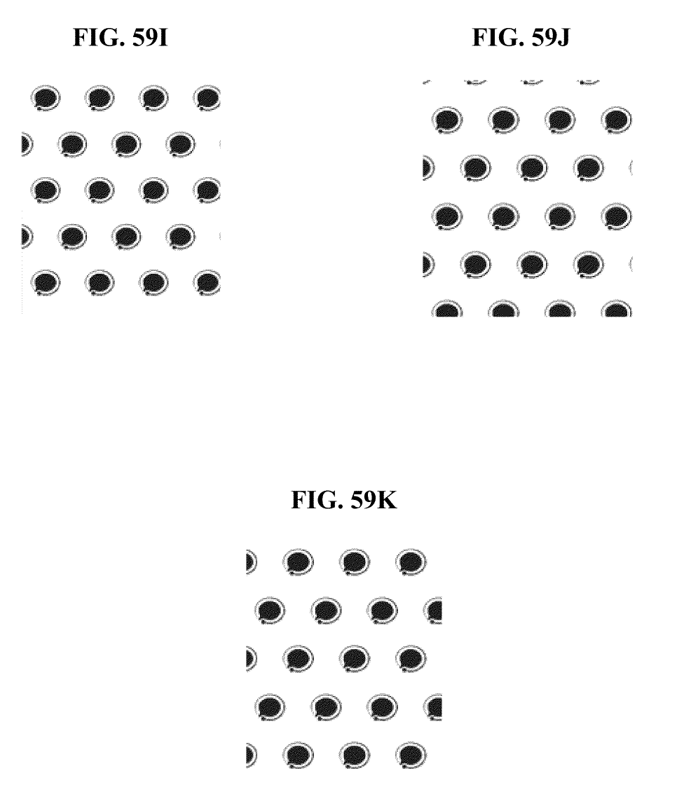

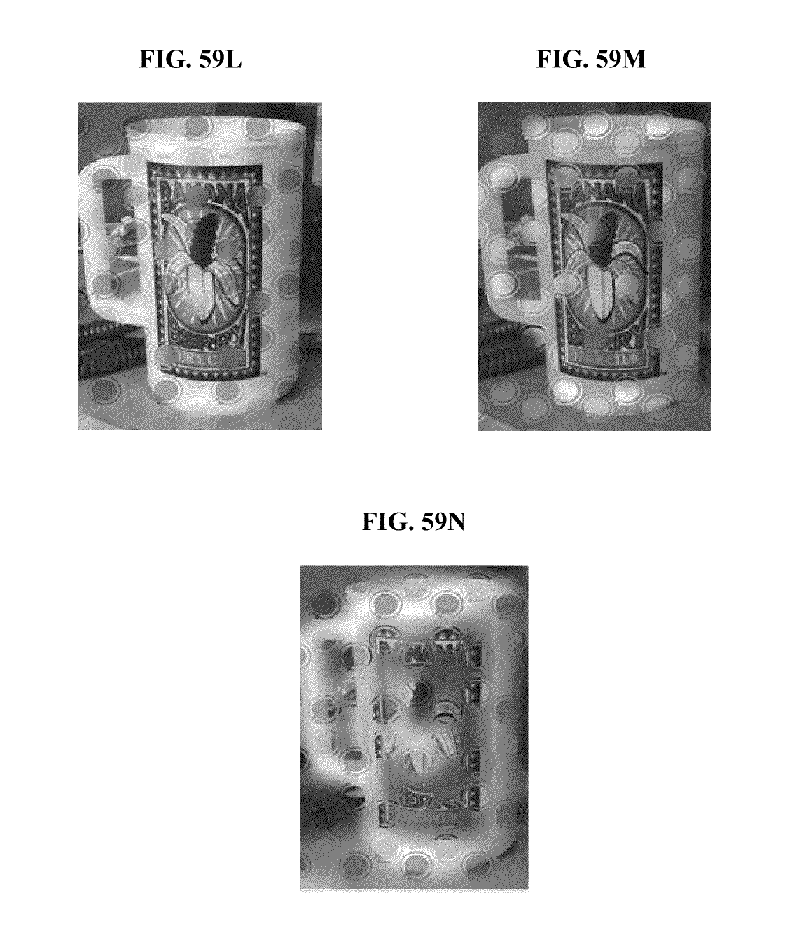

This masking and transformation technique is illustrated in FIGS. 59A-N. In this technique, a mask can be created that is based, for example, on a logo or other design. In this example, FIG. 59A shows the source content, and FIG. 59B shows a logo that can be used as a mask.

In some embodiments, a first transformation set of three (or more) images can be created to be used as a fill for the logo(s). FIGS. 59C-E show an exemplary first set of transformed images using RGB transformations that constrain the luminance as outlined herein to generate the transformed images in FIGS. 59C-D and a Gaussian blur technique to generate the transformed image in FIG. 59E. A second transformation set of three (or more) imaged can be created to be used as a fill for a background image using similar technique, but with different RGB transformations, for example. FIGS. 59F-G show an exemplary second set of transformed images. Next, a set of grid templates may be created as described above, but instead of using hexes, the logo or other shape may be used (see FIGS. 59I-K).

Using these images, sequence images can be created. For example, the image shown in FIG. 59L can be created over the background image shown in FIG. 59G using the following algorithm: Image1=(mask1+transLogo1)(mask2+transLogo2)(mask3+transLogo3).

Similarly, the image shown in FIG. 59M can be created over the background image shown in FIG. 59F using the following algorithm:

Image2=(mask1+transLogo2)(mask2+transLogo3)(mask3+transLogo1).

Finally, the image shown in FIG. 59N can be created over the background image shown in FIG. 59H using the following algorithm:

Image3==(mask1+transLogo3)(mask2+transLogo1)(mask3+transLogo2).

In some embodiments, different combinations of the images from the first transformation set and the second transformation set may be used to allow, for example, the logo or other design to get a controlled luminance set and the background to get another controlled luminance set.

Obscuration Technique—RGB Averaging

Another obscuration technique according to the disclosed embodiments is to cycle RGB values to average the original image.

For example:

Cycle 1, image portion 1: R+10, G−50, B+80

Cycle 1, image portion 2: R−50, G+20, B−70

Cycle 2, image portion 1: R−10, G+50, B−80

Cycle 2, image portion 2: R+50, G−20, B+70

Thus, for each image portion, the net values for each of R, G, and B are zero, thereby displaying the original image. For example, for image portion 1, cycle 1 has a red value of +10 and cycle 2 has a red value of −10, for a net red value of 0.

Obscuration Technique—High Contrast

According to aspects of the embodiments, the characteristics of the content may influence which obscuration technique is selected. For example, for high contrast materials, such as documents, an obscuration technique may include identifying how many pixels the dark portions of the content (e.g., the text) is occupying in the image (e.g., each line is x pixels high, each character is y pixels wide). This pixel analysis can be based on how the document is displayed on the screen, as compared to the source document, which allows this obscuration technique to support zooming, for example. Suppose the native character in a .jpg photo of a document is 8×8. It may be displayed on a 4 k high definition monitor and zoomed in so that the displayed character would be 200×200. By basing the pixel analysis on the display of the document, a full character obscuration would be 200×200 pixels. Furthermore, as the operator zooms in and out of the document, the obscuration could resize, for example, relative to the displayed pixel size (e.g., if the operator increased the zoom such that the character was 400×400 pixels, the obscuration would grow to 400×400). However, in some aspects, the obscuration technique may also be configured to ignore the zoom, and remain at a constant size.

A shape can be selected (e.g., a square, a circle, etc.) and colored based on the background color of the document. The size of the shape can be based on an approximation of the average pixel size of the characters in the document when rendered on the screen. For example, the shape can be sized equal to the average pixel size so that when overlaid on a character it would fully obscure the character, the shape can be smaller to only allow portions of the character to show through, the shape can be larger to obscure multiple characters at the same time, etc.).

In this manner, the obscuration algorithm used to apply the obscuration technique can be linked to the character size of a rendered document rather than fixed to a pixel size. A pattern of the shapes (e.g., random or fixed set) can be placed or overlayed over the document being displayed, and cycled rapidly to allow each character (or set of characters, portion of characters, etc.) equal time being exposed on the screen. In some embodiments, the background color and character color can be inverted or otherwise modified to have, for example, a black background and a colored character, etc. In addition, in some embodiments, the character color can be used, for example, as the shape color.

The above-described scaling of an obscuration can also be tied to an analysis of the characteristics of image content rather than documents. For example, facial recognition can be used to find the eyes in an image, and the obscuration (for example, fence post spacing) can be scaled to ensure that both eyes are not revealed in a single frame. This is beneficial in that having both eyes exposed when viewing photograph leads to an easier identification, and applying an obscuration technique that prevents both eyes from being revealed at any given time helps conceal the identity of a person included in the content being obscured.

Further aspects of the embodiments include analyzing the direction of the text in a document to determine the direction of the text (e.g., left to right) and altering the orientation and/or direction of motion of any obscuration technique to optimize the obscuration effect on a screenshot. For example, if the direction of the text is left to right, the motion of an obscuration (e.g., fence posting) could travel from right to left, thereby enhancing readability to a user while also increasing obscuration (e.g., the fence bars would cross the text on a screen capture instead of allowing a single gap between fence post to make visible an entire line of text).

Obscuration Technique—Browser

In some embodiments, an obscuration technique can be applied to content that is displayed in a browser. For example, suppose content is placed on a web server. A program (e.g., browser script program code) that runs in a browser can also be placed on the server (e.g., java, activex, flash etc.). In response to a request from a browser client, the program code and the content can be sent to the browser client, and the content can be rendered by running the browser script program code. The program code can be used to apply an obscuration technique to the content.

Obscuration Technique—Independent Rendering

Aspects of the embodiments further relate to using a standard rendering application (e.g., a pdf viewer, a jpg viewer, a word viewer, and the like) to render content on a screen. An obscuration program running on the rendering device can be used to analyze the rendered content, for example, by analyzing the frame or frame buffer, identify a security mark (e.g., a text mark “confidential”, a barcode, a forensic mark, a recognized person, etc.) that is being rendered by the standard application, and activate a routine that applies an obscuration technique over the standard application window to prevent unauthorized capture (e.g., screen capture, photography, etc.).

This approach follows the teachings of “Data Loss Prevention”, where content is allowed to flow using normal applications and workflows. The obscuration program prevents the rendering of content by a native or standard rendering program from being captured in an unauthorized manner (e.g., email scanning for confidential and the like). This approach augments existing system securities by utilizing obscuration programs to monitor renderings and apply obscuration techniques as needed during the rendering by recognizing the content is itself valuable based on marks or recognition of the content.

This approach can also be used with content transport (e.g., file server, email server etc.) to identify content that is important and requires obscuration technique protection. The system may then apply DRM and obscuration technique requirements automatically to the content, and allow the content to continue its path in the content transport (e.g., an attachment would be rewritten to require application of an obscuration technique and other DRM procedures, and allowed to continue).

Obscuration Technique—Element Identification

Further aspects of the invention relate to applying obscurations based on identifiable elements in content. First, the content can be evaluated to identify certain elements such as, for example, faces, eyes, fonts, characters, text, words, etc. An algorithm can be applied that indicates how certain elements that have been identified are allowed to be displayed simultaneously with other elements (e.g., faces with eyes, words with certain letters, etc.). This information can be used to further determine how the identifiable elements can be manipulated during obscuration. For example, an obscuration technique can be applied that allows the display of certain elements in one frame without the display of other elements that should be displayed with those certain elements. Thus, in one frame, a face can be displayed without the eyes, and in another frame, the eyes can be displayed without the face. Similarly, in one frame, some letters in a word can be displayed, and in another frame, the remaining letters of the word can be displayed. This technique can be applied to any indentifiable elements of content. In addition, although the above examples use alternating two-frame techniques, this same technique can be applied using more than two frames (e.g., 3 frames, 4 frames, 5 frames, etc.).

The rules used to implement the above-described obscuration techniques may be included in the rights portion of a license that is distributed with the content, hard baked into the client that displaying the content with the obscuration techniques, etc.

Example Rules Language:
Obscuration Rule (Eyes and Faces):
   Element 1=pair of eyes
   Element 2=face associated with element 1
   Rule=Element 1 or element 2 never both simultaneously
Obscuration Rule (Characters of a Word):
   Element 1=word in a document
   Elements 2-x=characters in element 1
   Rule=Only 33% or less of Elements 2-x of Element 1 are visible simultaneously (for words greater than 3 characters)

Obscuration Technique—Multiple Transformations

Aspects of the embodiments relate to applying an obscuration technique using multiple transformations to the content to create, for example, a flipbook effect during obscured rendering. For example, a transformation (fbx) can be applied to a plurality of images rendered in a frame buffer. When each of these transformations is displayed in sequential order (e.g., fb1, fb2, fb3, . . . ), the resulting display emulates an obscured rendering (e.g., a flipbook animation). The sequence can be repeated as many times as is necessary for display.

Obscuration Technique—Proximity Based Obscuration

Wireless communication devices today feature high resolution screens and multiple-band/multiple-standard two-way communications that enable the capability to send and receive still images and video at very high levels of display quality. Wireless communication device capabilities increasingly include the ability to enlarge displayed images and render them at high resolution, revealing very fine detail.

This aspect of the disclosed embodiments relates to the inhibiting or allowing removal of obscurations when another Wireless Communications Device is proximate using short range communications (e.g., BT, NFC). In this instance, proximity can be based on RSSI as proxy for distance, and the MAC of the other device can be used to determine imaging capability through DB lookup. Exceptions may be granted, for example, by explicit permissions.

According to this aspect of the disclosed embodiment, an obscuration may be altered when another device is detected to be in close proximity. For example, an offer may be sent that the obscured content becomes exposed (e.g., not obscured) when the user is in a specific store and receiving the MAC of its wireless network. As used herein, an offer may include a percentage or dollar amount discount to a listed price or prices for an item or service, a free item or service given with the purchase of another item or service or a percentage or dollar amount discount to the aggregate price to multiple items or services purchased together in a specified quantity or combination. The offer may either be written out as text, as a scannable code or symbol or other image or as a combination of text and image.

Proximity Inhibit

Since the introduction of the first wireless phone incorporating an integral camera, so-called “camera phones” have become nearly ubiquitous. While these phones can store their captured images in memory on the device, their unique innovation was the ability to send or “share” images by transmitting them via their integral wireless capability to another location where they may be stored or displayed. These locations included other wireless phones.

The capability to store and display gave rise to new applications that extended beyond simple image storage and display to include editing and filtering, annotation with text or voice, tagging with GPS location information and sharing with one or more device automatically.

An area of recent innovation introduces the ability to place restrictions on the use of shared images. These restrictions may encompass limiting the time an image may be displayed, the ability to store or forward and others that allow the user of the device sending or sharing the image to control circumstances of the image's use by recipients.

One issue surrounding control of these shared images is the concern that a displayed image can be re-imaged, for example, by taking a picture of the displayed image with another camera phone or camera. Some disclosed embodiments herein are concerned with inhibiting that capability and thus further ensuring that the image is controlled according to the restrictions placed on its use.

Camera phones in use today generally have the capability of operating in multiple frequency bands using multiple radio standards specified for those bands. For example, the Apple iPhone 5 contains radios capable of operating in the 850, 900, 1700/2100, 1900 and 2100 MHz bands utilizing the UMTS/HSPA+/DC−HSDPA, GSM/EDGE and LTE standards, as well as operating in the 2.4 GHz band using the 802.11a/b/g/n and Bluetooth 4.0 standards, and in the 5 GHz band utilizing the 802.11g/n standards.

These phones can operate as both a transmitter and a receiver of the particular standards within these bands. Additionally, all wireless standards require that each mobile device be capable of transmitting a unique ID. For example, the 802.11 series of standards mandate the transmission of a Media Access Control (MAC) address, as does the Bluetooth specification. These addresses are generally assigned in ranges which correspond to a particular model of device (e.g., iPhone 5, Galaxy S5, etc.)

An emerging trend is the incorporation of significant wireless capabilities into digital still and video cameras. These capabilities, however, are also based on existing wireless bands/standards and allow device identification in the same way as camera phone mobile devices.

Further standards typically specify a maximum allowable transmission strength for mobile devices. This is usually expressed in terms of an Effective Isotropic Radiated Power (EIRP). Knowing the EIRP allows rough calculation of distance between a transmitter and a receiver based on Received Signal Strength Indication (RSSI).

Disclosed embodiments can inhibit the display of a restricted image when another wireless imaging device is proximate. This can be accomplished, for example, by scanning one or more bands for the appropriate standard, detecting and measuring the signal strength (RSSI) of each of the detected IDs, consulting a table or database to determine which IDs identify devices with cameras, comparing the RSSIs of the camera equipped devices with a table that correlates RSSI with approximate distance for the band/standard combination, or inhibiting display on the device if any of the detected proximate camera devices are within a specified approximate distance. Another option is to inhibit based on the RSSI of any proximate signal regardless of whether it may be uniquely identified. This would be appropriate in some high security situations.

It is possible that there could be proximate devices which have cameras that are not a concern, such as a photographer carrying a wireless capable camera (such as a Panasonic GH3 or GH4). In this case exceptions may be made which allow such proximate devices based on ID. However, this capability may be overriden by restrictions placed by the originator of the sent or shared image.

Proximity Enable

Another means of controlling image display in current practice is the obscuration of the image by reducing the clarity of the image such that some action is necessary to restore the ability to see the image well enough to make the objects in the image viewable. This obscuration may be accomplished by making all or some of the image out-of-focus or visible only through some set of distortions or other superimposed images.

These obscuration techniques can be applied by the sender's device or originator of the image. The restricting mechanisms that allow the clear image to be displayed may also be imposed by the sender's device or originator.

Various mechanisms can be used to automatically remove obscurations including geofencing, the use of an area defined by latitude and longitude points, wherein when a wireless communication device is within such a defined area the image is automatically rendered without obscuration. Geofencing in this manner may be dependent on Global Positioning System satellites being receivable by one or more GPS receivers in the wireless communication device and the wireless communication device being capable of comparing the position calculated by the GPS receiver with the points defined by the geofence. This can be challenging when the wireless communication device is in a location where there is limited or no signal path from the GPS constellation to the wireless communication device.

A typical wireless communication device such at the iPhone 5 has the capability of operating in multiple frequency bands using multiple radio standards specified for those bands. This allows for the transmission and reception of large, high resolution still images and video as well as their display on a 4-inch screen with 1136×640 resolution that delivers 326 pixels-per-inch (ppi). This wireless communication device from Apple also incorporates a 1.3 GHz ARM-based processor providing the processing power to drive the high resolution display.

The wireless communication device can operate as both a transmitter and receiver of the particular standards within the bands in which it operates. Additionally, wireless standards typically require that each transmitter be capable of transmitting a unique ID. For example, as mentioned above, the 802.11 series of standards mandate the transmission of a Media Access Control (MAC) address, as does the Bluetooth specification. These addresses are generally assigned in ranges that correspond to a particular model of device (Linksys Advanced Dual Band N Router Model E2500, Bluetooth Wireless Network Platform/Access Point BTWNP331s, etc.) These devices may also “broadcast” a specified name (Lowe's WiFi, Boingo, etc.) which may be meaningful (John's Home Network) or obscure (zx29oOnndfq). Various other short range transmitters such as those compliant with ISO/IEC 14443 and 18092 may also be employed in a similar manner. As described above, setting the EIRP controls the Received Signal Strength (RSS) at devices and thus defines an area in which a usable signal may be received.

The disclosed embodiments enable the obscuration of an image or video to be removed, for example, when a wireless communication device receives a wireless signal with a threshold RSS at the wireless communication device defined by an obscuration removal rule, or that matches an identifier of a wireless transmitter specified as allowed by the obscuration removal rule or in a database referenced by the obscuration removal rule. This allows for images to be displayed “in the clear” when proximity-based criteria are met, such as in secured areas or for retail offers to be fully displayed only in a particular place such as a shopping mall or retail store.

Proximity Access

Wireless communication devices have screens capable of displaying all types of images. Some of these images may be used by other imaging devices to assist in the completion of transactions, authenticate or allow access by displaying visual symbols or codes such as bar codes, QR codes or images such as those in U.S. Pat. No. 8,464,324. These systems are in common use today in retail settings such as Starbucks Coffee, which uses a bar code scanner to capture a bar code displayed on a wireless communication device to verify a purchase transaction debiting an account.

One weakness of any system that uses displayed images is that the image can be captured by another imaging device, for example the camera in a wireless communication device such as a smartphone, and then presented as though it was the original image. This “spoofing” of the original image may not be an issue in some circumstances, but could be problematic in others. One of these is the area of access control.

The disclosed embodiments prevent duplication of the clear content of an image by making it unusable until it is proximate the point of use. The image is delivered to the wireless communication device in a form in which all or part of the image is obscured and thus not recognizable to a scanning or image matching system until a short time before the image is used.

For example, an obscured image may contain a code, image or symbol representing an access token to a place or venue. A transmitter may be placed proximate to a reader, scanner or similar imaging device at the access control point to a place or venue. An RSSI value may be defined corresponding to the desired estimated proximity in terms of distance between the wireless communication device and the transmitter. When the wireless communication device measures an RSSI at or above the defined threshold (e.g., when the wireless communication device is proximate to the designated place or venue), the previously obscured image has the obscuration removed such that the image can be readable by the reader, scanner or similar imaging device.

If the RSSI should drop below the defined RSSI value, the image can once again be obscured, or if an indication is sent to the wireless communication device that the image has been successfully captured by the reader, scanner or similar imaging device then the image can be deleted or permanently obscured.

This is useful in situations in which one time access is granted, such as tickets to an event or venue. It is also useful in situations where access is only temporarily required such as maintenance workers who only are granted access on an as-needed basis.

Geolocation

Various mechanisms have been proposed for automatically removing obscuration including geolocation, wherein when a wireless communication device moves closer to the defined point the image becomes less obscure and when a wireless communication device move farther away from a defined point the obscuration increases. Geolocation in this manner can be dependent on Global Positioning System satellites being receivable by one or more GPS receivers in the wireless communication device and the wireless communication device being capable of comparing the position calculated by the GPS receiver with a distance metric to/from the point. This can be challenging when the wireless communication device is in a location where there is limited or no signal path from the GPS constellation to the wireless communication device. As described above, setting the EIRP controls the Received Signal Strength (RSS) at devices and thus approximates the distance from a transmitter.

To enable object or location searching, an object or location can be imaged as a static or moving image and the image can be obscured and sent to one or more people who are engaged in searching for the object or image. Then, a wireless transmitter can be placed with the object or at the location. The wireless communication device can have either the ID of the transmitter or can obtain the ID from a database. As the wireless communication device's RSSI for the wireless transmitter increases, the image becomes less obscured. As the wireless communication device's RSSI for the wireless transmitter decreases, the image becomes more obscured. When the RSSI reaches a level defined in the restrictions the image is no longer obscured.

In addition, additional wireless transmitters (e.g., that have different identifiers than the transmitter placed with the object or at the location) can be placed at various distances away from the transmitter placed with the object or at the location. This is useful for activities such as “discovery” tourism, clue-based geocaching-like activities, “treasure hunts”, etc.

Gamification

A current trend in user interfaces for portable computing devices is the use of gamification to drive greater engagement with applications operating on the device. This includes having the user engage in behaviors consistent with those used in playing a game. These may include answering questions, doing some activity repetitively such as shooting at targets, following directions, etc. The end result of this game playing is a hoped-for reward such as winning a prize or, in the case of computer games, obtaining new levels or new capabilities.

Gamification may also be applied to the process of removing obscuration(s) from an image displayed on a personal computing device (PCD) including a wireless communication device). For example, an obscured image is presented on a PCD and the obscuration can be removed by:
Repetitively “rubbing” the image using a finger, cursor, mouse or similar pointing mechanism as the repetitive motion is made, the image is gradually becomes recognizable
Progressively answering two or more questions—as each question is correctly answered the image becomes increasingly recognizable
“Hitting a target”—by pointing at a second image that is displayed on the screen independent of the obscured image, as each “hit” is made the image becomes increasingly unobscured

The degree to which the obscuration is removed for each increment of successive action may be configurable. Of course, any other suitable gamification technique may also be used in this regard.

Obscuration Technique—Water Turbulence

Another obscuration technique according to the disclosed embodiments is to apply a transformation over the image that looks like it is being viewed through turbulent water and optionally allow the user to manipulate turbulence. In this manner, the water turbulence effect blurs the image while also creating a visually pleasing affect and the underlying content obscured by the surface of the turbulent water can be identified and used.

Obscuration Technique—Document Fade

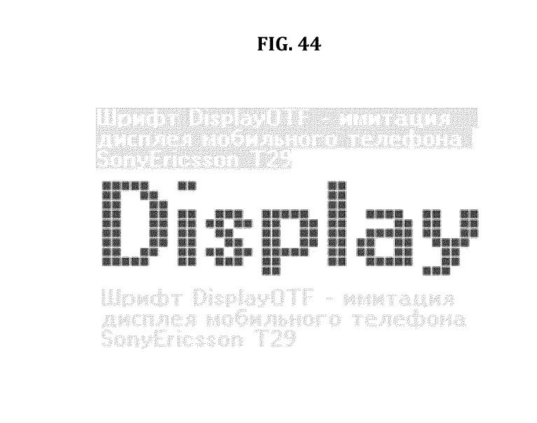

In the case of black and white documents, another obscuration technique is to randomly place background colored pixels over an image and cycle rapidly. For example, suppose there was an image such as the graphic illustrated in FIG. 44. Random portions of the word “Display” may be whited out or faded such that only a portion (e.g., 20%) of the image would be visible at any given cycle. Over time, all of the pixels would be displayed, but each individual pixel would only be visible a portion of the time (e.g., 20%). Thus, the resulting image would appear greyer instead of solid black. In one embodiment, a solid opaque image colored the same as the background color of the document would be created. This solid opaque image would be divided into rows and columns at a resolution based on the resolution of the underling characters in the document (e.g., an 8×8 pixel character can be identified, this algorithm can create an obscuration at ¼ the size of the character so, and the obscuration may utilize a 4×4 pixel array to segment the solid opaque image.) The solid opaque image can randomly or procedurally mask elements in the opaque image to allow the content to be viewed through the mask. Parameters associated with this obscuration technique can provide which and how many array elements are rendered transparently, how frequently the array elements are changed, and the like). When viewed during this obscured rendering, the user would see each varying portions of a character for a given frame set. Degraded content as a result of a screenshot would include many of the characters as being only partially visible. An exemplary alternative would be to place a black background with white text.

Obscuration Technique—Windshield Wiper

Another obscuration technique according to the disclosed embodiments is to apply an obscuration technique that is similar in appearance to a windshield wiper. In this instance, an animated windshield can be overlayed in front of the content to mimic the look of a driver looking out a windshield. Other graphical elements (e.g., dash board elements, rain on the windshield, blur on the windshield mimic depth of field (sharp content, blurry windshield and content), etc,) may be included, and the sender's device (or receiver's device) may be allowed to vary the intensity of the effects, such as the rain. The obscuration may be achieved through an animated bar (e.g., the windshield wiper) that sweeps back and forth on the windshield to clear the rain and provide a temporary non rain view of the content beyond the windshield. The sender's device (or receiver's device) may be permitted to vary the intermittency of the windshield wiper.

Obscuration Technique—Reading View

Another obscuration technique according to the disclosed embodiments is to place the protected document for reading on the screen and obscure the document using any number of techniques (blur, fog, fade text to background color etc.), and then make the content clear one portion at a time. For textual content, the clear content may include, for example, one portion of the text (letter, word, sentence, paragraph etc.). The user can then input a control technique or command (scroll wheel, drag bar, touch and drag object etc.) to modify the visible section of the content so the clear text advances in a reading pattern (left to right or right to left or top to bottom etc. depending on language). In addition, the clear section may advance automatically. As the clear section moves, the previously clear section becomes obscured again.

The obscuration may include enciphering the text, for example, by placing a random word or sequence of characters. The replacement word or sequence of characters may be related to the enciphered word (e.g., same number of characters, same capitalization, same set of characters in a different order, etc.). In addition, the text may not be shown; instead indicate a marker on the screen to allow the user to understand where they are currently in the document (highlight a portion of the document behind the obscuration and allow the obscuration to hide the text but allow the user to see the effect through the obscuration (see a blurry document that cannot be read, but formatting etc. can be seen, one word or sentence is highlighted (change in color or background color etc.)). In this scenario, a text to voice converter may be used to allow the reader to “hear” that portion of the document as it is read.

The user may also be permitted to select where in the document they want to “hear” the text to voice, e.g., pick a word/paragraph, the system advances the highlight to that location and begins to text to voice at that point, and the user may be allowed to control the rate of reading via a control object that they can manipulate.

Obscuration Technique—Using a Separate Device to Perform De-Obscuration

In this aspect of the disclosed embodiment, obscured content may be de-obscured by a separate device (e.g., 3D LCD shutter glasses). In addition, data may be transmitted to an external device to obtain information regarding how to de-obscure (computer tells device that every 18th frame is valid, ignore the other frames; glasses only make the glasses clear during every 18th frame etc.). In this scenario, external devices can indicate what de-obscuration techniques are supported. For example, a device that is positioned in front of the screen and filters random colors in real time can inform the computer of what pattern it is using so that the computer can present the image on its screen in a pattern that, when viewed through a color filter system, can appear normal. However, when a screenshot, for example, is captured, the image would be distorted or otherwise be less than useful. More specifically, suppose an external device filters red in a section of the screen (e.g., section 1,5), then the computer may saturate that section of the screen with red at the same time. When viewed without the device, the image would be distorted. However, when viewed through the device, the red would be filtered out.

Rendering Obscured Images

When obscuration techniques are applied to still images according to some embodiments, the obscuration techniques frames in a frame set may be converted to GIF frames, for example. These GIF frames then can be saved in animated GIF file format for playback as an n-frame loop.

Another approach takes advantage of computing devices with graphic processors (GPUs) and multiple frame buffers. A frame buffer consists of a large block of RAM or VRAM memory used to store frames for manipulation and rendering by the GPU driving the device's display. For GPUs supporting double buffering with page flipping, and for still image obscuration techniques with a two-frame cycle, some embodiments may load each obscuration techniques frame into separate VRAM frame buffers. Then each buffer may be rendered in series on the device's display at a given frame rate for a given duration. For GPUs supporting triple buffering, and for still image obscuration techniques with a two-frame cycle, in some embodiments, each obscuration technique frame may be loaded into separate RAM back buffers. Then each RAM back buffer may be copied one after the other to the VRAM front buffer and rendered on the device's display at a given frame rate for a given duration.

In some embodiments, a GPU shader may be created to move much of the processing to a GPU running on the device that is creating an obscured rendering. In this fashion, a single frame of an obscured rendering may be created in near real time (e.g. less than 1/20 of a second or faster). This allows devices that generate image frames on the order of 1/20-1/120 of a second to have an obscuration technique applied to the output of the camera without having to pre-record the content and then view the obscured rendering, for example.

Each image frame of the obscured rendering may be processed by the shader in a different configuration. For example, the shader may take a masking image and apply 1) a red transform where there is black in the mask at the corresponding location and 2) apply a blue transformation where there is white in the mask at a corresponding location. The next frame may reverse the red and blue transformation using the same mask.

This technique may be used, for example, for each frame of a video, or each frame of a rendering of a still image, etc.

Obscuration Technique—Front Facing Camera Techniques

Certain mobile communication device applications send ephemeral graphical content (e.g., photos, videos) meant to be seen briefly by a recipient before automatic deletion. The intent of the sender is typically not to leave a permanent record of the content on any third-party device. However, this intent can be circumvented by using a camera on a second device to take a snapshot or video of the recipient's device screen during display of the ephemeral content. In some cases, the sender desires that only the owner of the recipient's device may view the content.

Disclosed embodiments herein enable ways to prevent a second device from capturing the screen of the recipient's device during display of the ephemeral content using a built-in front-facing camera on the recipient's device. For example, a front-facing camera on a device can be used to detect a face in order to permit the display of the obscured, ephemeral content. In this scenario, facial recognition with the front-facing camera can be used to allow just the owner of the phone (or another authorized person) to view the content while preventing a non-owner from controlling the device, or the content on the device from being passed around. Authorized users can be established, for example, by having them take a front-facing camera snapshot of themselves when installing the app (or subsequently by password established when installing the app), and only displaying the ephemeral content if the face matches. This technique can be enabled through existing facial recognition/tagging technologies, employed in many mobile device camera and photo applications, for example. If there is any change in facial characteristics that would interfere with positive recognition (e.g., glasses, hairstyle, injury), the user would be able to reset their face authorization photo by selecting that option in conjunction with entering their password.

Obscuration Technique—Barcode Scanning

Another aspect of the disclosed embodiments relates to obscuring sensitive data, such as barcodes or other coded scanning patterns, within content. In this scenario, an obscuration technique is applied over a barcode or other sensitive data. When a screen capture or single frame is displayed, at least a portion of the barcode will be obscured. However, when the content is displayed in the manner intended by the specific obscuration technique, the barcode can be readable with a barcode scanner or suitable reader.

Using Degraded Content as Source Content

According to some aspects of the embodiment, degraded content can be used instead of censored content. For example, when the source content is distributed, a usage rule may be included that requires that an obscuration technique be applied during rendering. The obscuration technique can cause metadata to be embedded into any degraded content that is captured (e.g., using well-known stenographic techniques). When an unauthorized use occurs (e.g., screen shot is captured), the resulting degraded content includes the metadata with information such as an identifier of the source content, an identifier of the user or device that was displaying the obscured content when the degraded content was generated, information identifying the degraded content as coming from a trusted application, and the like. This degraded content can now be treated like censored content if it is distributed by the user or device that created the degraded content. When a secondary user opens the degraded content (e.g., in a non-trusted application), the degraded content can be displayed with relevant portions of the metadata (e.g., information identifying that the degraded content was captured while the obscured content was displayed in a trusted application). The secondary user can use this information to open the degraded content in a trusted application, and the trusted application can in turn recover the metadata. The trusted application can also attempt to recover the source content using any available identifiers of the source content. The trusted application can also report information about how the degraded content was created (e.g., the identification of the user or device that captured the degraded content during the obscured rendering).

This technique can be applied using a fence posting obscuration as follows, for example:

Algorithm for Embedding:

1) Create a solid image to use as a fencepost that is 80 percent as wide as the image to be displayed

2) Use steganographic techniques like: http://www.openstego.info/ to apply the identification information to the solid image

3) Divide the solid image into 8 columns and give one column a unique mark to identify it as the lead column. The remaining columns can follow the lead column during obscuration.

4) Use the 8 columns as fenceposts in the fence post algorithm

5) Rapidly move the 8 columns in front of the image during the obscured rendering

Algorithm for Recovery:

1) Identify the degraded content and the fence posts in an image file

2) Identify the 8 columns in the degraded content

3) Assemble the 8 columns back into a single image in memory

4) Apply steganographic techniques to the single assembled image to recover the identifying information

A trusted application that has the identification information recovered using this technique may then follow the content identifier (e.g., URL pointing to source content) to request the source content and usage rules, thus allowing the degraded content to serve as censored content.

Detection of Degraded Content

According to aspects of the embodiments, the receiver's device can be used to identify and detect creation of degraded content and/or efforts to capture obscured content in an unauthorized manner. For example, during obscured rendering, the trusted application can select a GUID to encode in the obscuration. The trusted application can then use this GUID to report what content and what user/device was performing the obscured rendering to a server with the selected GUID. This reporting can be performed either upon obscured rendering of the content begins or is completed, when unauthorized actions are performed, or at any other suitable time. The reporting can include information such as “which user is viewing the content”, “which device/application is providing the obscured rendering”, “what source content is being viewed”, and the like. Any captured degraded content can also be sent back to the server for analysis, and the GUID can be recovered from the degraded content.

As an alternative to using a GUID, characteristics of the obscuration technique (e.g., shapes, color data, etc.) can be used to identify degraded content. For example, during obscured rendering, a GUID or other identifying information can be selected or generated. The GUID or identifying information can then be encoded (e.g., using a QR code), and the encoded information can be used as part of the obscuration element (e.g., the fencepost bars may include the encoded element, etc.). To make the identifying information easier to recover, the color of the source image may also be altered to reduce or eliminate conflicting colors between the encoded information and the obscured content. Using this technique, any captured degraded content can be sent back to the server for analysis, and the encoded information can be recovered. The recovery may include taking steps to isolate the obscuration elements that include the encoded information by manipulating the degraded content. The encoded information can then be used to recover the identifying information.

Reverse Obscuration

Aspects of the disclosed embodiments further relate to using obscuration techniques to reveal source content. For example, before rendering, source content can be modified to create modified source content. When the modified source content is rendered, rules can require the application of a specific obscuration technique that, when applied, counteracts the modifications made to the source content to create the modified source content. Thus, during the obscured rendering of the modified source content, the source content itself is exposed.

For example, suppose the modification of source content included rotating the RGB values of an image pixel array to +100 each. (e.g., R+100, G+100, B+100), and if the new values are greater than 255, change the value to value minus 255. (e.g., R+100=300, R=5 instead). The obscuration technique intended to reveal the source content may include creating a bar that subtracts 100 (e.g., using the inverse of the algorithm above) from each RBG value during the display. During the obscured rendering, the bar can be moved bar rapidly across the image. Thus, when the RGB modification bar is not in front of the image, that image portion reverts to is “modified source content” values).

Source Image (0=original values)

00000000000

00000000000

00000000000

00000000000

Modified Source Image (+=valued modified using the +100 algorithm above)

+++++++++++

+++++++++++

+++++++++++

+++++++++++

Modified Source Image with Obscuration Technique Applied

t=0

0++++++++++

0++++++++++

0++++++++++

0++++++++++

Modified Source Image with Obscuration Technique Applied

t=1

+0+++++++++

+0+++++++++

+0+++++++++

+0+++++++++

t=10

++++++++++0

++++++++++0

++++++++++0

++++++++++0

t=11 (repeat t=0)

0++++++++++

0++++++++++

0++++++++++

0++++++++++

Where t= 1/60th of a second.

Obscured rendering: Rules can also be distributed with source content with conditions that require obscured rendering as well as another set of conditions that allow for unobscured rendering, for example, using the following algorithm.

{
Apply OT “abc″ during rendering of content “def″
If user is using a device of security class > 10
OT is not required
}
{
Apply OT “abc″ during rendering of content “def″
If user enters combination “secret” on the keyboard
OT is not required
}

Application of Obscuration Techniques to Video Content Data

The obscuration technique embodiments disclosed herein may also be applied to video content data. In some embodiments, the video frames from the video content data may be extracted to produce a set of image content data. The selected obscuration technique embodiment may be applied to the set of image content data to create obscured frames that may be reassembled into an obscured rendering of the video content data. In obscuration technique embodiments that produce two obscured frames in each frame set for a given image content data, each video frame in the video content data may produce two video frames in the obscured rendering of the video content data. For example, if the video content data consists of a 15 second video at 30 video frames per second, the obscured rendering of the video content data may consist of a 15 second video at 60 video frames per second if the obscuration technique embodiment creates two obscured frames for each image content data. In some embodiments, one or more obscuration technique embodiments may be applied to one or more image content data from an image sensor to create obscured frames. In some embodiments, the obscured frames may be assembled into obscured video content data. In some embodiments, a version of the video content data without obscuration may also be created from the one or more image content data from the image sensor.

Digital video encoders in use today, such as those implementing the H.264/MPEG-4 standard, use two modes of compression. Intra-frame compression leverages the similarity between transformed pixel blocks in a single video frame, while inter-frame compression tracks the motion of transformed pixel blocks in video frames before and after the current video frame.

H.264/MPEG-4 inter-frame compression can look behind or ahead up to 16 video frames for similar pixel blocks in the current video frame. Not all H.264/MPEG-4 encoders take advantage of this feature and, instead, consider only the video frame immediately before or after the current video frame. For these basic encoders, applying obscuration techniques on original video (or on still images to produce video) and preserving the quality of the original content may result in much larger files. This is due to the extra information required to encode obscuration technique video frames, which contain high-contrast edges impacting intra-frame compression, and much less video frame-to-video frame similarity impacting inter-frame compression. Reducing encoder output bit rate, file size or quality parameters may result in more compression and smaller files, but visual artifacts may be introduced and some detail may be lost.

In some embodiments, an H.264/MPEG-4 encoder may be instructed to apply only intra-frame compression when compressing obscuration technique frames to create an obscured rendering of a video. In some embodiments, each obscuration technique frame may be encoded as a separate JPEG image file in Motion JPEG format for playback of the obscurely rendered video.

For obscuration technique frame sets, each consisting of n obscuration technique frames, assuming that the n frames may be randomized within each obscuration technique frame set, an obscuration technique frame similar (or identical) to a given obscuration technique frame may be found within the previous 2*n−1 obscuration technique frames. An obscuration technique frame similar (or identical) to a given obscuration technique frame may also be found within the next 2*n−1 obscuration technique frames. In some embodiments, better compression may be obtained by instructing an H.264/MPEG-4 encoder to search up to 2*n−1 preceding or subsequent obscuration technique frames. In some embodiments, depending on the limitations of the encoder used to encode the obscured video data, n may be constrained (e.g., to 2<=n<=8 if the encoder can look behind or ahead up to only 16 frames).

Applying some obscuration technique embodiments to image data content, the features of the resulting obscuration technique frame may not align with the video compression pixel blocks, resulting in increased visual artifacts, decreased detail or larger file size. For example, for an image or video whose dimensions are not powers of two, an obscuration technique may be applied to 16×16 pixel blocks, while intra-frame compression may be applied in 8×8 pixel blocks. In this case, video compression may be improved when the obscuration technique pixel blocks and the intra-frame compression pixel blocks are aligned, i.e., two or more sides of each obscuration technique pixel block aligns with two or more sides of each intra-frame compression block. For H.264/MPEG-4 and JPEG, the origin for a frame is at top left, and an obscuration technique may be applied starting at this same origin. In addition, the dimensions of the obscuration technique blocks may be multiples of the dimensions of the video compression blocks or vice versa.

Preventing Image Persistence During Obscuration

Image persistence (also known as image retention) is a problem that occurs in many LCD displays and is characterized by portions of an image remaining on a display device even after the signal to transmit the image is no longer being sent to the display. The problem of image persistence is of particular importance for obscuration techniques, as any image persistence resulting from an output image can interfere with the multi-image cycling used during obscuration and make observation of the intended content difficult even for authorized uses.

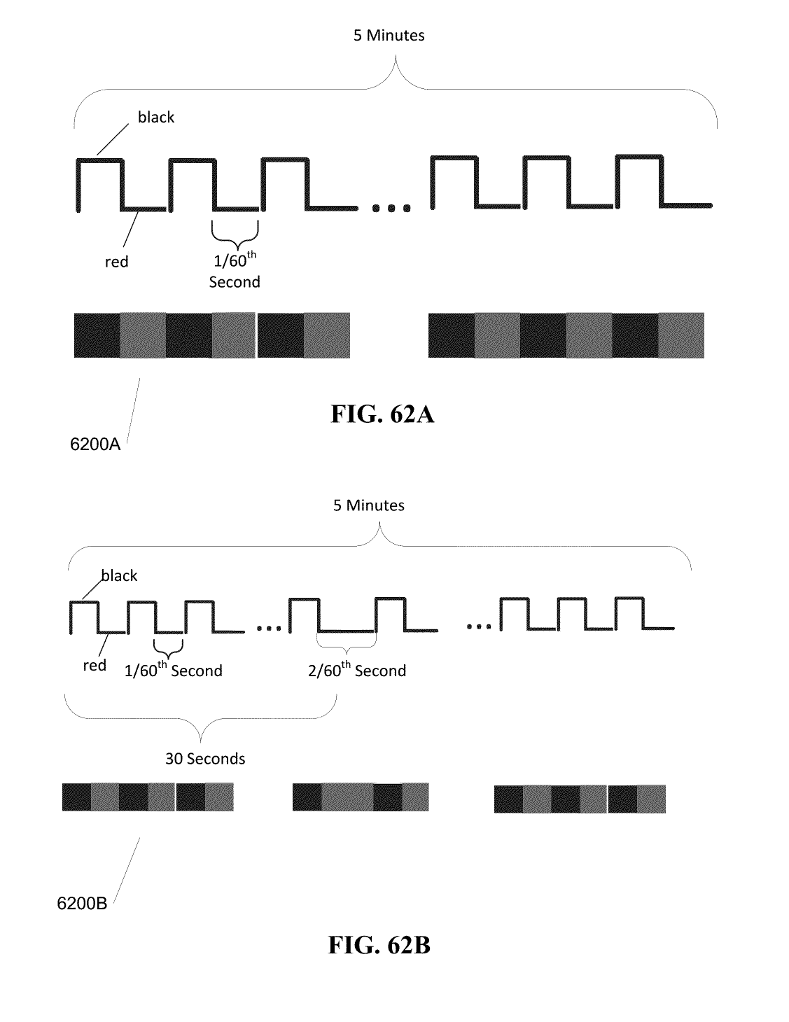

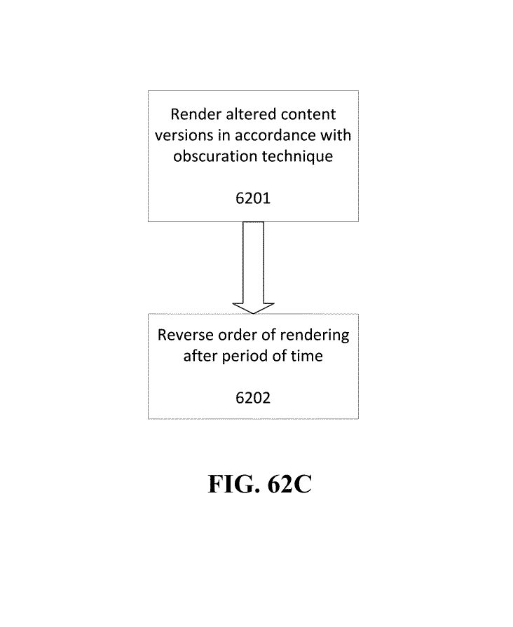

For example, FIG. 62A illustrates a diagram 6200A showing the oscillations of a pixel between black and red sixty times per second. As this process repeats for a longer period of time, the risk of image retention increases. At the end of the 5 minutes shown on the diagram 6200A, there will be considerable image retention in the LCD, resulting in loss of clarity of the overall image, flicker, and/or graphic elements remaining on display device after the output signal has ended.

Image persistence has typically been addressed by either removing the image from the display for an extended period of time or by outputting an image to attempt to correct the persistence, such as a completely white image or a completely black image. Unfortunately, neither of these strategies would be effective during rendering of content as they would require removal of the content from the display for an extended period of time.

Applicant has invented a method and system for preventing image persistence during content obscuration and rendering which does not interfere with obscuration techniques and allows for continued viewing of intended content.

FIG. 62B illustrates an example of this method and system using the earlier example of a pixel oscillating between black and red. FIG. 62B again illustrates a diagram 6200B showing the oscillations of a pixel between black and red sixty times per second. However, as shown in this diagram, after a period of 30 seconds the order of rendering is reversed by intentionally stuttering the red pixel so that it is rendered for two consecutive cycles. If this reversal is repeated periodically, such as every 30 seconds as shown in the diagram 6200B, the problem of image persistence is prevented and there is no loss in quality of the rendered content.

FIG. 62C illustrates a flow chart for preventing image persistence according to an exemplary embodiment. At step 6201 content is rendered in accordance with an obscuration technique, wherein the obscuration technique is configured to oscillate between rendering a first altered version of the content during a first cycle and a second altered version of the content during a second cycle.

Any of the techniques described herein can be used to generate the first and second altered versions of the content. For example, the first altered version of the content can be generated by applying a first mask to the content and the second altered version of the content can be generated by applying a second mask to the content. Additionally, the first altered version of the content can be generated by applying a first obscuration pattern to the content and the second altered version of the content can be generated by applying a second obscuration pattern to the content. Furthermore, the first altered version of the content can generated by applying a first transformation to the content and the second altered version of the content is generated by applying a second transformation to the content. Additional obscuration techniques are described in U.S. Provisional Application No. 62/014,661 filed Jun. 19, 2014, U.S. Provisional Application No. 62/042,580 filed Aug. 27, 2014, and U.S. Provisional Application No. 62/054,951 filed Sep. 24, 2014, all of which are hereby incorporated by reference.

At step 6202 the oscillation of the first altered version of the content and the second altered version of the content is reversed after a period of time, such that the first altered version of the content is rendered during the second cycle and the second altered version of the content is rendered during the first cycle.

Reversing the oscillation can include repeating one of the first altered version of the content and the second altered version of the content for two consecutive cycles, thereby switching the order in which the altered versions are displayed.

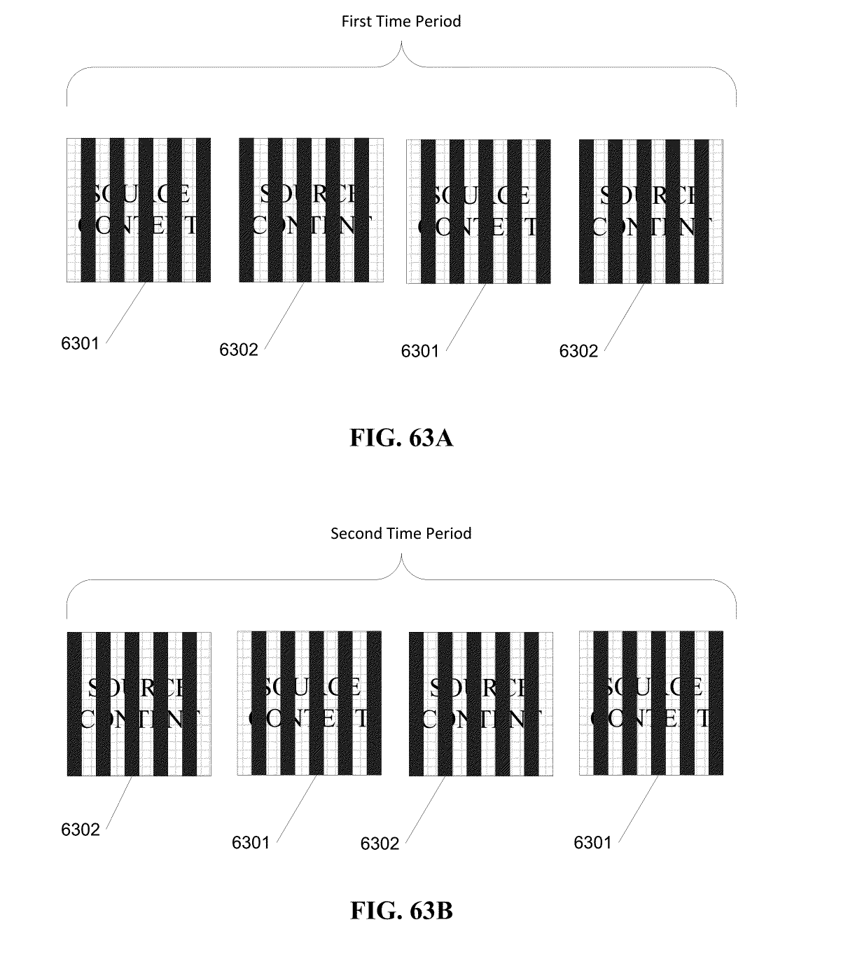

FIG. 63A illustrates the oscillation of a first altered version of content 6301 and a second altered version of content 6302 based on the fence post mask described earlier. As shown in the figure, the first altered version 6301 is alternated with the second altered version 6302. FIG. 63A illustrates the oscillations that occur in a first time period.

FIG. 63B illustrates the oscillation of the two altered versions of content during a second time period which occurs immediately after the first period of time has elapsed. The first altered version 6302 is the last version transmitted during the first time period and the first version transmitted during the second time period. As shown in the figure, this has resulted in the order of rendering of the altered versions of content being reversed.

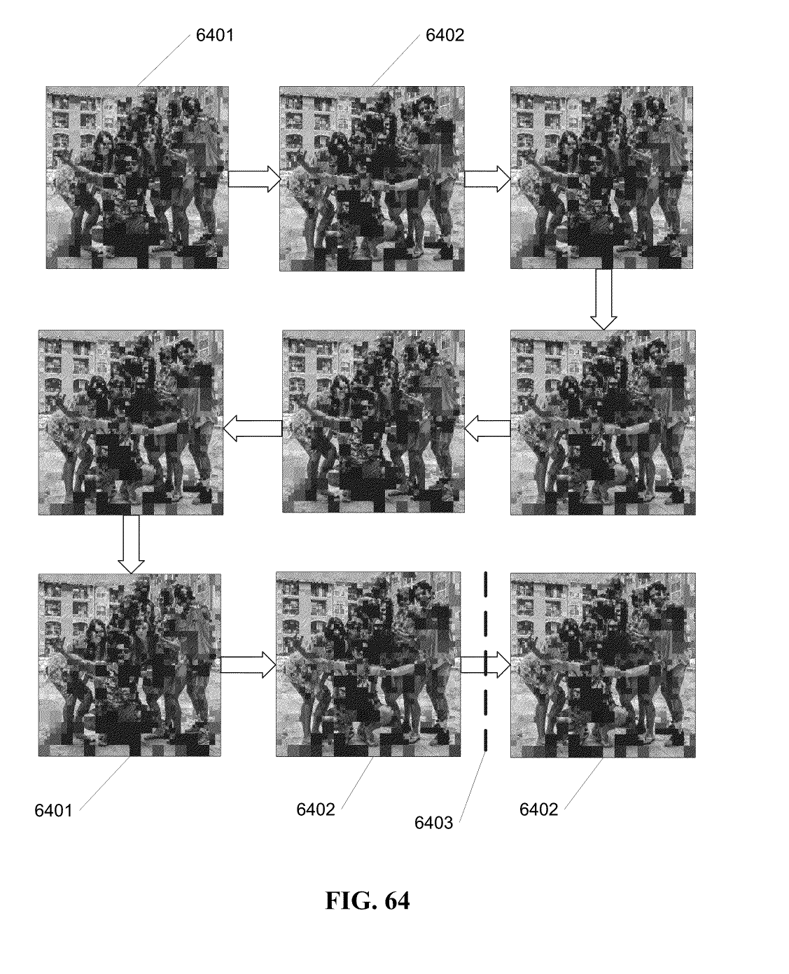

FIG. 64 illustrates another example of reversing the oscillation using the altered versions of content in FIGS. 46B-C. The first altered version 6401 is alternated with the second altered version 6402 until a predetermined time period has elapsed, indicated by dashed line 6403. At this point the second altered version 6402 is repeated and the oscillation of the versions of content is reversed.

Applicant has found that reversing the oscillation of the altered versions of content presented after a predetermined time period eliminates undesirable image persistence effects which would otherwise make rendering obscurated content difficult without significantly altering the quality of the viewed image. Of course, the particular time period which is used to prevent image persistence can vary and can depend on the type content, the type of obscuration that is being used, and the particular LCD screen or technology that is displaying the content. Time periods for reversing oscillation of altered versions of content can range from as little as one second up to three minutes. While frequent reversals of the order of rendering of the altered images will be more noticeable to a user, infrequent reversals will increase the likelihood of image persistence, which is also noticeable to a user. Applicant has found that reversal after 30 seconds is suitable for many different obscuration techniques and display devices. Additionally, the first time period and the second time period need not be the same, and each time period can vary.

Additionally, rather than reverse the order of rendering of altered versions of the content based on a predetermined period of time, the order of rendering can also be reversed after a pre-determined number of frames. In this case, the refresh rate of the display device or the obscuration technique can also be taken into consideration. For example, if each “cycle” lasts for three frames and a first and second altered version of the content are switched each cycle, then the pseudo-code for the version to render for any given frame could be:

```
int FrameCount = 1;
while (rendering the content)
{
        if ( ((FrameCount/3) % 2) == 0)
        output (Version1)
        else
        output (Version2);
FrameCount++;
}
```

Based on the above pseudo-code, the pseudo-code for reversing the order of rendering of the altered versions after each 30 second period on a 60 Hz display device could look like:

| | |
|---|---|
| int FrameCount = 1; | |
| while (rendering the content) | |
| { | |
| if ( ((FrameCount/3) % 2) == 0) | |
| output (Version1) | |
| else | |
| output (Version2); | |
| FrameCount++; | |
| if (FrameCount%1800==0) | // 60Hz × 30 Seconds |
| { | |
| tempVersion=Version1; | |
| Version1=Version2; | |
| Version2=tempVersion; | |
| } | |
| } | |

As shown in the pseudo-code above, the order of rendering of the two altered versions of content can continue to oscillate back and forth after each increment of the predetermined time period (30 seconds or 1800 frames in the above example).

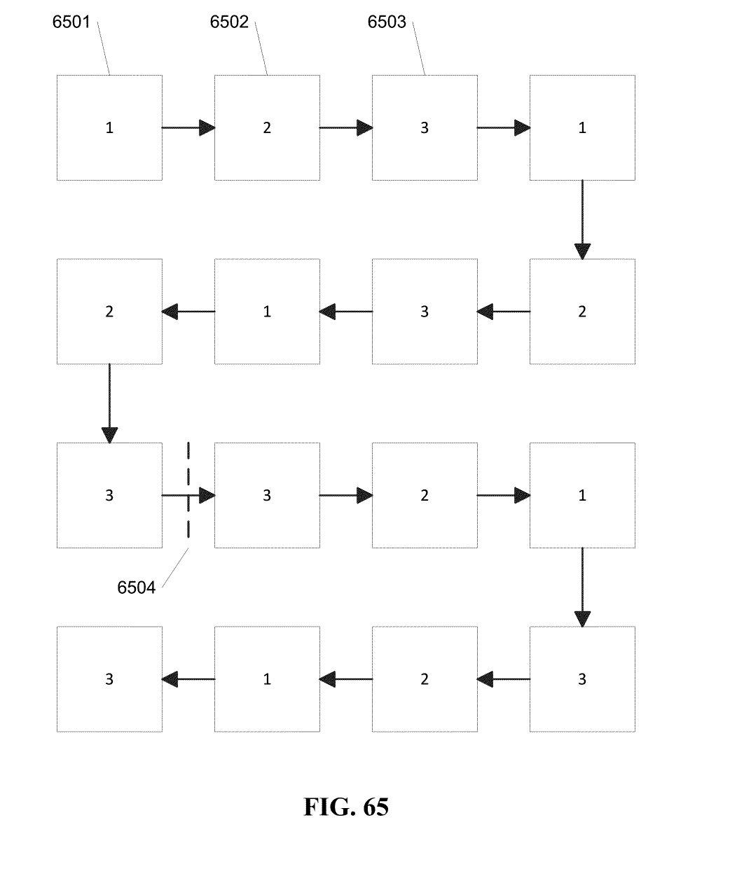

Of course, this technique for preventing image persistence can be utilized in situations where more than two altered versions of the content are cycled during rendering of the content. For example, FIG. 65 illustrates a scenario where a first altered version of content 6501, a second altered version of content 6502, and a third altered version of content 6503 are being cycled in accordance with an obscuration technique. After a predetermined period of time has lapsed, indicated by dashed line 6504, the order of cycling can be reversed, so that the third altered version of content 6503 is rendered first, followed by the second altered version of content 6502, and then the first altered version of content 6501.

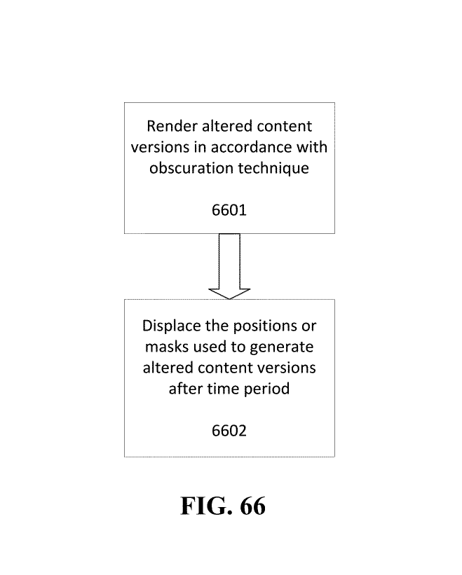

FIG. 66 illustrates another flow chart for preventing image persistence according to an exemplary embodiment. At step 6601 content is rendered in accordance with an obscuration technique, wherein the obscuration technique is configured to cycle through two or more altered versions of the content and wherein the two or more altered versions of content are generated based on two or more masks applied to the content.

At step 6602 the positions of the two or more masks are displaced relative to the content after a predetermined period of time such that two or more additional altered versions of content are cycled through during rendering after the predetermined period of time.

Although this displacement results in the creation of two additional altered versions of the content, the content that is perceived by a user does not change since each of the complementary masks are displaced in a similar manner. Additionally, the method prevents image persistence by shifting the masks to generate the additional altered versions of content so that the same images are not being repeated continuously.

As discussed earlier, the predetermined time period can vary depending on the type of content, characteristics of the content, the obscuration technique being used, and the characteristics of the display device. For example, the predetermined time period can be in the range of 1 second to 3 minutes, such as 30 seconds.

Additionally, the two or more masks can be displaced on a periodic basis in a first direction for a first period of time and then be displaced on a periodic basis in a second direction for a second period of time, resulting in the masks oscillating or “drifting” over the content to be rendered on a periodic basis. This oscillation can be repeated as long as the content is being rendered, and the timing of the oscillation of the two or more masks can be based on characteristics of the two or more masks involved.

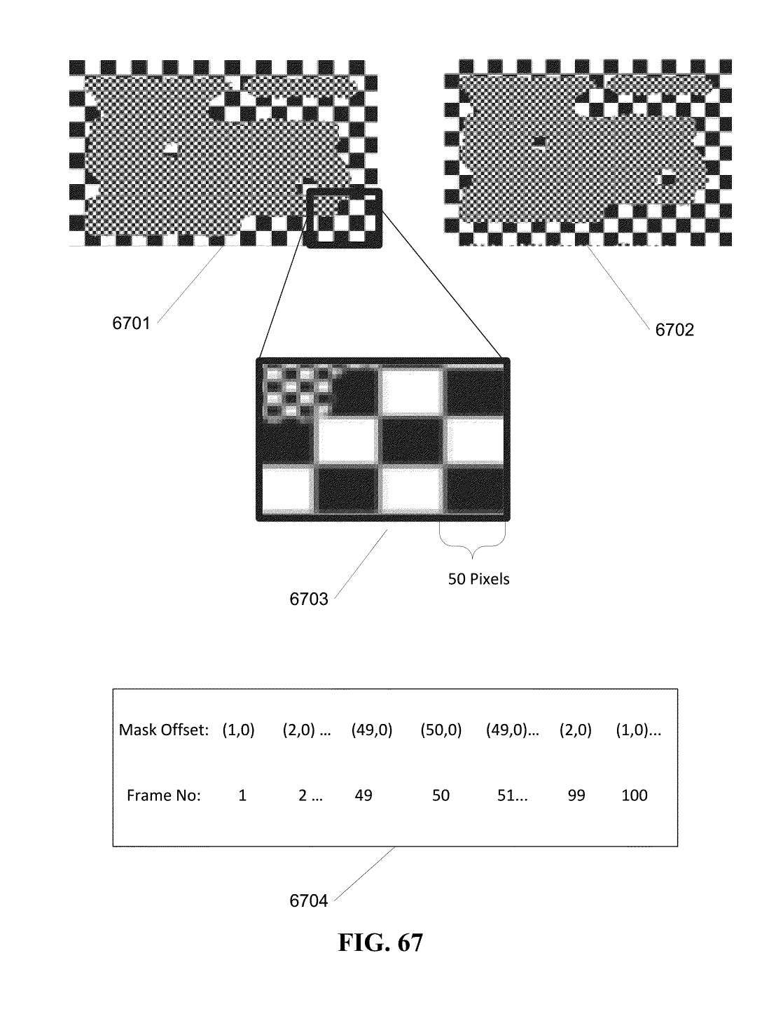

For example, FIG. 67 illustrates the checkerboard mask 6701 from FIG. 58G and inverted checkerboard mask 6702 from FIG. 58H. FIG. 67 also illustrates an expanded view 6703 of a portion of mask 6701 which indicates that the width of each of the large squares in the checkerboard mask (and the corresponding inverted mask) is 50 pixels. As shown in the table 6704, this 50 pixel width can serve as a maximum displacement point for the masks over the content, after which the masks oscillate backwards towards the start point. Table 6704 illustrates the mask offset corresponding to each frame during a rendering of the content. As shown in the table 6704, the mask offset increases 1 pixel per frame up to 50 frames, after which the mask offset decreases one pixel per frame until the offset returns to 1.

Of course, the mask offset can increase after any specified interval of frames. For example, each mask offset can increase after two frames and the existing mask offset can be applied to both the checkerboard mask 6702 and the inverted checkerboard mask 6702 during rendering of the content. As discussed earlier, each application of the offset masks to the content to be rendered will result in slightly different versions of altered content, but since the two masks are complementary, the resulting image will not be effected.

Exemplary Computing Environment

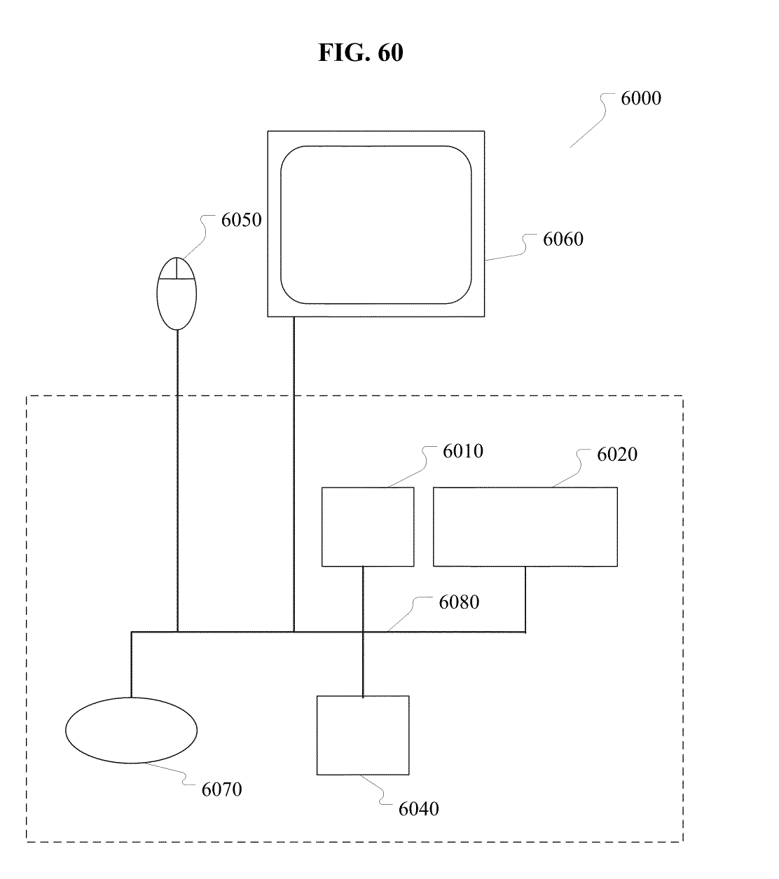

One or more of the above-described techniques can be implemented in or involve one or more computer systems. FIG. 60 illustrates a generalized example of a computing environment 6000 that may be employed in implementing the embodiments of the invention. The computing environment 6000 is not intended to suggest any limitation as to scope of use or functionality of described embodiments.

With reference to FIG. 60, the computing environment 6000 includes at least one processing unit 6010 and memory 6020. The processing unit 6010 executes computer-executable instructions and may be a real or a virtual processor. The processing unit 6010 may include one or more of: a single-core CPU (central processing unit), a multi-core CPU, a single-core GPU (graphics processing unit), a multi-core GPU, a single-core APU (accelerated processing unit, combining CPU and GPU features) or a multi-core APU. When implementing embodiments of the invention using a multi-processing system, multiple processing units can execute computer-executable instructions to increase processing power. The memory 6020 may be volatile memory (e.g., registers, cache, RAM, VRAM), non-volatile memory (e.g., ROM, EEPROM, flash memory, etc.), or some combination of the two. In some embodiments, the memory 6020 stores software instructions implementing the techniques described herein. The memory 6020 may also store data operated upon or modified by the techniques described herein.

A computing environment may have additional features. For example, the computing environment 6000 includes storage 6040, one or more input devices 6050, one or more output devices 6060, and one or more communication connections 6070. An interconnection mechanism 6080, such as a bus, controller, or network interconnects the components of the computing environment 6000. Typically, operating system software (not shown) provides an operating environment for other software executing in the computing environment 6000, and coordinates activities of the components of the computing environment 6000.

The storage 6040 may be removable or non-removable, and may include magnetic disks, magnetic tapes or cassettes, CD-ROMs, CD-RWs, DVDs, or any other medium which can be used to store information and which can be accessed within the computing environment 6000. In some embodiments, the storage 6040 stores instructions for software.

The input device(s) 6050 may be a touch input device such as a keyboard, mouse, pen, trackball, touch screen, or game controller, a voice input device, a scanning device, a digital camera, or another device that provides input to the computing environment 6000. The input device 6050 may also be incorporated into output device 6060, e.g., as a touch screen. The output device(s) 6060 may be a display, printer, speaker, or another device that provides output from the computing environment 6000.

The communication connection(s) 6070 enable communication with another computing entity. Communication may employ wired or wireless techniques implemented with an electrical, optical, RF, infrared, acoustic, or other carrier.

Implementations can be described in the general context of computer-readable media. Computer-readable media are any available storage media that can be accessed within a computing environment. By way of example, and not limitation, within the computing environment 6000, computer-readable media may include memory 6020 or storage 6040.

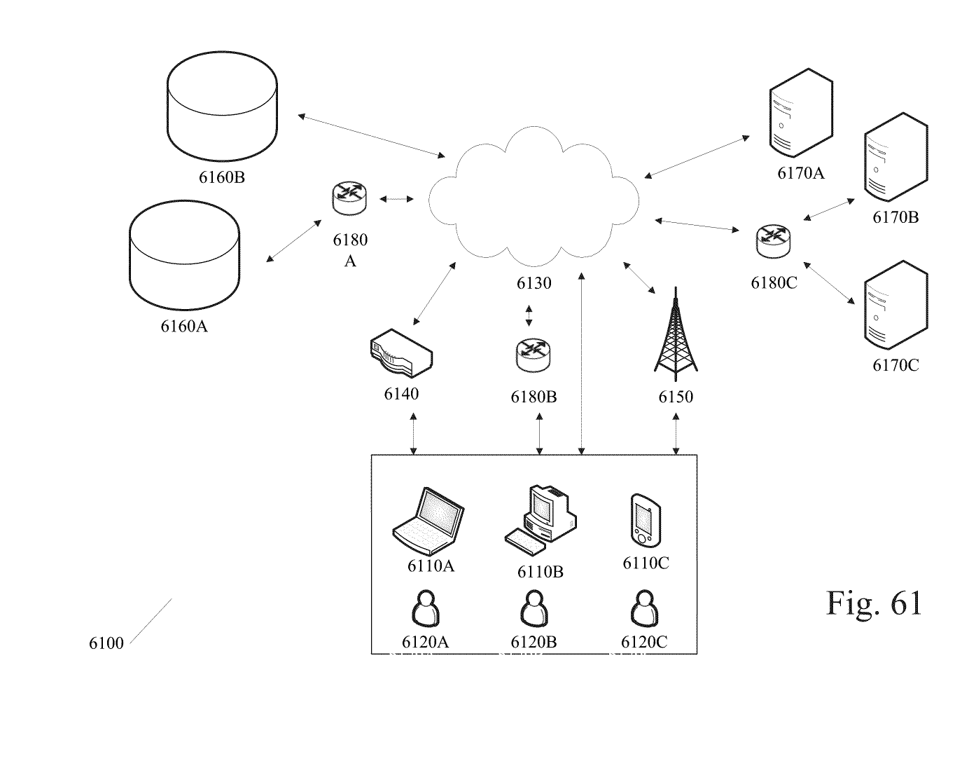

One or more of the above-described techniques can be implemented in or involve one or more computer networks. FIG. 61 illustrates a generalized example of a network environment 6100 with the arrows indicating possible directions of data flow. The network environment 6100 is not intended to suggest any limitation as to scope of use or functionality of described embodiments, and any suitable network environment may be utilized during implementation of the described embodiments or their equivalents.

With reference to FIG. 61, the network environment 6100 includes one or more client computing devices, such as laptop 6110A, desktop computing device 6110B, and mobile device 6110C. Each of the client computing devices can be operated by a user, such as users 6120A, 6120B, and 6120C. Any type of client computing device may be included.

The network environment 6100 can include one or more server computing devices, such as 6170A, 6170B, and 6170C. The server computing devices can be traditional servers or may be implemented using any suitable computing device. In some scenarios, one or more client computing devices may functions as server computing devices.

Network 6130 can be a wireless network, local area network, or wide area network, such as the internet. The client computing devices and server computing devices can be connected to the network 6130 through a physical connection or through a wireless connection, such as via a wireless router 6140 or through a cellular or mobile connection 6150. Any suitable network connections may be used.

One or more storage devices can also be connected to the network, such as storage devices 6160A and 6160B. The storage devices may be server-side or client-side, and may be configured as needed during implementation of the disclosed embodiments. Furthermore, the storage devices may be integral with or otherwise in communication with the one or more of the client computing devices or server computing devices. Furthermore, the network environment 6100 can include one or more switches or routers disposed between the other components, such as 6180A, 6180B, and 6180C.

In addition to the devices described herein, network 6130 can include any number of software, hardware, computing, and network components. Additionally, each of the client computing devices, 6110, 6120, and 6130, storage devices 6160A and 6160B, and server computing devices 6170A, 6170B, and 6170C can in turn include any number of software, hardware, computing, and network components. These components can include, for example, operating systems, applications, network interfaces, input and output interfaces, processors, controllers, memories for storing instructions, memories for storing data, and the like.

Having described and illustrated the principles of the invention with reference to described embodiments, it will be recognized that the described embodiments can be modified in arrangement and detail without departing from such principles. It should be understood that the aspects of the embodiments described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa, where appropriate and as understood by those skilled in the art.

As will be appreciated by those of ordinary skilled in the art, the foregoing examples of systems, apparatus and methods may be implemented by suitable program code on a processor-based system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such program code, as will be appreciated by those of ordinary skilled in the art, may be stored or adapted for storage in one or more non-transitory, tangible machine readable media, such as on memory chips, local or remote hard disks, optical disks or other media, which may be accessed by a processor-based system to execute the stored program code.

The description herein is presented to enable a person of ordinary skill in the art to make and use the invention. Various modifications to the disclosed embodiments will be readily apparent to those skilled in the art and the generic principles of the disclosed embodiments may be applied to other embodiments, and some features of the disclosed embodiments may be used without the corresponding use of other features. Accordingly, the embodiments described herein should not be limited as disclosed, but should instead be accorded the widest scope consistent with the principles and features described herein.

What is claimed is:

1. A computer-implemented method executed by one or more computing devices for displaying content, the method comprising:
receiving, by at least one of the one or more computing devices, source content;
identifying, by at least one of the one or more computing devices, a mask that segments the source content into at least a first segment and a second segment, the identifying including specifying one or more parameters associated with the mask;
identifying, by at least one of the one or more computing devices, one or more masking techniques;
associating, by at least one of the one or more computing devices, the source content with obscuration information and one or more usage rules, the obscuration information including information corresponding to the mask, information corresponding to the one or more parameters, and information corresponding to the one or more masking techniques; and
transmitting, by at least one of the one or more computing devices, the source content, the one or more usage rules, and the obscuration information to at least one recipient computing device.

2. The method of claim 1, wherein the at least one recipient computing device is operable to use the source content, the one or more usage rules, and the obscuration information to create an obscured rendering of the source content.

3. The method of claim 1, wherein the mask segments the source content into at least three segments including the first segment, the second segment, and one or more additional segments.

4. The method of claim 1, wherein identifying the mask comprises selecting a mask from a library of at least two possible masks.

5. The method of claim 1, wherein at least one of the one or more masking techniques is a blur.

6. The method of claim 1, wherein at least one of the one or more masking techniques replaces a segment with a solid color approximating the average color of the segment.

7. The method of claim 1, wherein at least one of the one or more masking techniques alters the RGB values of each pixel of a segment.

8. The method of claim 1, wherein the mask is based at least in part on an image or a logo.

9. The method of claim 1, wherein the mask is based at least in part on a tile pattern of shapes.

10. The method of claim 1, wherein the mask is based at least in part on a field of hexagon shapes.

11. The method of claim 1, wherein a document comprises the source content.

12. An apparatus for displaying content, the apparatus comprising:
one or more processors; and
one or more memories operatively coupled to at least one of the one or more processors and having instructions stored thereon that, when executed by at least one of the one or more processors, cause at least one of the one or more processors to:
enable the receipt of source content;
identify a mask that segments the source content into at least a first segment and a second segment, the identifying including specifying one or more parameters associated with the mask;
identify one or more masking techniques;
associate the source content with obscuration information and one or more usage rules, the obscuration information including information corresponding to the mask, information corresponding to the one or more parameters, and information corresponding to the one or more masking techniques; and
transmit the source content, the one or more usage rules, and the obscuration information to at least one recipient computing device.

13. The apparatus of claim 12, wherein the at least one recipient computing device is operable to use the source content, the one or more usage rules, and the obscuration information to create an obscured rendering of the source content.

14. The apparatus of claim 12, wherein the mask segments the source content into at least three segments including the first segment, the second segment, and one or more additional segments.

15. The apparatus of claim 12, wherein the instructions that, when executed by at least one of the one or more processors, cause at least one of the one or more processors to identify the mask further cause at least one of the one or more processors to select a mask from a library of at least two possible masks.

16. The apparatus of claim 12, wherein at least one of the one or more masking techniques is a blur.

17. The apparatus of claim 12, wherein at least one of the one or more masking techniques replaces a segment with a solid color approximating the average color of the segment.

18. The apparatus of claim 12, wherein at least one of the one or more masking techniques alters the RGB values of each pixel of a segment.

19. The apparatus of claim 12, wherein the mask is based at least in part on an image or a logo.

20. The apparatus of claim 12, wherein the mask is based at least in part on a tile pattern of shapes.

21. The apparatus of claim 12, wherein the mask is based at least in part on a field of hexagon shapes.

22. The apparatus of claim 12, wherein a document comprises the source content.

23. At least one non-transitory computer-readable medium storing computer-readable instructions that, when executed by one or more computing devices, cause at least one of the one or more computing devices to:
receive source content;
identify a mask that segments the source content into at least a first segment and a second segment, the identifying including specifying one or more parameters associated with the mask;
identify one or more masking techniques;
associate the source content with obscuration information and one or more usage rules, the obscuration information including information corresponding to the mask, information corresponding to the one or more parameters, and information corresponding to the one or more masking techniques; and
transmit the source content, the one or more usage rules, and the obscuration information to at least one recipient computing device.

24. The at least one non-transitory computer-readable medium of claim 23, wherein the at least one recipient computing device is operable to use the source content, the one or more usage rules, and the obscuration information to create an obscured rendering of the source content.

25. The at least one non-transitory computer-readable medium of claim 23, wherein the mask segments the source content into at least three segments including the first segment, the second segment, and one or more additional segments.

26. The at least one non-transitory computer-readable medium of claim 23, wherein the instructions that, when executed by at least one of the one or more computing devices, cause at least one of the one or more computing devices to identify the mask further cause at least one of the one or more computing devices to select a mask from a library of at least two possible masks.

27. The at least one non-transitory computer-readable medium of claim 23, wherein at least one of the one or more masking techniques is a blur.

28. The at least one non-transitory computer-readable medium of claim 23, wherein at least one of the one or more masking techniques replaces a segment with a solid color approximating the average color of the segment.

29. The at least one non-transitory computer-readable medium of claim 23, wherein at least one of the one or more masking techniques alters the RGB values of each pixel of a segment.

30. The at least one non-transitory computer-readable medium of claim 23, wherein the mask is based at least in part on an image or a logo.

31. The at least one non-transitory computer-readable medium of claim 23, wherein the mask is based at least in part on a tile pattern of shapes.

32. The at least one non-transitory computer-readable medium of claim 23, wherein the mask is based at least in part on a field of hexagon shapes.

33. The at least one non-transitory computer-readable medium of claim 23, wherein a document comprises the source content.

34. An apparatus for displaying content, the apparatus comprising:
one or more processors; and
one or more memories operatively coupled to at least one of the one or more processors and having instructions stored thereon that, when executed by at least one of the one or more processors, cause at least one of the one or more processors to:
enable the receipt of source content;
identify a mask that segments the source content into at least a first segment and a second segment, the identifying including specifying one or more parameters associated with the mask;
identify one or more masking techniques, wherein the one or more masking techniques can be applied to segments of the source content identified by the mask to create an obscured rendering of the source content;
associate the source content with obscuration information and one or more usage rules, the obscuration information including information corresponding to the mask, information corresponding to the one or more parameters, and information corresponding to the one or more masking techniques, the one or more usage rules indicating how the source content may be obscurely rendered using the obscuration information; and
transmit the source content, the one or more usage rules, and the obscuration information to at least one recipient computing device.
